(19) United States
(12) Patent Application Publication
(10) Pub. No.: US 2003/0065613 A1
(43) Pub. Date: Apr. 3, 2003

(54) Software for financial institution monitoring and management and for assessing risk for a financial institution

(76) Inventor: Diane K. Smith, North Royalton, OH (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/965,981

(22) Filed: Sep. 28, 2001

(51) Int. Cl. G06F 17/60

(52) U.S. Cl. 705/38

(57) ABSTRACT

A software based Knowledge Management application for supervision and regulation, statistical services and credit risk management. It is designed to retrieve financial institution information from a variety of systems, filter that information and deliver it to the appropriate users through a single point of access. The system provides access to financial institution profiles, tracks institution performance, risk assessment and generates alerts. In addition, the system provides for workflow management. The system also performs compliance monitoring of certain regulations.

### COPYRIGHT NOTICE

A portion of the disclosure of this patent document contains material which is subject to copyright protection. The copyright owner has no objection to the facsimile reproduction by any one of the patent disclosure as it appears in the Patent and Trademark Office patent files or records, but otherwise reserves all copyright rights whatsoever.

### BACKGROUND OF THE INVENTION

The present invention is generally related to software for financial institution monitoring and management.

Financial institution monitoring and management is a diverse multifaceted operation. Performance of the institution is measured and tracked. Assets and liabilities of the institution must be examined. In addition, Financial Holding Company compliance must be monitored. The various examinations and monitoring are conducted by disparate groups which may also be geographically dispersed. An institution may appear sound to one group based on that group's inspection or evaluation, however may have unacceptable rankings in another category. Therefore, in order to compile a true and accurate picture of the financial institution's current status, reports utilizing cumulative data from the various sources are necessary.

The various risk assessments and surveillance of the institution are conducted at varying intervals. Thus a risk factor may become critical during the cycle in between assessments. It is also desired that a system be created whereby alerts may be generated and communicated to the various monitoring groups on a real time basis.

Another aspect of the monitoring and assessment process is the completion of data forms for entry into national examination databases. The process is extremely detailed and time consuming. The entering of data can be very labor intensive. In addition, there are several steps that need to be scheduled and completed in the process. Thus there is a need for a workflow program that can populate data fields and parameters necessary for the completion of the various tasks as well monitoring the progress of the various aspects of the examination.

### BRIEF SUMMARY OF THE INVENTION

In view of the aforementioned needs, the invention contemplates a system that is comprised of a plurality of databases accessible from a single application or a main page. The system utilizes navigation pane links to other databases, web sites and favorite Lotus Notes® databases (Lotus Notes is the registered trademark of Lotus Development Corporation). Furthermore, the present invention utilizes push-pull technology for generating alerts and distributing news. The system is comprised of several databases that are described as follows.

An Alerts database stores all alerts which are generated when data thresholds are identified and exceeded during data downloads. Alerts are also generated by other significant events. The alerts are categorized by type of alert. The database has the capability to see new alerts, an alert being considered new if it is generated within the last seven days. Various views are provided which enable all alerts over time to be observed. Financial alerts have two threshold levels, the first being an “early warning” level and the second a “normal” level.

A risk assessment database supports the creation and approval of risk assessments. A composite risk assessment is an overall assessment while section risk assessments are used to provide information for the composite assessment. High-risk institutions are also reported on a watch list. Any risk assessment with a “high” in one of the factors puts an institution on the watch list. In addition, the database has the ability to force an institution on or off the watch list. The database generates one watch list for composite assessments and additional high risk lists for each section.

The performance database performs corporate and departmental tracking and generates balanced scorecard information. The database uses industry standard perspectives and shows whether objectives are not met, mostly met, met, or exceeded. Measurements and targets are established for each objective. Additionally, goals and the actions performed to meet those goals are tracked at corporate and departmental levels.

The Institution Profile database is generated from data pulled from a plurality of relational databases across the country on a dynamic basis, including the databases listed above. This database tracks financial information and generates early warnings when changes in directions of financial ratios are detected. In the present invention, the data is combined whereas previously different navigation procedures and passwords were required to obtain the data. The Institution Profile generates early warnings for direction changes in exams and inspections ratings. The information is retrieved dynamically, data changes are based on currently available data. The Institutions Database may generate an early warning alert or a normal alert based on user defined thresholds. The credit risk of an institution may also be determined based on current data and provides information on the eligibility of institutions to borrow from the Federal Reserve discount window. Another aspect of the Institution Profile is the tracking of Financial Holding Company compliance. Recent legislation allows financial institutions to offer certain products and services, however, the holding company must be healthy and their subsidiaries must be healthy. The system of the present invention enables the holding company's status to be verified regardless of the location of its subsidiaries.

A workflow application supports the creation and approval of National Examination Data (“NED”) examination forms for entry into NED. Exam documents support each stage in the flow from scheduled to final. Email notifications are generated to inform users when a document requires their attention or when an action is overdue.

Structure event tracking workflows structure event processes. The workflows report receipt and processing of structure events and the database provides notification to external operating departments of pending and consummated events. Internal users of the system receive alerts. Views of pending and historical structure events are provided.

An advantage of the present invention is the ability to see shared data real-time. Prior systems operated in batch mode and often updates were posted on a weekly basis. Alerts are generated as soon as an alert threshold has been surpassed and the alert is immediately available to all groups.

Another advantage of the present invention is that it provides more accurate data and eliminates the copying of data from the old database to electronic mails. Furthermore, much of the institution data comes directly from existing databases, thereby reducing informational errors. The present invention also provides more complete data, many fields have been added to codify knowledge from subject matter experts.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF DESCRIPTION OF THE SEVERAL VIEWS OF THE DRAWING

The drawings illustrate a preferred embodiment, by way of example only, presently contemplated of carrying out the invention.

FIG. 1 is a block diagram showing the relationship of the various databases and Headlines Page for the present invention;

FIG. 2 is a sample screen snapshot of the Headlines Page;

FIG. 3 is a block diagram of the components of the Home Database;

FIG. 4 is a sample screen snapshot of the Financial Alert Information Screen as contemplated by the present invention;

FIG. 4a is a sample New Alerts screen;

FIG. 5 is a sample screen snapshot showing a screen for setting alert threshold parameters as contemplated by the present invention;

FIG. 6 is a sample screen snapshot showing composite risk assessment factors as contemplated by the present invention;

FIG. 7 is a sample screen snapshot of a Composite Risk Assessment screen;

FIG. 8 is a sample Risk Assessment form;

FIG. 9a is a sample Add-In Template Approval screen;

FIG. 9b is a sample Add-In Template In Process screen;

FIG. 9c is a sample Add-In Template Archived screen;

FIG. 9d is a sample Add-In Template History screen;

FIG. 10 is a sample Web Links screen;

FIG. 11 is a sample Web Links data screen;

FIG. 12a is a sample Structure report for all structures;

FIG. 12b is a sample Structure report for all reports;

FIG. 12c is a screen for selecting Tracking Status;

FIG. 13 is a sample Corporate Balanced Scorecard;

FIG. 14 is a sample Corporate Detailed Balanced Scorecard;

FIG. 15 is a sample Corporate Historical Balanced Scorecard;

FIG. 16 is a sample Corporate Balanced Scorecard Relationships view that relates departmental scorecards to the corporate scorecard;

FIG. 17 is a sample Department Balanced Scorecard;

FIG. 18 is a sample Department Detailed Balanced Scorecard;

FIG. 19 is a sample Department Historical Balanced Scorecard;

FIG. 20 is a sample screen snapshot of a Balanced Scorecard screen showing Target, Measurement and Status;

FIG. 21 is a sample screen showing a blank screen used to start an exam;

FIG. 22 is a sample New Exam form;

FIG. 23 is a sample of an Opened Stage detail screen;

FIG. 24 is a sample screen snapshot of an Open stage—entry into NED screen;

FIG. 25 is a sample screen snapshot of a Preliminary stage screen;

FIG. 26 is a sample screen snapshot of a detailed Preliminary stage screen;

FIG. 27 is a sample screen snapshot of additional details from a Preliminary stage screen;

FIG. 28 is a sample screen snapshot of additional details from a Preliminary stage screen;

FIG. 29 is a sample screen snapshot of additional details from a Preliminary stage screen;

FIG. 30 is a sample screen snapshot of additional details from a Preliminary stage screen;

FIG. 31 is a sample screen snapshot of a Preliminary stage—NED entry screen;

FIG. 32 is a sample screen snapshot of a Preliminary stage—NED entry screen;

FIG. 33 is a sample screen snapshot of an Open stage—Opened NED entry screen;

FIG. 34 is a sample screen snapshot of an NED Examiner View;

FIG. 35 is a sample screen snapshot of a Review stage screen;

FIG. 36 is a sample screen snapshot of detailed Review stage screen;

FIG. 37 is a sample screen snapshot of a Banking Supervisor View;

FIG. 38 is a sample Institutions by entity view;

FIG. 39 is a Institutions Financial Comparisons screen;

FIG. 40 is an Institutions Profile screen;

FIG. 41 is an expanded view of the General Information stored in the Institution Profile database;

FIG. 42 is an expanded view of the Contacts information stored in the Institution Profile database;

FIG. 43 is an expanded view of the Financial Ratios stored in the Institution Profile database;

FIG. 44 is an expanded view of the Assets and Comments Sections of an Institution Profile;

FIG. 45 is an expanded view of the Exam Summary;

FIG. 46 is an expanded view of the Reports, Risk Assessments and Applications sections of the Institution Profile;

FIG. 47 is an expanded view of Reports Tracking of the Institution Profile;

FIG. 48 is an expanded view of Loans and Discount Summary of an Institution Profile;

FIG. 49 shows additional detail of the Loans and Discount Summary;

FIG. 50 shows an expanded view of Structure details of an Institution Profile;

FIG. 51 shows an expanded view of Other Links section of an Institution Profile;

FIG. 52 shows an example of an Exam Reports tracking screen;

FIG. 53 shows an example of an Exam Reports Acknowledgement screen;

FIG. 54 shows an expanded view of the Tracking section of the Report Tracking view;

FIG. 55 shows an example of an Exam Summaries view;

FIG. 56 shows an example of an expanded view for Most Recent Exams, Future Exams, Supervisory Actions, and PCAD Rating for an Exam Summary view;

FIG. 57 shows an example of an Exam History view;

FIG. 58 shows an example of details on specific exams;

FIG. 59a shows an example of an Open Supervisory Actions view;

FIG. 59b shows an example of a Supervisory Actions History view;

FIG. 59c shows an example of a Classified Assets view;

FIG. 59d shows an example of a detailed Classified Assets view;

FIG. 60a is an example of a FHC Compliance view;

FIG. 60b is an example of a FHC's out of compliance view;

FIG. 61a is an example of a Condition Monitoring view;

FIG. 61b is an example of a Monitoring view;

FIG. 62a is an example of BIC Surveillance view;

FIG. 62b is an example of PCAD Designations view;

FIG. 63 is an example of an Employee By Name view;

FIG. 64 is an example of an Employee by Department view;

FIG. 65 is an example of Employees Education view;

FIG. 66 is an example of Employees Reporting relationships view;

FIG. 67 is an example of Employees Skills with level of skill view;

FIG. 68 is an example of an Employee Specialty view;

FIG. 69 is an example of details of an Employee Profile;

FIG. 70 is an example of an Employee Professional with expanded Skills;

FIG. 71 is an example of an Employee Profile with expanded Education and Biography;

FIG. 72 is an example of an Employee Profile with expanded Administration;

FIG. 73 is an example of a Discussion By Category view;

FIG. 74 is an example of a Discussion Main Topic;

FIG. 75 is an example of an Open Application view;

FIG. 76 is an example of Unconsummated Applications view;

FIG. 77 is an example of a Consummated Applications view;

FIG. 78 is an example of the additional details available by selecting a document within a Consummated Applications view;

FIG. 79 is a detailed Application information;

FIG. 80 is an example of a Schedules Master view;

FIG. 81 is an example of a Calendar Entry screen;

FIG. 82 is an example of a Calendar Entry view;

FIG. 83 is an example of a Scheduled Exams view;

FIG. 84 is an example of an Institutions view within the Schedules database;

FIG. 85 is an example of a Calendar Entry for a global interest event;

FIG. 86 is an example of a Person Schedule view;

FIG. 87 is a block diagram showing the relationship of the various databases and modules for the present invention is a block diagram of an overall system view.

### DETAILED DESCRIPTION OF INVENTION

The present invention (“SuperLink”) is for a software-based Knowledge Management application for supervision and regulation, statistical services, and credit risk management. It is designed to retrieve financial institution information from a variety of systems, filter that information and deliver it to the appropriate users through a single point of access. The system provides access to financial institutional profiles, tracks institution performance, risk assessments and generates alerts. In addition, the system provides for workflow management and views of scheduled examinations. The system also performs Financial Holding Company (“FHC”) and “Borrower in Custody” compliance monitoring.

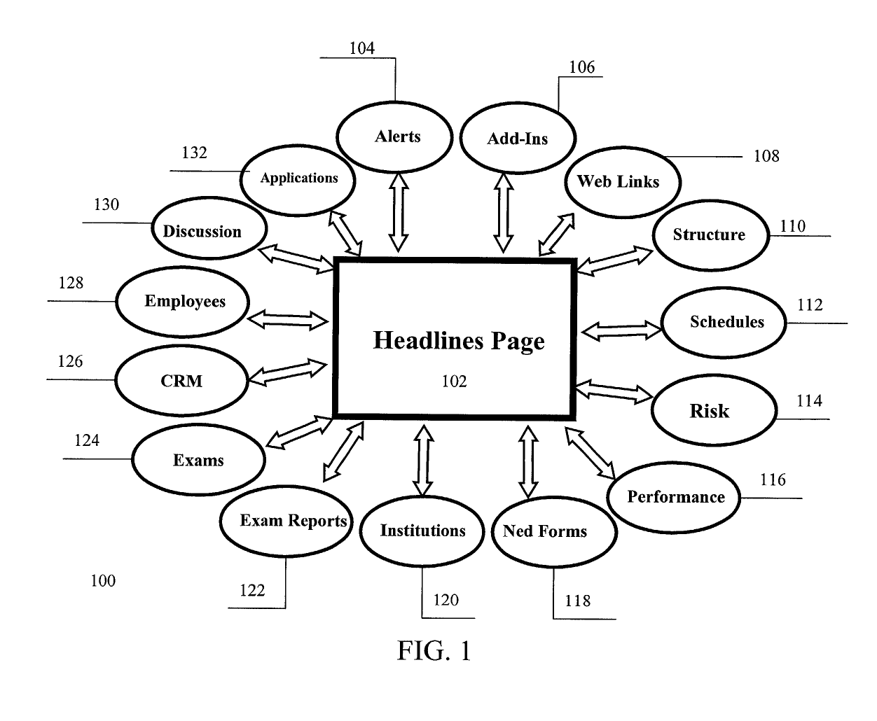

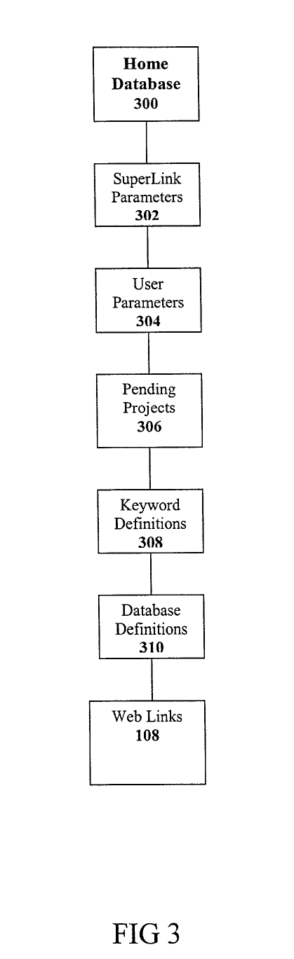

SuperLink, in the preferred embodiment, is comprised of at least thirteen Lotus Notes databases interacting together through software. While the preferred embodiment contemplates use of the Lotus Notes platform, it will be apparent by one of ordinary skill in the art that alternative platforms are readily available that will also be adaptable. Referring to FIG. 1, the system of the present invention is generally designated 100. The starting point of the system is the Headlines Page 102 in FIG. 1. The Headlines Page 102 accesses the Home database (FIG. 3). User preferences are stored in the Employee Database 128. A user is permitted to see only certain databases which is controlled via security settings. A user can decide what is displayed on their Headlines pages through setting their preferences. The user's unique preferences are then stored for subsequent sessions.

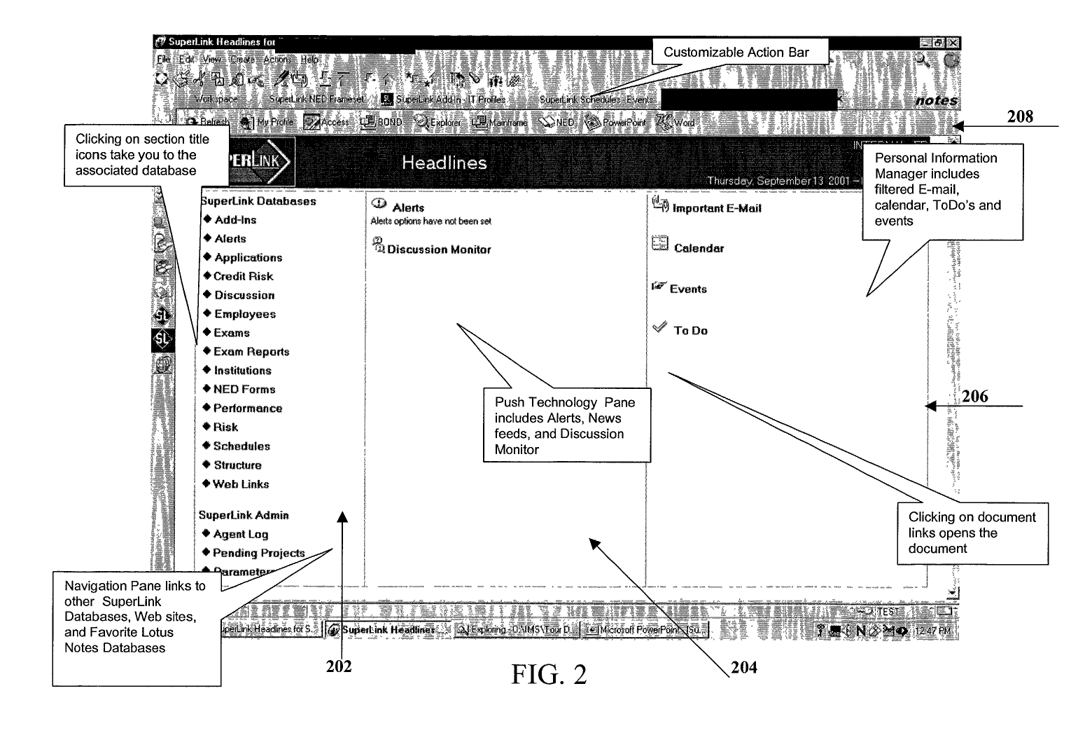

The Headlines Page 102 is advantageously selected as the main entry point to the system. It enables ready access to the factors of the subject invention. From the Headlines Page 102, access to the various modules, views, and databases is provided, the particulars of which will be detailed below. The Headlines Page 102 is fully customizable by each user of the system. As is observed in FIG. 2, the Headlines Page 102 is divided into four main sections. The Navigation Pane 202 is located on the left side of the screen. The Navigation Pane 202 provides Navigation to SuperLink Databases, Web Links, and Other Notes Database Links. The center pane 204 of the Headlines Page 102 is the Push Technology Pane. Pane 204 provides links to alerts, links to news, and discussion monitor. The right pane 206 is the Personal Information Manager pane which is comprised of filtered electronic mail, calendar, events and ToDo's. Across the top of the panes 202, 204, and 206 is an action bar 208. The action bar 208 contains application buttons customizable by each user, a refresh button and a link to the user's profile.

The Headlines Page 102 provides links and access to the thirteen Lotus Notes databases utilized by the present invention. These databases are the Alerts database 104, Add-Ins database 106, Web Links database 108, Structure database 110, Schedules database 112, Risk Assessment database 114, Performance database 116, Ned Forms database 118, Institutions database 120, Exam Reports database 122, Exams database 124, Credit Risk Management database 126, Employees database 128, Discussion database 130, and Applications database 132.

The contents of the Home database 300 are shown in FIG. 3. The Home database 300 is comprised of SuperLink Parameters 302, User Parameters 304, Pending Projects 306, Keyword Definitions 308, Database definitions 310 and Web Links 108. The Employee Profile determines what appears on the Headlines page 102 (FIG. 1). The SuperLink Parameters 302, User Parameters 304, Keyword Definitions 308, and Database Definitions 310 are system configurations. This allows the software to be customized for each monitoring location. The SuperLink Parameters 302 define data sources and are used to tailor downloads. The User Parameters 304 are used to define application button file paths. The Pending Projects Database 306 lists the current SuperLink initiatives along with information about their status, priority, target dates, and dependencies. There is also a facility to track issues and their resolutions. Also included are all versions of SuperLink and its enhancements as well as various other documentation supporting SuperLink. This data is maintained by the SuperLink Administrator. The Web Links 108 database is used to store hyper-links, advantageously chosen as World Wide Web links of general interest in the preferred embodiment, as well as to the financial institutions being monitored by the SuperLink application.

The Alerts Database 104 is a storage location for all alerts which are generated when data thresholds are identified and exceeded during the data downloads. Alerts are also generated for other significant events. Alerts are categorized by type of alert. The system has the ability to see “new” alerts, an alert being considered “new” for a preset period, seven days, in the preferred embodiment. The system also provides the ability to see all alerts over time through various views. There are two financial alert thresholds, the “Early Warning” level and “Normal” level. Financial alert thresholds are set at the district level.

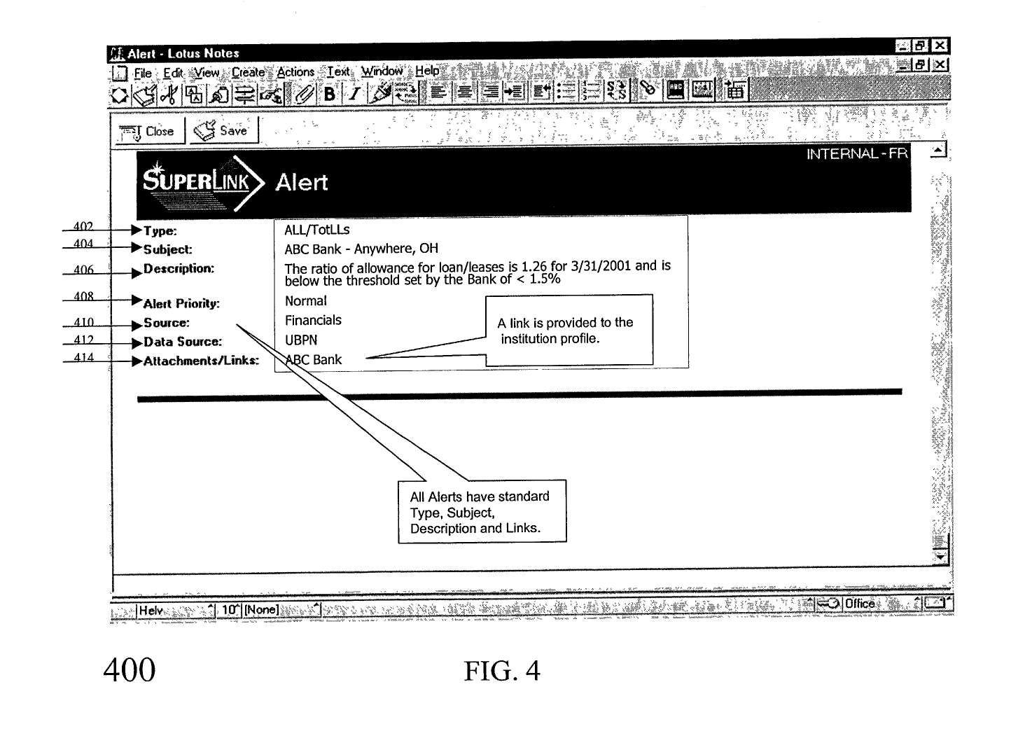

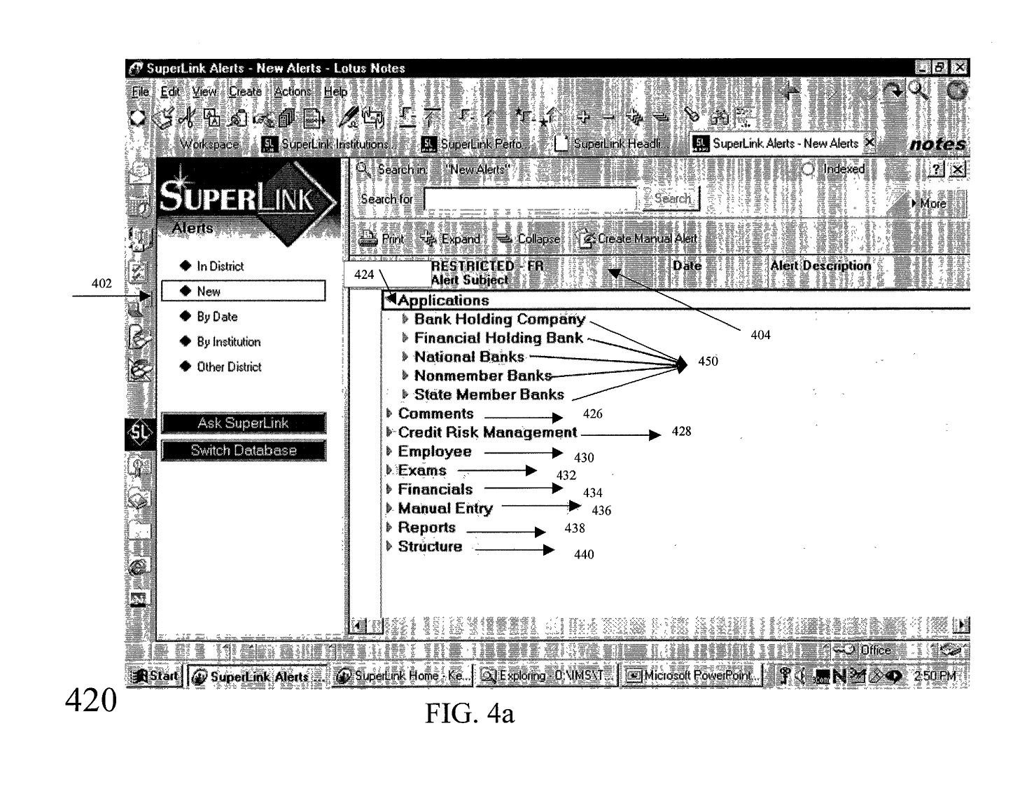

Referring to FIG. 4, there is shown an example Alert Screen generally designated 400. The fields listed on the screen are the type of alert 402, subject 404, description 406, priority 408, source 410, data source 412, and attachments/links 414. All alerts have standard type subject, description and links. The attachments/links field 414 provides a link to the associated institution profile or supporting document from the Alert Screen.

FIG. 4a shows an example new alert screen, generally designated 420. This screen 420 gives several examples of alert subjects 404. Alert subjects 404 include but are not limited to Add-Ins (not shown), Applications 424, Comments 426, Credit Risk Management 428, Employees 430, Exams 432, FHC Compliance (not shown), Financials 434, Loans (not shown), Manual Entry 436, Reports 438, Risk (not shown) and Structure 440. Typically, the subject 404 is determined by the database generating the alert. When the alerts are applicable to an institution, they are further classified by entity type 450.

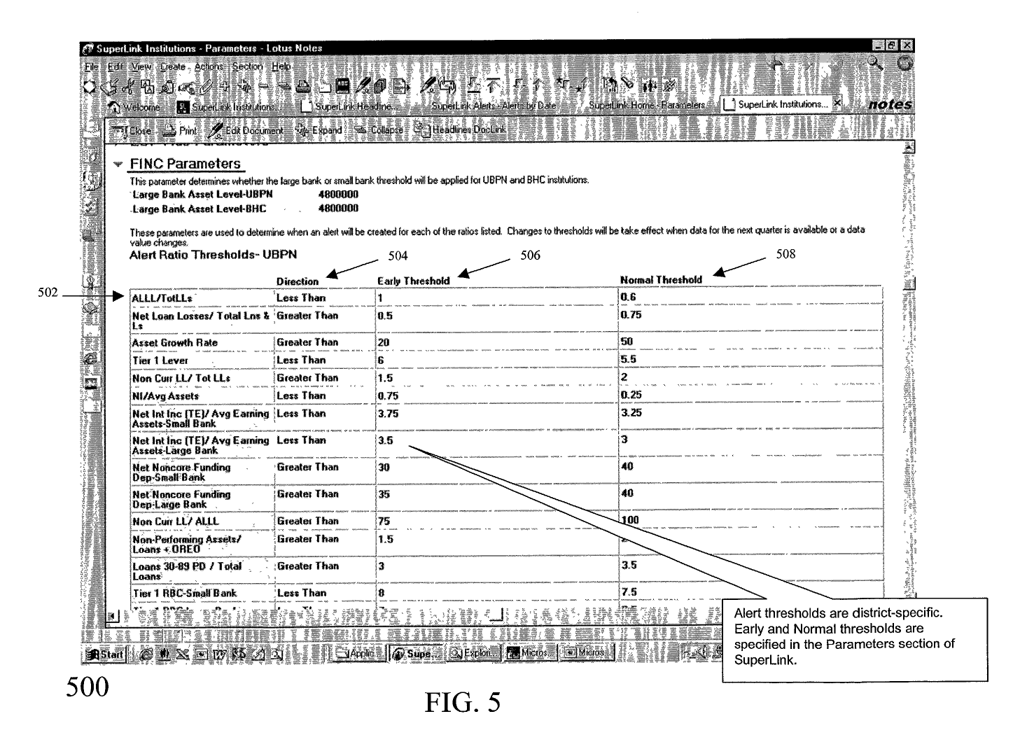

Referring to FIG. 5, there is shown an Alert Threshold Parameters screen generally designated 500. This screen allows a user to set the parameters for generating an alert. The screen is comprised of four columns, the first column is the data 502 that is to be compared for generating the alert. The second column is the direction 504 that the data is compared. The direction determines whether an increasing or decreasing value will generate the alert. For example if the alert direction is less than, then no alert is generated whenever the value of the field listed in the data 502 column increases, however an alert is generated when the value increases beyond the threshold value. The remaining two columns, Early Threshold 506 and Normal Threshold 508, are the values that the field are compared against. It should be noted that the value for Early Threshold 506 and Normal Threshold 508 typically contain different values. The enables an early warning to be generated before a critical problem develops. Alert thresholds are specific to the district to which the data pertains. Alerts may also be generated based on an event.

The Risk database 114 (FIG. 1) is a workflow and reporting application which supports the creation and approval of Risk Assessments. The Risk Assessment Database 114 (FIG. 1) provides a comprehensive method for preparing, reviewing and reporting risk assessments. The risk assessment should highlight both the strengths and vulnerabilities of an institution as well as providing a foundation for determining the supervisory activities to be conducted. Further, the assessment should apply to the entire spectrum of risks facing an institution. Therefore the entire SuperLink Risk Assessment program is driven by the following six risk factors.

Credit risk, which arises from the potential that a borrower or counter party will fail to perform on an obligation. Market risk, which is the risk to a financial institution's condition resulting from adverse movements in market rates or prices, such as interest rates, foreign exchange rates, or equity prices. Liquidity risk, which is the potential that an institution will be unable to meet its obligations as they come due because of an inability to liquidate assets or obtain adequate funding (referred to as “funding liquidity risk”) or that it cannot easily unwind or offset specific exposures without significantly lowering market prices because of inadequate market depth or market disruptions (“market liquidity risk”). Operational risk, which arises from the potential that inadequate information systems, operational problems, breaches in internal controls, fraud, or unforeseen catastrophes will result in unexpected losses. Legal risk, which arises from the potential that unenforceable contracts, lawsuits, or adverse judgements can disrupt or otherwise negatively affect the operations or condition of a banking organization. Reputational risk, which is the potential that negative publicity regarding an institution's business practices, whether true or not, will cause a decline in the customer base, costly litigation, or revenue reductions.

A risk assessment matrix (see FIGS. 5-8) is used to identify significant activities, the type and level of inherent risk in these activities, and the adequacy of risk management over these activities as well as to determine composite risk assessments for each of these activities and the overall institution.

Once the significant activities are identified, a composite risk “rating” of high, medium or low as well as a trend “rating” of increasing, decreasing, stable must be assigned. The composite risk rating assigned should be based on the following guidelines:

A high composite risk generally would be assigned to an activity where the risk management system does not significantly mitigate the high inherent risk of the activity. Thus, the activity could potentially result in a financial loss that would have a significant negative impact on the organization's overall condition, even in some cases where the systems are considered strong. For an activity with moderate inherent risk, a risk management system that has significant weaknesses could result in a high composite risk assessment because management appears to have an insufficient understanding of the risk and uncertain capacity to anticipate and respond to changing conditions. A moderate composite risk generally would be assigned to an activity with moderate inherent risk where the risk management systems appropriately mitigate the risk. For an activity with a low inherent risk, significant weaknesses in the risk management system may result in a moderate composite risk assessment. On the other hand, a strong risk management system may reduce the risks of an inherently high-risk activity so that any potential financial loss from the activity would have only a moderate negative impact on the financial condition of the organization. A low composite risk generally would be assigned to an activity that has low inherent risks. An activity with moderate inherent risk may be assessed a low composite risk where internal controls and risk management systems are strong and effectively mitigate much of the risk.

The Risk database 114 maintains a High Risk Institution list (not shown). When an institution has been assigned one or more High rating in any risk category in any risk assessment, it is automatically placed on the High Risk Institutions Report.

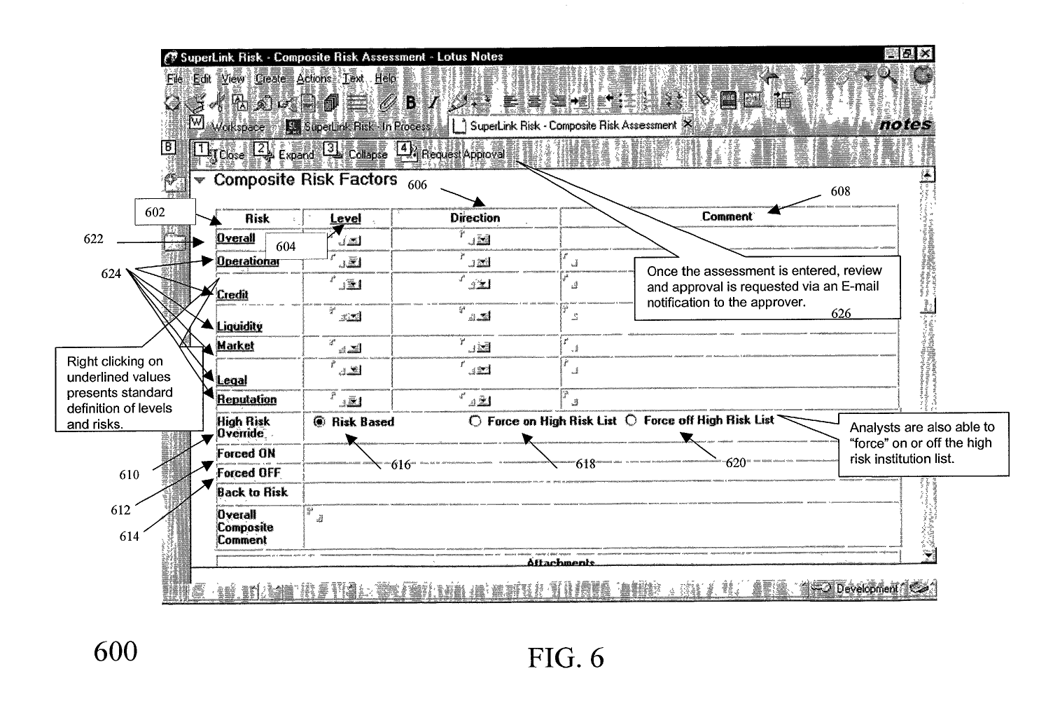

FIG. 6 shows an example screen snapshot 600 of the various data utilized by the Risk database 114. This form is comprised of four columns. The Risk column 602 contains the various risk factors. By selecting a Risk Factor in this column a user should observe, or changes the values utilized for the institution's risk assessment. The Level column 604 shows the risk level for the corresponding risk factor in column 602. The Direction column 606 lists whether the Risk Level 604 in the preceding column is improving or deteriorating. The Comments column 608 enables a user to enter in comments explaining a risk assessment. The High Risk Override 610 provides a button based selection method for overriding the risk assessment made by the system. Selecting the Risk Based button 616 directs the Risk database 114 to use the risk Level 604 values automatically computed by the system. The Force on High Risk List button 618 enables a user to place an institution on the High Risk list even if none of its risk factors are sufficient to place the institution on the High Risk list. The Forced ON 610 field enables the user to enter a reason for forcing the institution onto the High Risk list. Similarly, an institution may be removed from the High Risk list by selecting the Force off High Risk list button 620, and reasons for forcing an institution off the High Risk list may be entered into the Forced OFF field 614. The overall risk assessment 622 is computed from a plurality of risk factors 624.

Incorporated into the risk assessment database is an approval process. Once a risk assessment is completed it must be approved by the Portfolio Manager/Supervisor. Upon completion of the risk assessment, the Central Point of Contact (CPC) will “Request Approval” of the document by the Portfolio Manager/Supervisor of the company. This means that an electronic mail notification will be sent to the Portfolio Manager. Upon receipt of the assessment, the Portfolio Manager/Supervisor will review the document and then either approve or reject it. When the Supervisor “approves” the document it will then be placed on the Approved View, the History View, and the Portfolio View. The CPC will receive a communication such as an electronic mail, stating that the assessment has been approved by the supervisor. However, if the Portfolio Manager/Supervisor rejects the assessment, notification, such as an electronic mail notification in the preferred embodiment, will be sent back to the CPC stating that the document was “rejected”. The CPC will need to make the necessary corrections to the document and then resubmit the assessment to the Supervisor for approval. After the user has reviewed or changed a risk assessment, the user may forward the assessment to a supervisor by selecting the Request Approval button 626. Selecting the Request Approval button 626 causes the system to send a communication, such as an electronic mail, to an approver to review the assessment. While many of the communications of the preferred embodiment disclose electronic mail as a preferred medium of communication, it will be apparent to one of ordinary skill in the art that any suitable communication mechanism may suitably be implemented. By way of example, direct software interaction through terminal access, telephonic communication, wireless communication pagers, WAP devices and the like are suitable for such communication and are readily available digital communication methods.

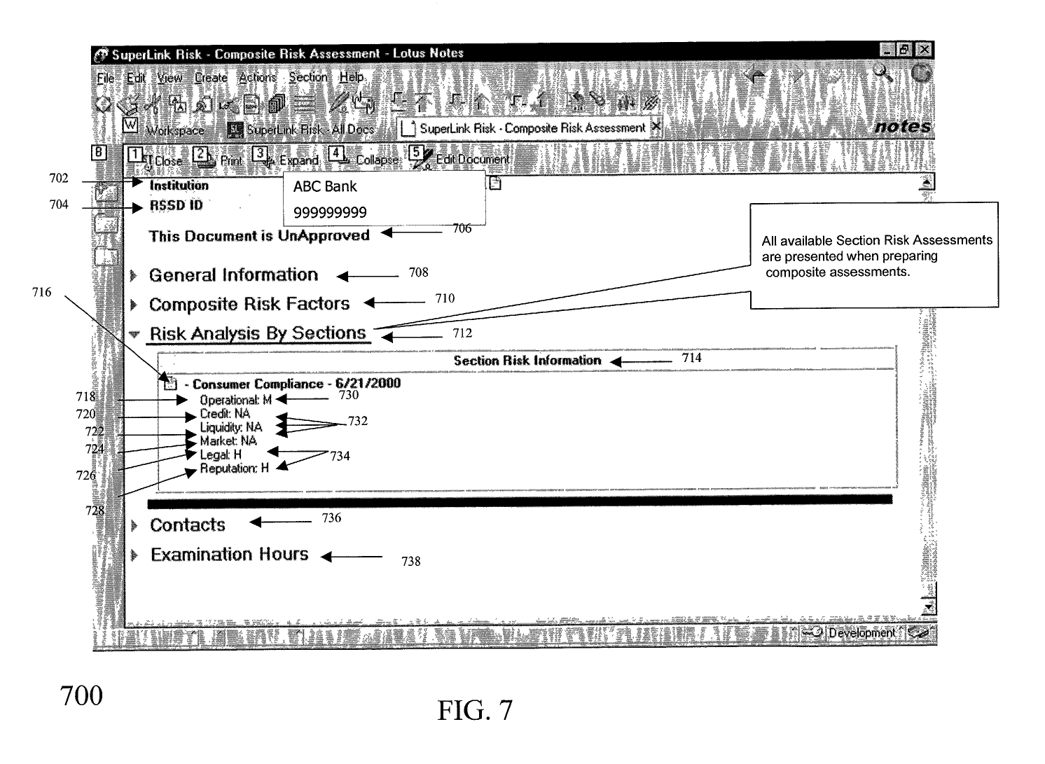

Referring to FIG. 7, there is shown an example of a Composite Risk Assessment screen 700. A Composite Risk Assessment is an overall assessment that will be entered into other national legacy databases. Section Risk Assessments are used to provide information for the composite risk assessment. The Institution name 702 and RSSD ID 704 identify the institution. Below the institutional information is the approval status 706. General information can be obtained by selecting General Information 708. When Risk Analysis by Sections 712 is selected, the various risk assessments by section are displayed. As shown in FIG. 7, after selecting the Risk Analysis by Sections 712, a Section Risk Information window 714 is displayed. Contained within the window 714 is the data regarding the Section and Date of risk assessment 716, the types of risks assessed, which as shown are Operational 718, Credit 720, Liquidity 722, Market 724, Legal 726, and Reputation 728. The rating for each lo type of risk assessment is located adjacent to that type. For example, in FIG. 7 the Operational risk assessment 718 is shown as medium 730. The Credit 720, Liquidity 722, and Market 724 risk assessments are shown as N/A 732. The Legal 726 and Reputation 728 risk assessments are rated High 734. Finally, Contacts 736 and Examination Hours 738 are displayed.

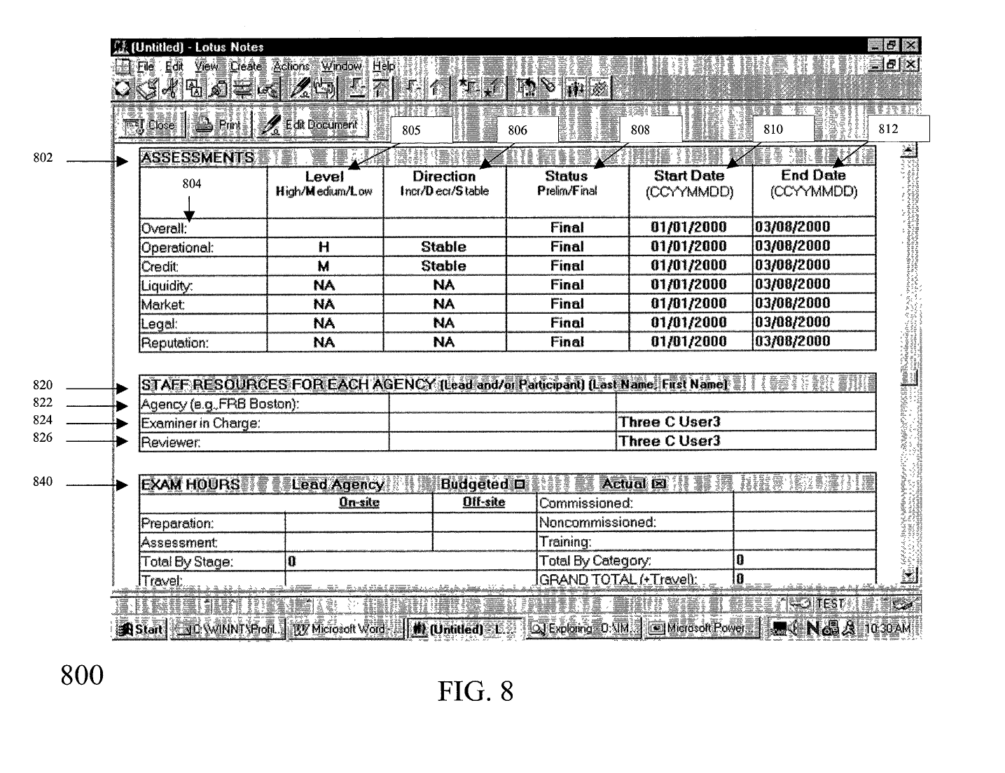

More detailed Composite Risk Assessment data is obtained on a form similar to that as shown in FIG. 8. The screen 800 is generally divided into three sections, Assessments 802, Staff Resources 820, and Exam Resources 840.

The first section Assessments 802 is comprised of six columns. The first column 804 gives the risk factor. The second column 805 the risk level. The third column 806 is the direction. The status of the exam, preliminary or final is displayed in the third colunmn 808. Finally, the Start Date 810 and End Date 812 are shown. The Staff Resources for each agency 820 displays the Agency 822, Examiner in Charge 824 and Reviewer 826 for the assessment. The Exam Hours section 840 displays the various hours spent in conducting the assessment.

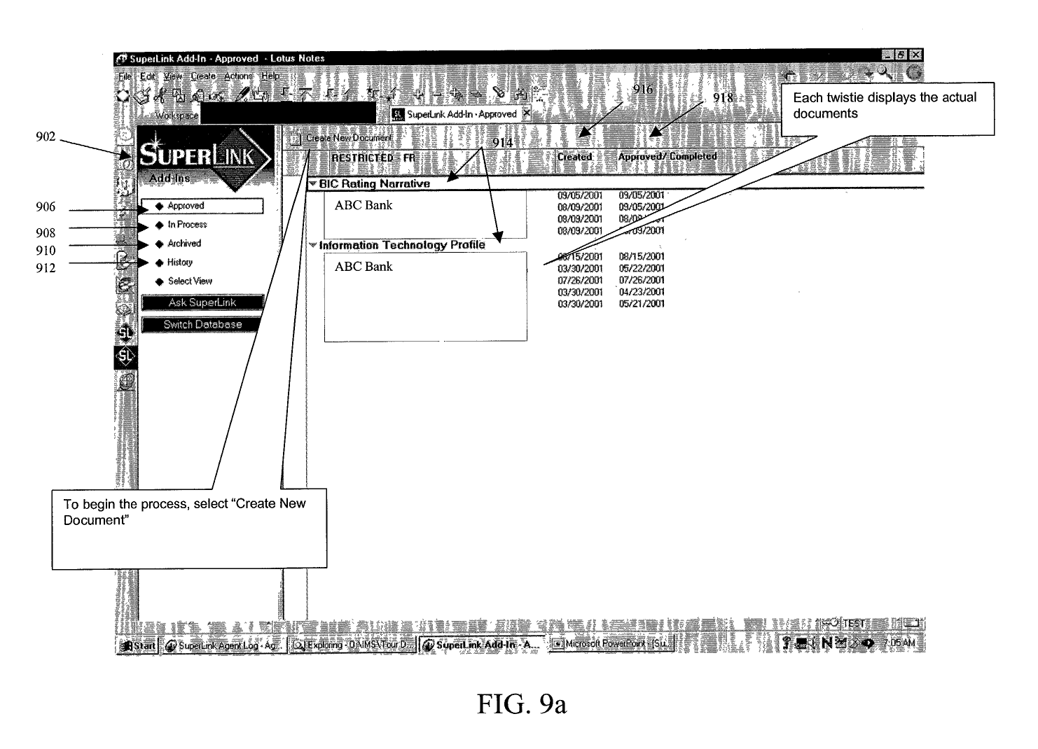

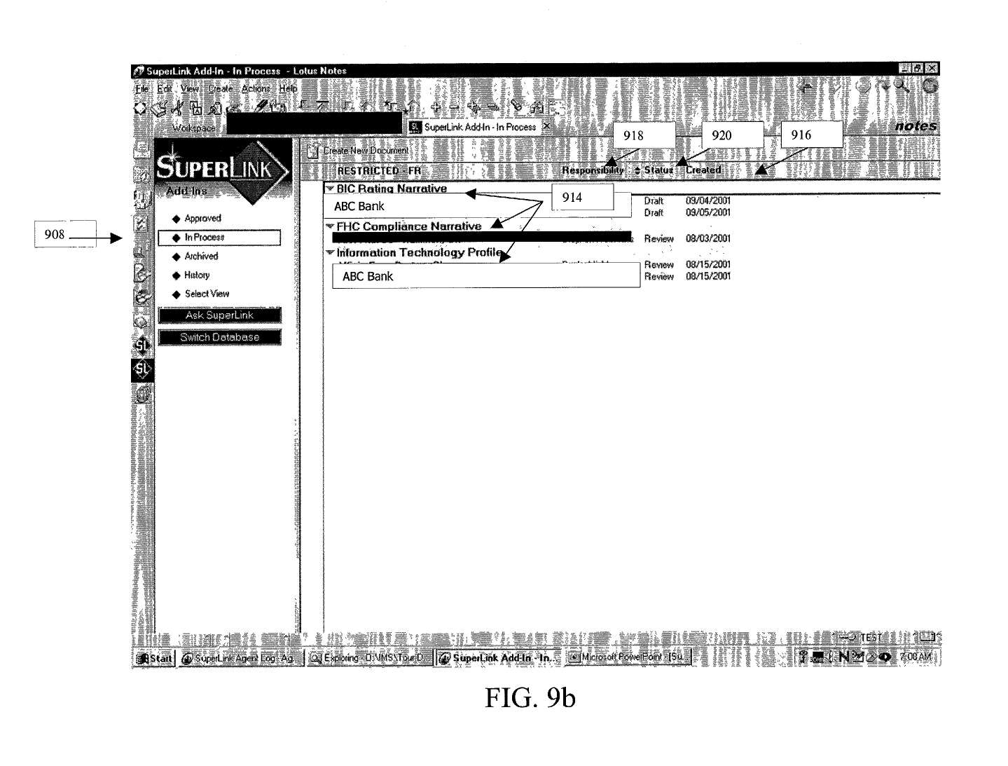

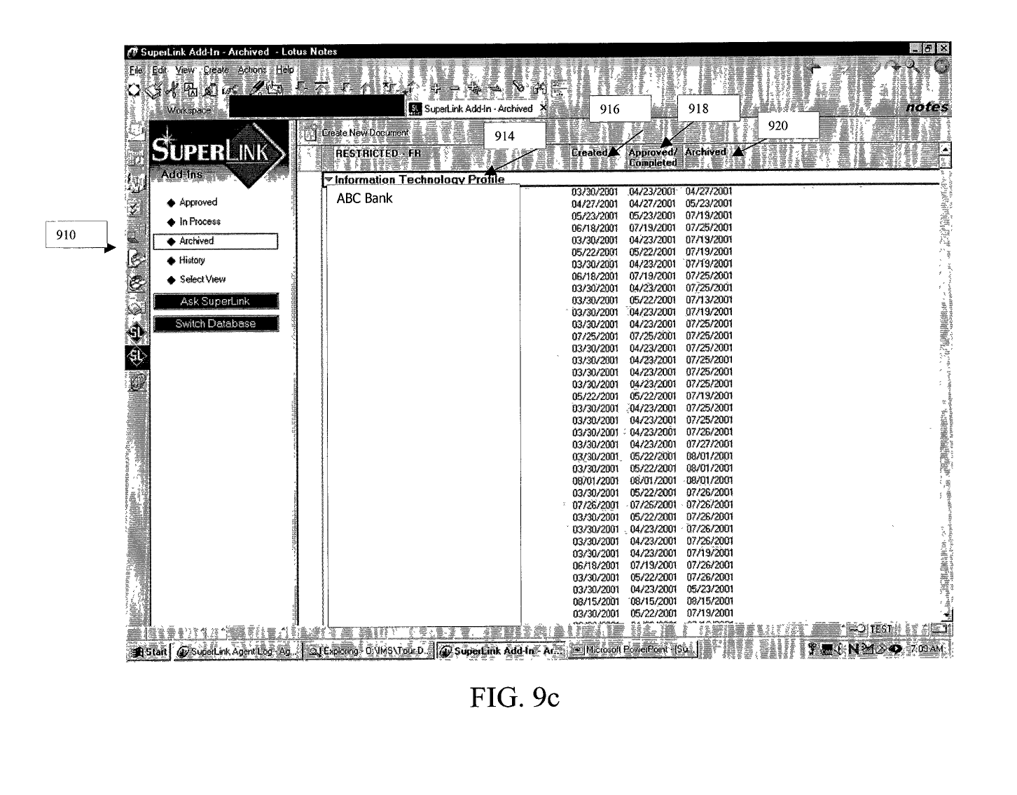

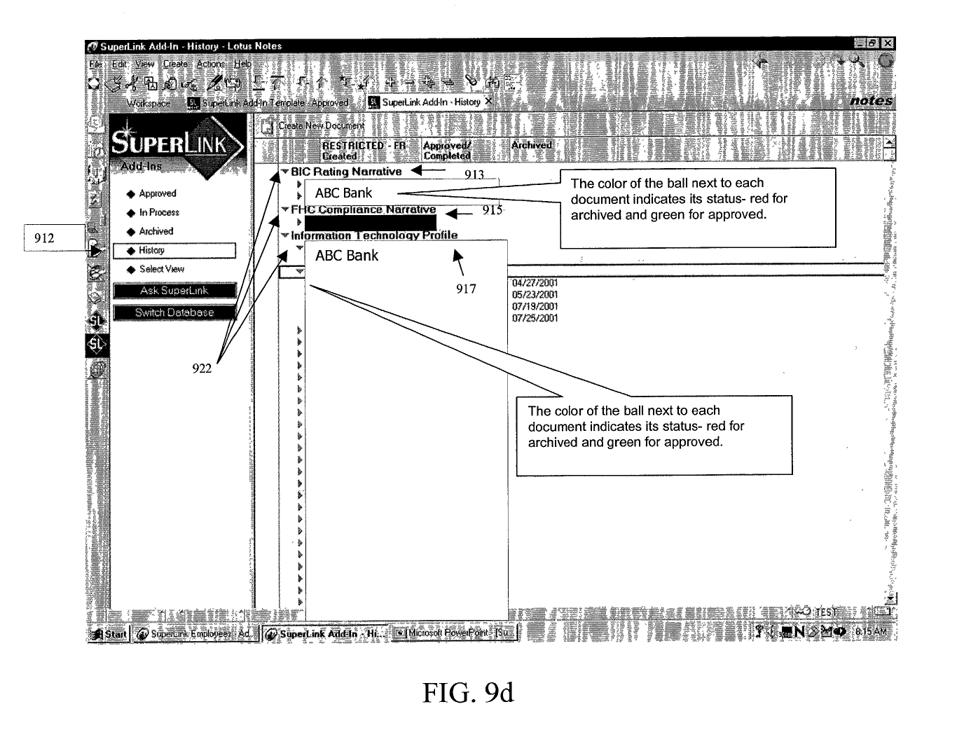

The Add-Ins database 106 is a workflow and reporting application that currently supports the creation and approval of borrower in custody (BIC) and FHC compliance narratives and informnation technology profiles. The existing infrastructure allows for rapid development of new document types that will utilize a standard workflow process, linkage to either institution 120 or employee profiles 128, and an alert 104 system. The Add-Ins Database 106 has greater flexibility for capturing knowledge that doesn't fit anywhere else. Borrower in custody narratives 914 about collateral arrangements that permit depository institutions in sound financial condition to retain possession of assets they pledge as collateral to secure advances from the discount window are stored in the Add-Ins database (FIG. 9a). If an institution is a Financial Holding Company, the FHC compliance narratives (not shown) are also stored in the Add-Ins database. The information technology profiles is used by the Add-Ins database 106 to store additional information about Information Technology exams. All institutional related Add Ins are linked to each respective institution profile. Finally, the Add-Ins database 106 is used for miscellaneous documents.

Examples of Add-In views are shown in FIGS. 9a-9d. The displays of FIGS. 9a-9d are comprised of two side by side windows. The left pane 902 is used to select which view is desired. The appropriate template is selected in the right pane 902 by selecting In Process 908 and selecting the corresponding template. FIG. 9a shows the Approved 906 view. There are three fields for the approved template, the first field gives the document title 914, followed by the created date 916 and the approved/completed date 918.

FIG. 9b shows the display when the In Process 908 view is selected. Like FIG. 9a, this displays the document title 914, and the Created date 916. In addition, Responsibility 918 and Status 920 are displayed. Similarly, FIG. 9c shows a sample screen display when the Archived 910 view is selected. The document title 914, Created Date 916 Approved/Completed date 918 are again displayed, but in addition the Archived date 920 is shown. When the History view 912 is selected, a screen similar to FIG. 9d suitably appears. An icon 922 next to the document title is provided, which advantageously indicates the document status. In the preferred embodiment, red means archived, green means approved. FIG. 9d also displays the various types of documents stored in the Add-Ins database 106. For example in FIG. 9d the documents shown are a BIC Rating Narrative 913, FHC Compliance Narrative 915, and an Information Technology Profile 917.

The Web Links database 108 is accessible from the Headlines Page 102. Web links provides a list of relevant web links or any other suitable like to other information sources, such as FTP, Telnet sessions.(?) Clicking on an entry will open a browser and launch the associated web site. Web links can be created by users and shared. Web Links can be of general interest or used to store information about services offered on supervised institutions' web sites. Web Links are also linked to IT Institutional Profiles.

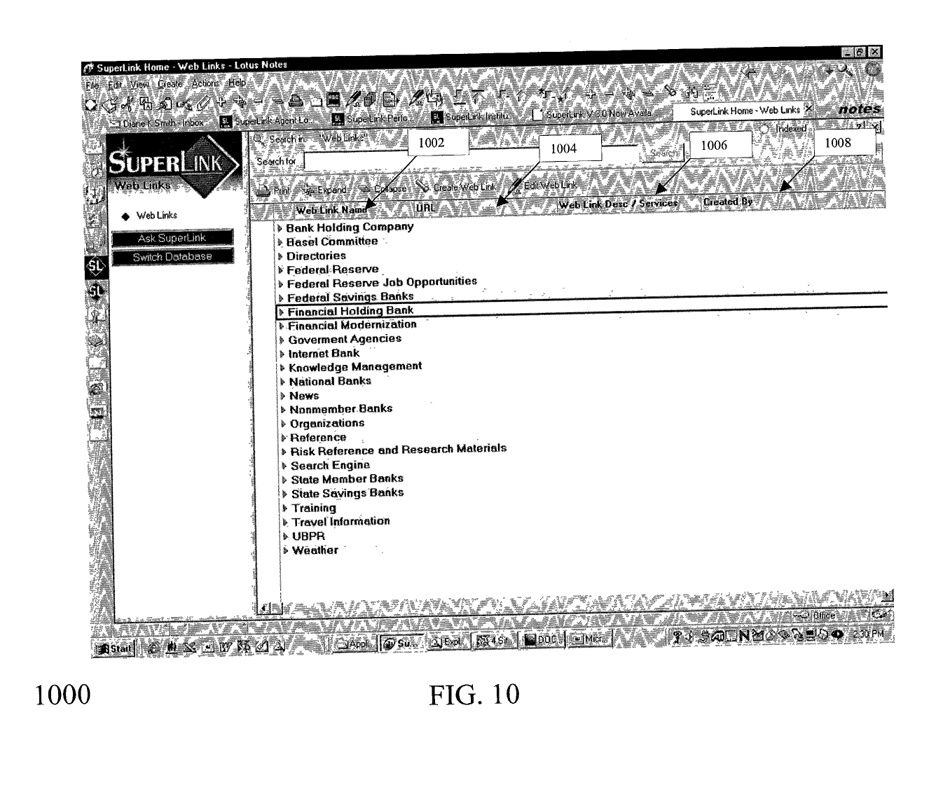

FIG. 10 shows an example Web Links screen 1000. The screen 1000 is comprised of four columns. The web link name 1002 is displayed in the first column. The URL 1004 or web address is shown in the second column. The Description 1006 of the Web Link or Services provided by the web link are shown in the third column. The created by 1008 column lists who created the web link.

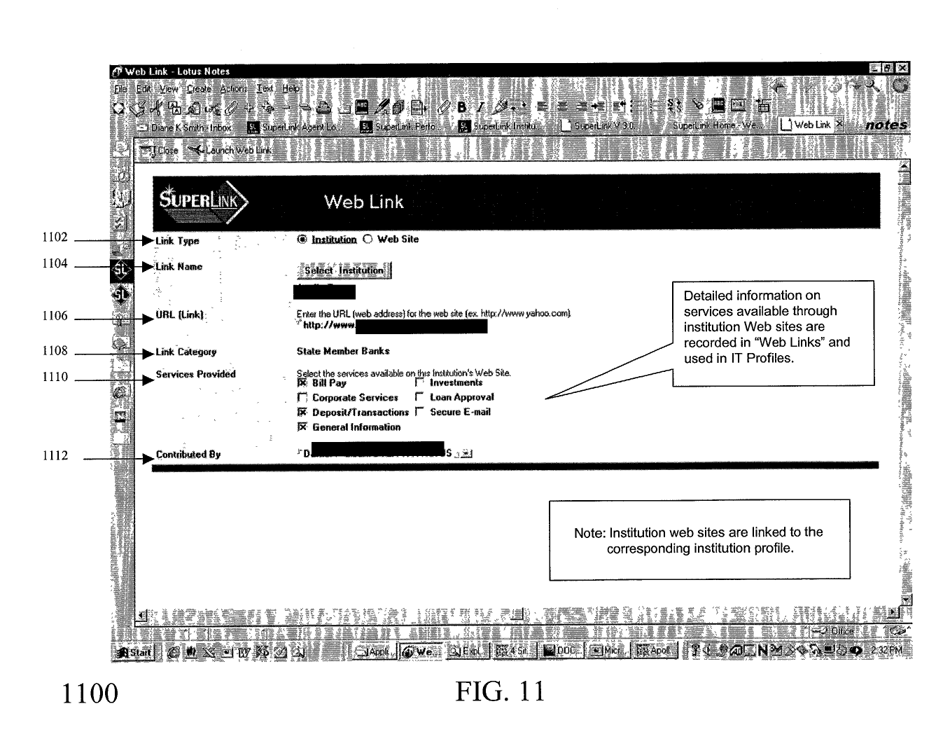

FIG. 11 shows a web link data screen 1100. The Link type 1102 is a button field that shows the link is either an institution or general web site. The Link Name 1104 can either be the name of the institution or a name may be inserted. The URL link 1106 is the web address for the link. The Link Category 1108 is the category of the link. The Services Provided 1110 is used to list what services are available on an institution's web site. Finally, the contributor 1112 information is displayed.

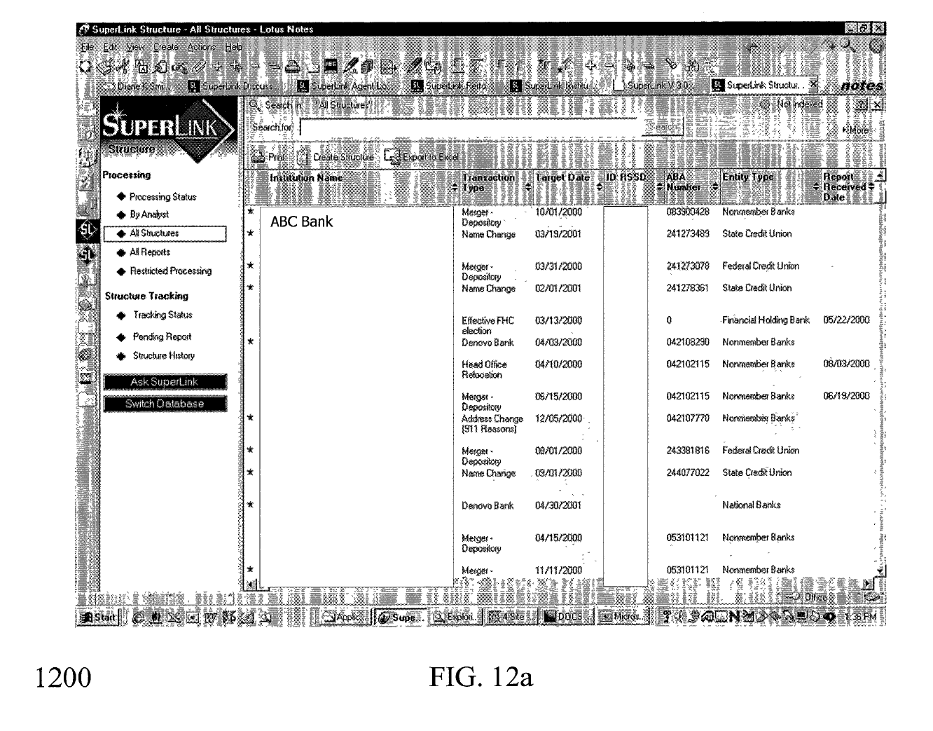

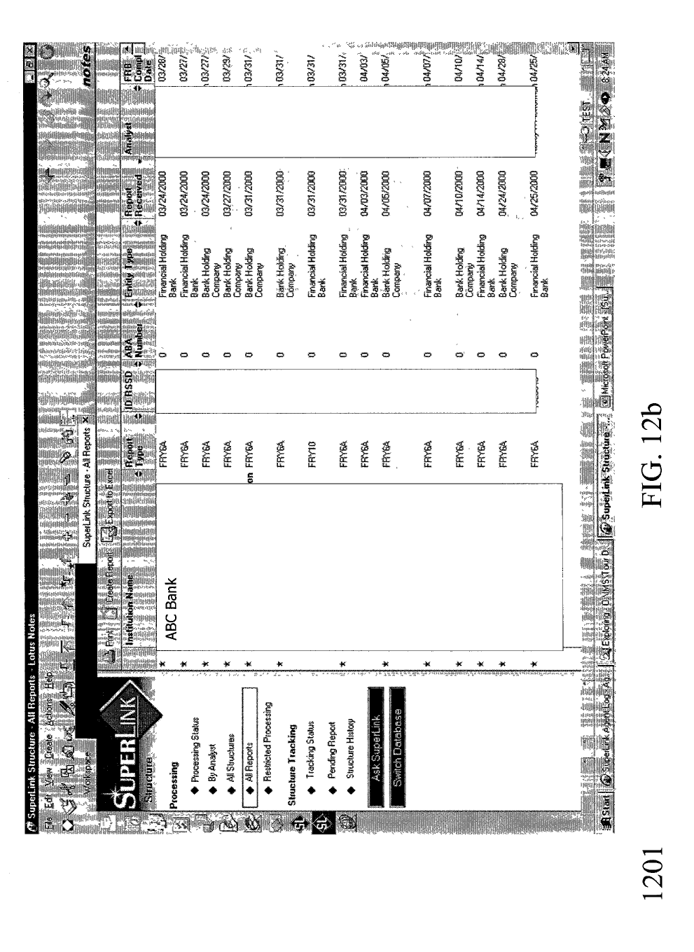

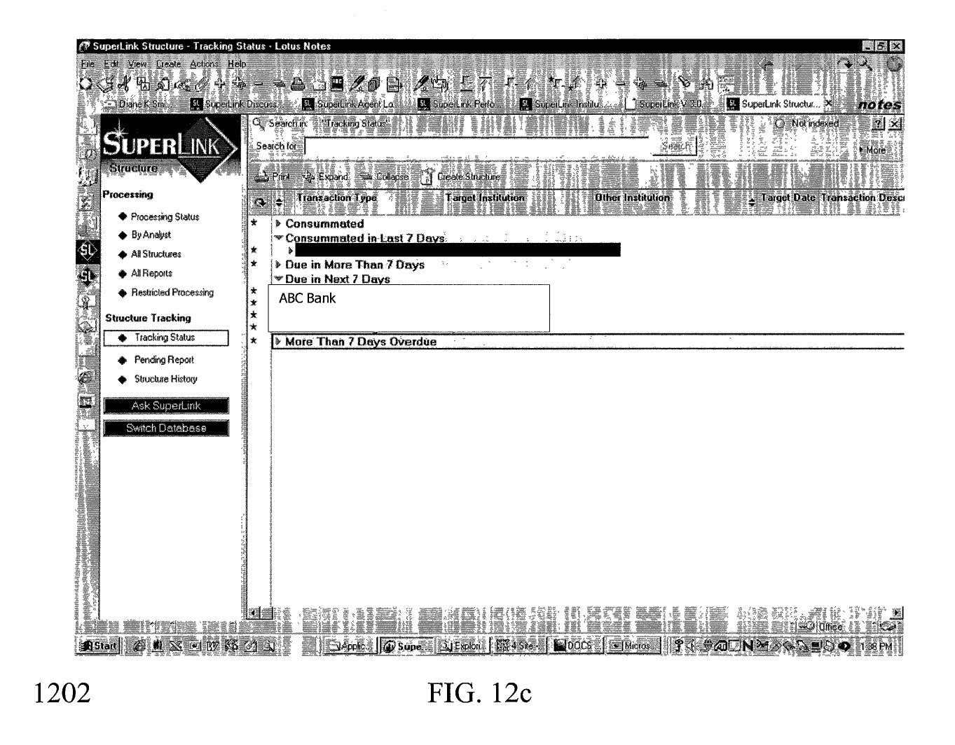

The Structure Database 110 handles structure event tracking. The Structure Database 110 work flows structure event processes. The Structure Database 110 also work flows report receipt and processing. The Structure Database 110 handles notification to external operating departments of pending and consummated events. The Structure Database 110 generates is Alerts for internal SuperLink users. The Structure Database 110 provides views of structure events, pending and historical. FIG. 12a is an example All Structure view 1200. This reports lists Institution Name, Transaction Type, Target Date, RSSD ID, ABA Number, Entity Type, and Report Received date and represents all available documents in the database. Sorting on every column is also available. FIG. 12b shows an example of the All Reports view 1201 which is used to track the receipt and processing of structure event reporting by institutions. This view shows Institution Name, Report Type, RSSD ID, ABA Number, Report Received, Analyst, and FRB completion date. Finally FIG. 12c shows the Tracking Status view 1202. As shown in FIG. 12c, reports may be generated for transaction types of Consummated, Consummated in Last 7 Days, Due in More Than 7 Days, Due in Next 7 Days, and More Than 7 Days Overdue.

The Performance Database 116 is used for corporate and departmental performance tracking. The Performance Database 116 provides Balanced Scorecard information. The Performance Database 116 is advantageously set up to implement industry standards. The Performance Database 116 utilizes icons to show whether objectives are not met (red x), mostly met (yellow ball), met (green check), or exceeded (green diamond) in the preferred embodiment. The Performance Database 116 also includes goal and action information.

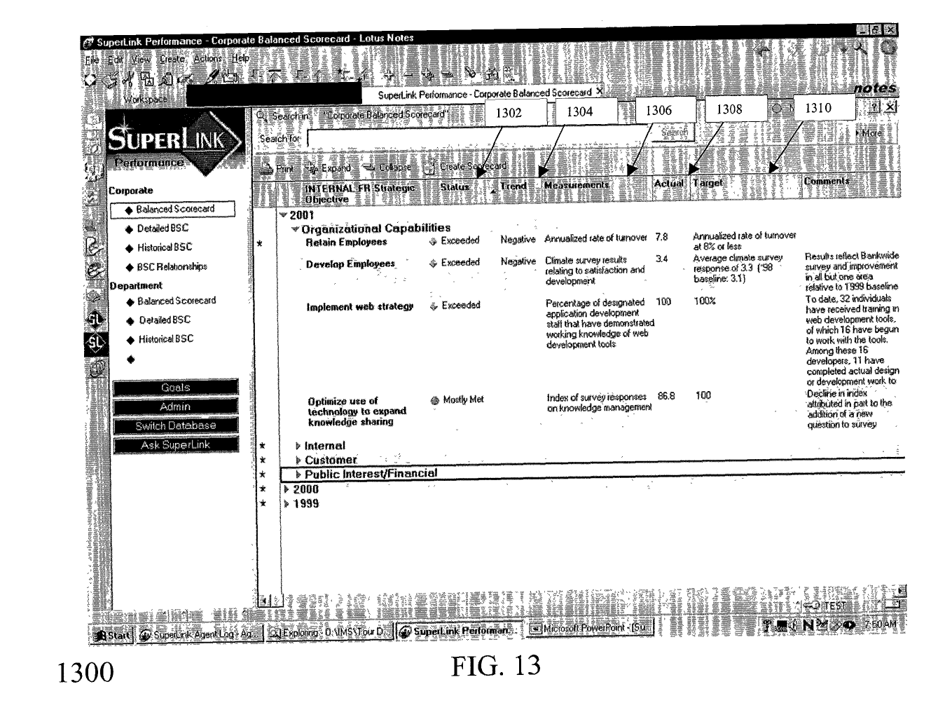

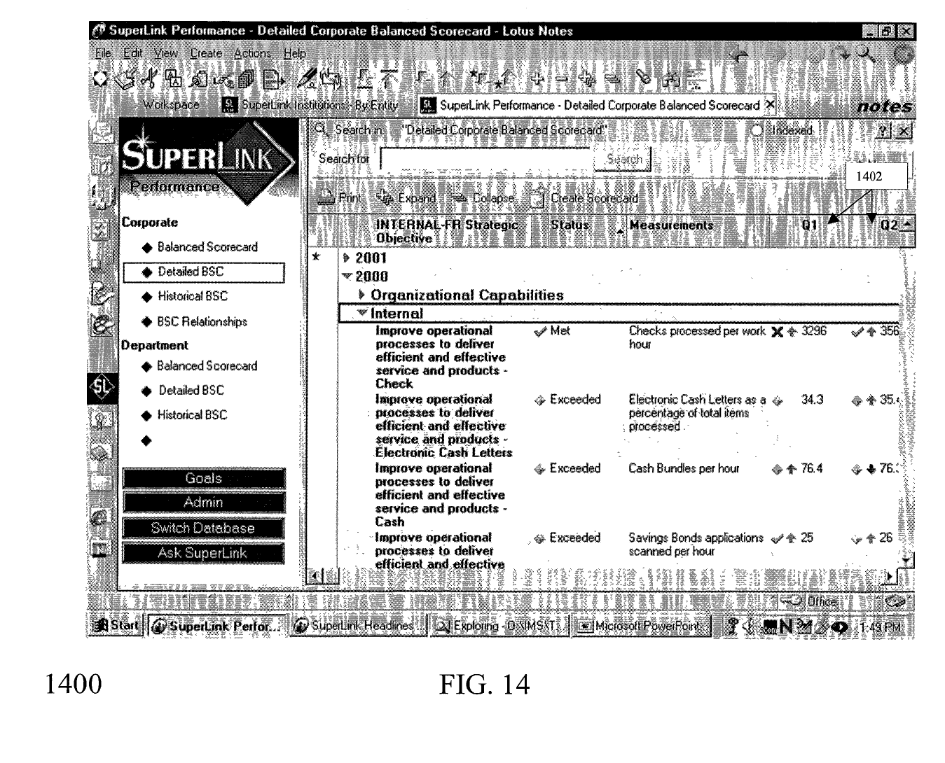

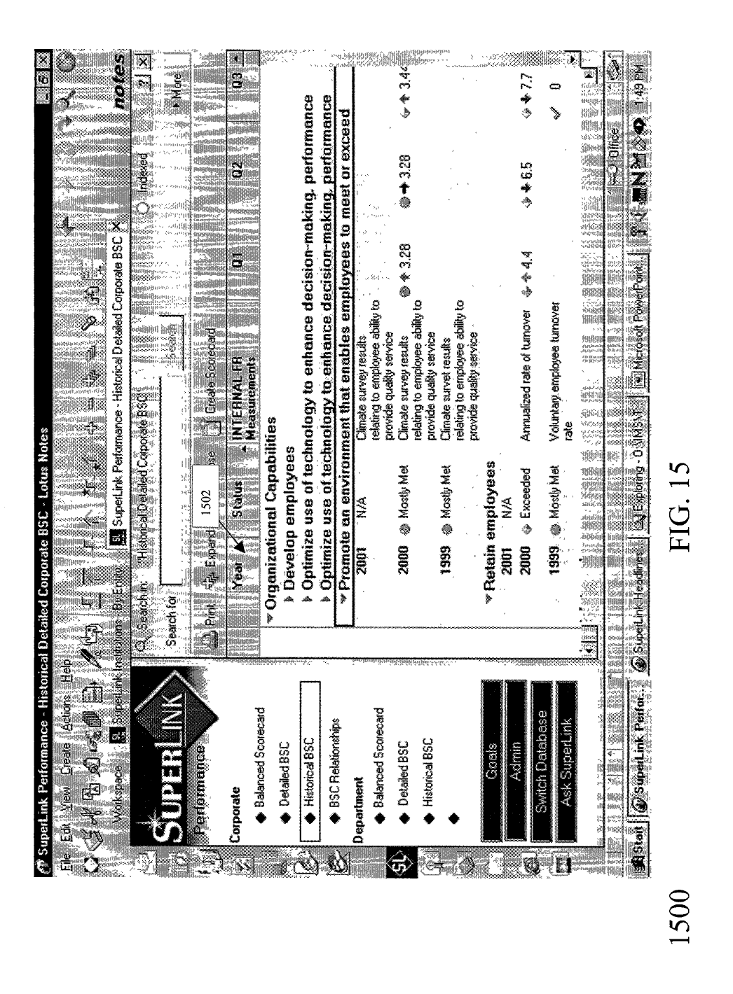

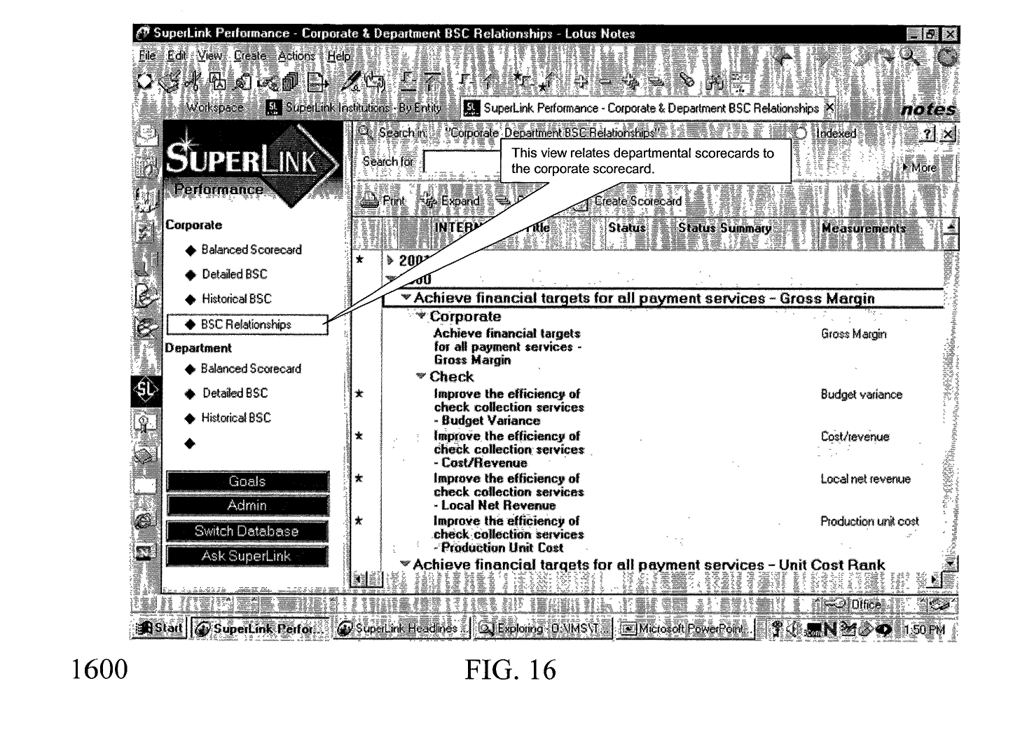

FIG. 13 shows an example of the Corporate Balanced Scorecard view 1300. The Balanced Scorecard view 1300 is divided into a plurality of columns. One column shows the status 1302 of a balanced scorecard item. The next column shows the year to date trend 1304. Another column shows the measurements 1306. Still another column shows the actual data 1308. Yet another column 1310 displays the target value. FIG. 14 shows an example of the Corporate Detailed Balanced Scorecard view 1400. This view shows similar data as the Balanced Scorecard view 1300, and in addition shows quarterly data 1402. FIG. 15 is an example of the Corporate Historical Balanced Scorecard view 1500. This view has similar data fields as the detailed Balanced Scorecard view 1400 and in addition lists the Year 1502 for multi-year comparisons of the performance rating. FIG. 16 shows an example of the Corporate Balanced Scorecard Relationships view 1600 which relates departmental scorecards to corporate scorecards.

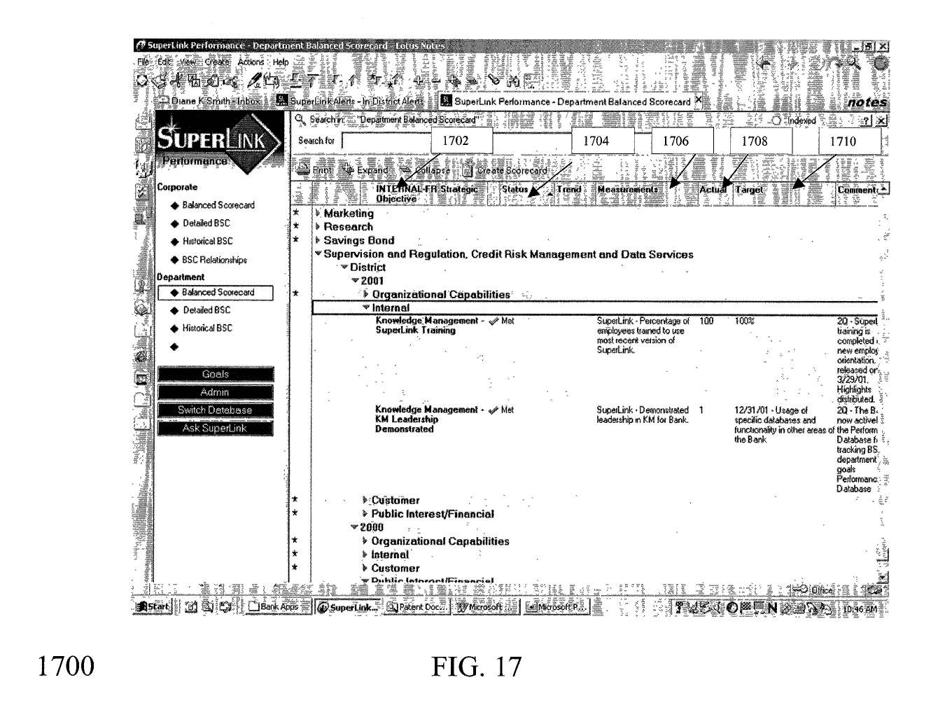

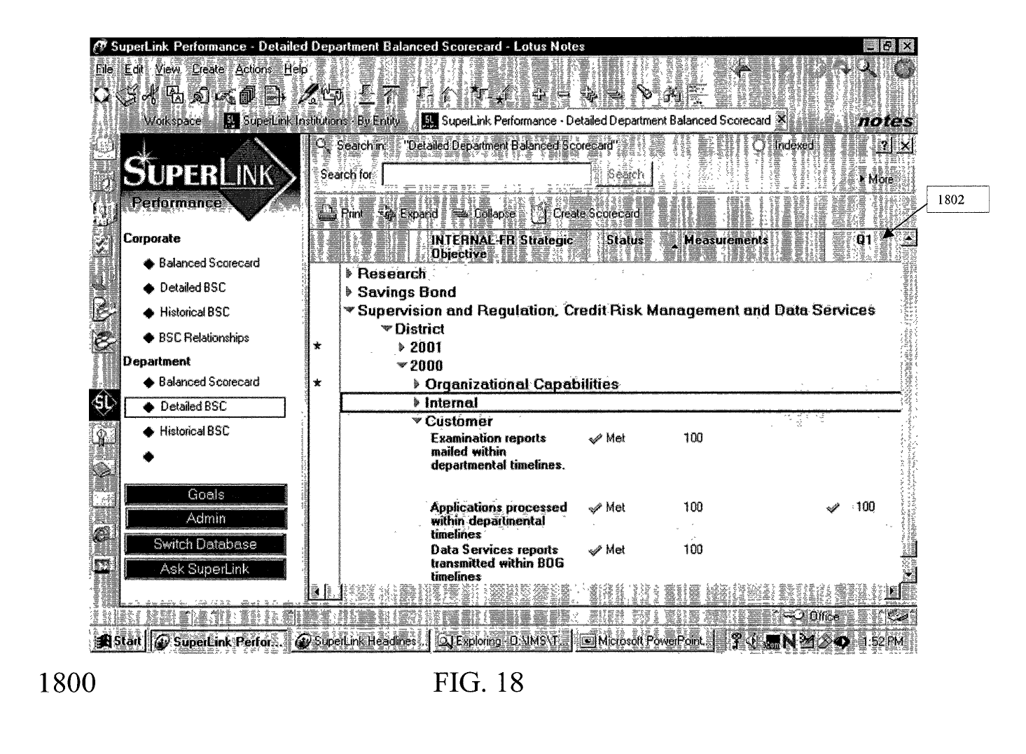

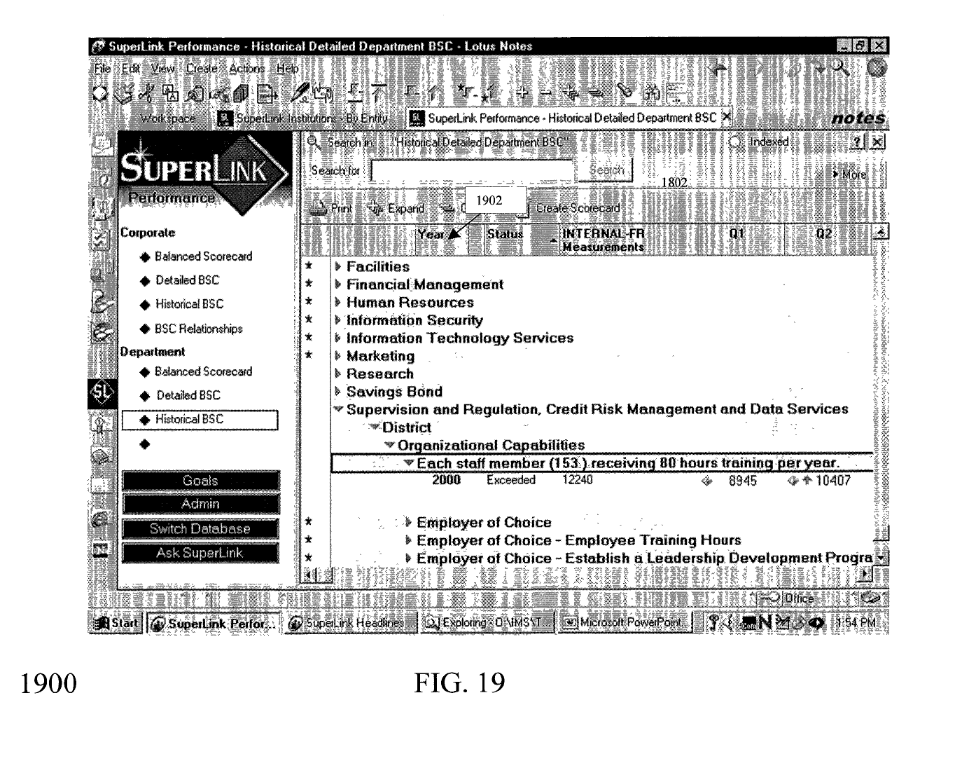

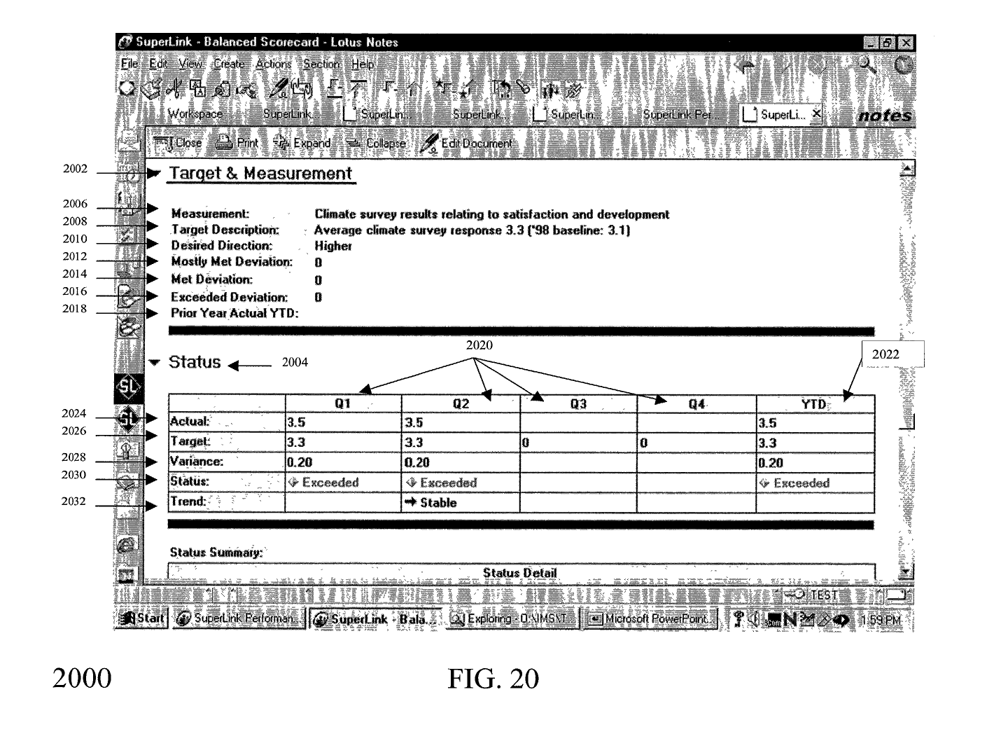

FIG. 17 shows an example of the Departmental Balanced Scorecard 1700. Similar to the Corporate Balanced Scorecard view 1300, this view lists a narrative describing the objective 1702, the status 1704, measurements 1706, actual data 1708, and target data 1710. FIG. 18 is a sample of the Department Detailed Balanced Scorecard view 1800. This view 1800 also shows quarterly breakdowns 1802 for each objective. FIG. 19 is a sample of the Department Historical Balanced Scorecard 1900. This view contains the same fields as FIG. 18, and in addition lists the Year 1902 the performance objective was measured. FIG. 20 shows a Balanced Scorecard document with a detailed Target & Measurement and detailed Status 2000. The Target & Measurement section 2002 shows the Measurement 2006, Target Description 2008, Desired Direction (e.g. Higher/Lower) 2010, the Mostly Met Deviation 2012, the Met Deviation 2014, the Exceeded Deviation 2016, and a measurement of the Prior Year Actual YTD 2018 of this objective if available. The Status section 2004 shows a quarterly breakdown 2020 and Year to Date 2022 figures of the Actual 2024, Target 2026, Variance 2028, Status 2030, and Trend 2032.

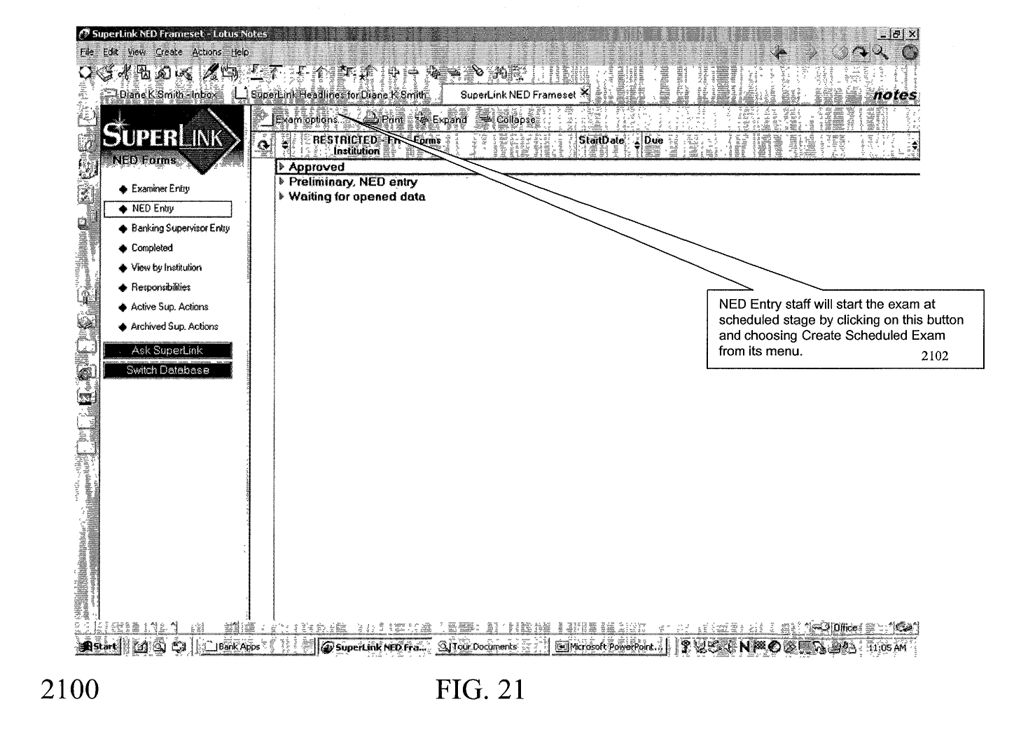

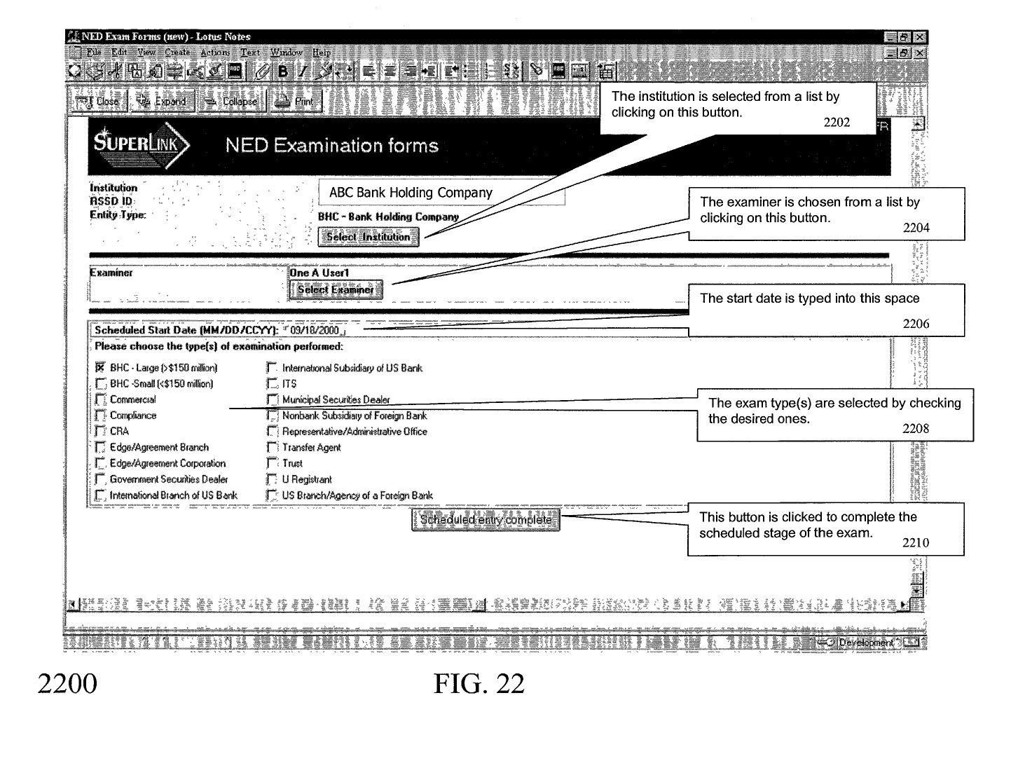

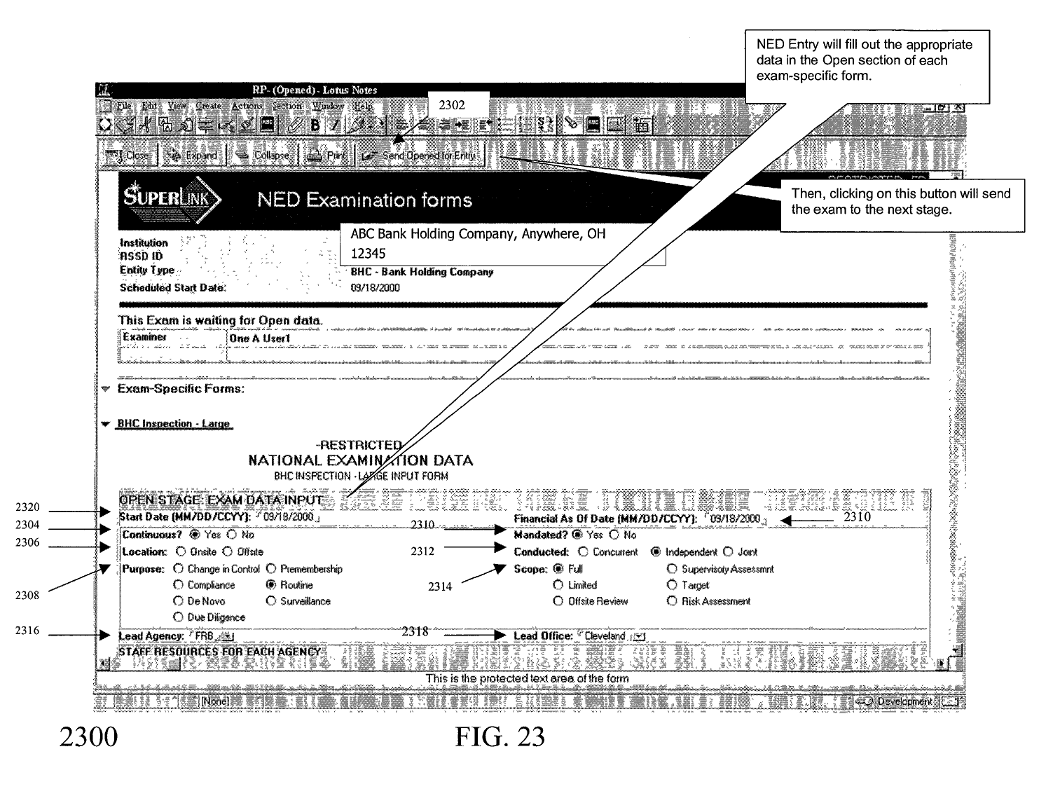

The NED Forms database 118 is used to generate forms for input into a National Examination Data (“NED”) database. Referring to FIG. 21, there is shown a blank NED screen 2100. Selecting Exam Options 2102 starts the exam process. By selecting Create Scheduled Exam from the menu received after selecting Exam Options 2102, a form similar to FIG. 22 will be displayed. The new Exam form 2200 allows data entry for selecting an institution 2202, selecting an Examiner 2204, Scheduled Start Date 2206, and a plurality of checkboxes allow the exam type(s) 2208 to be selected. Finally the Scheduled entry complete button 2210 is selected to complete the scheduled stage of the exam. By entering NED Entry and selecting the appropriate exam, an Opened Stage detail screen 2300 (FIG. 23) will appear. Referring to FIG. 23, the database will automatically fill out the appropriate data on the open stage detail screen 2300. Users can then verify or modify data as needed. Selecting the Send Opened for Entry button 2302 will send the exam to the next stage. This Open Stage Detail Screen 2300 lists the start date 2320 of an exam, whether the exam is Continuous 2304, the Location 2306, and a plurality of checkboxes are used to identify the purpose 2308 of the exam. In addition screen 2300 lists whether the exam is Mandated 2310, how Conducted 2312, the Scope 2314, the Lead Agency 2316, and Lead Office 2318.

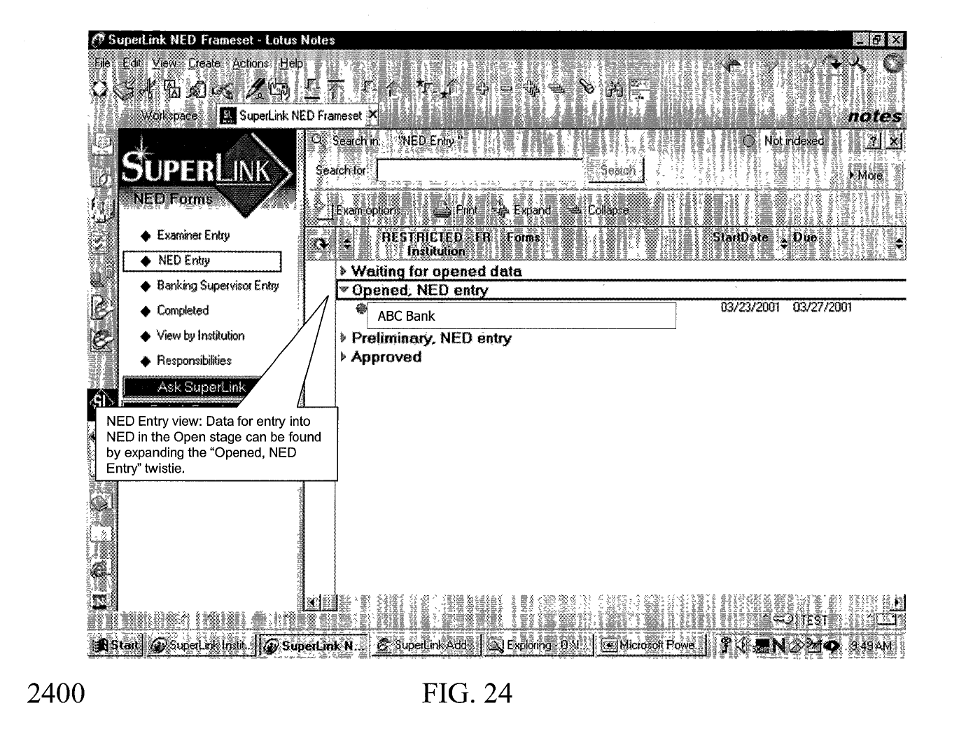

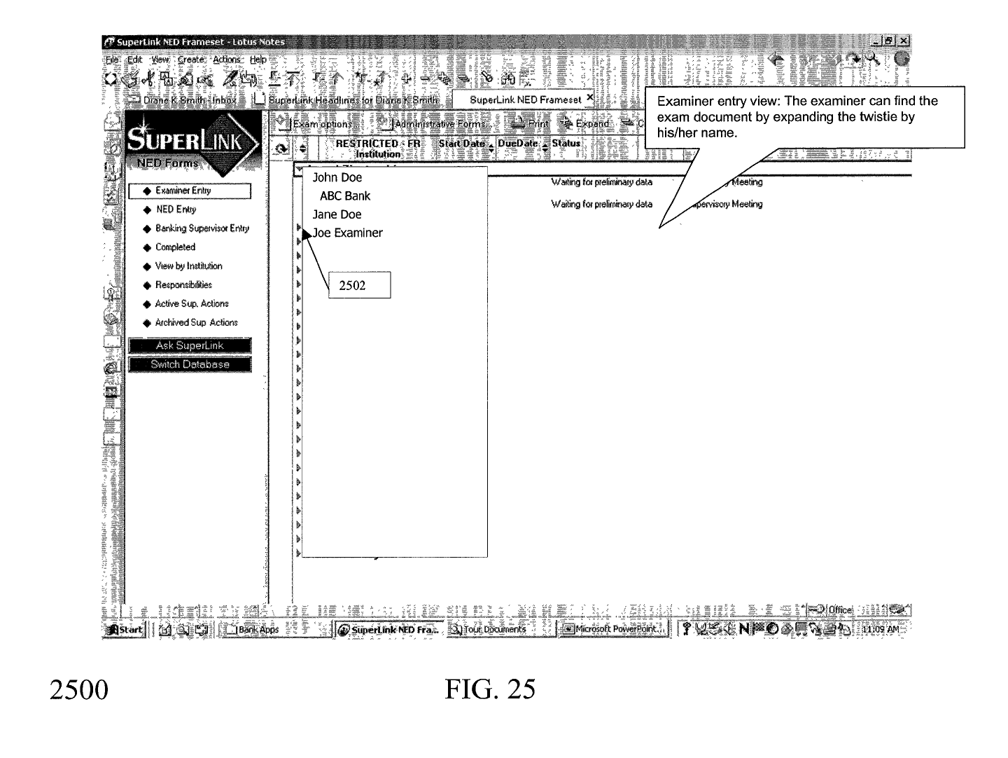

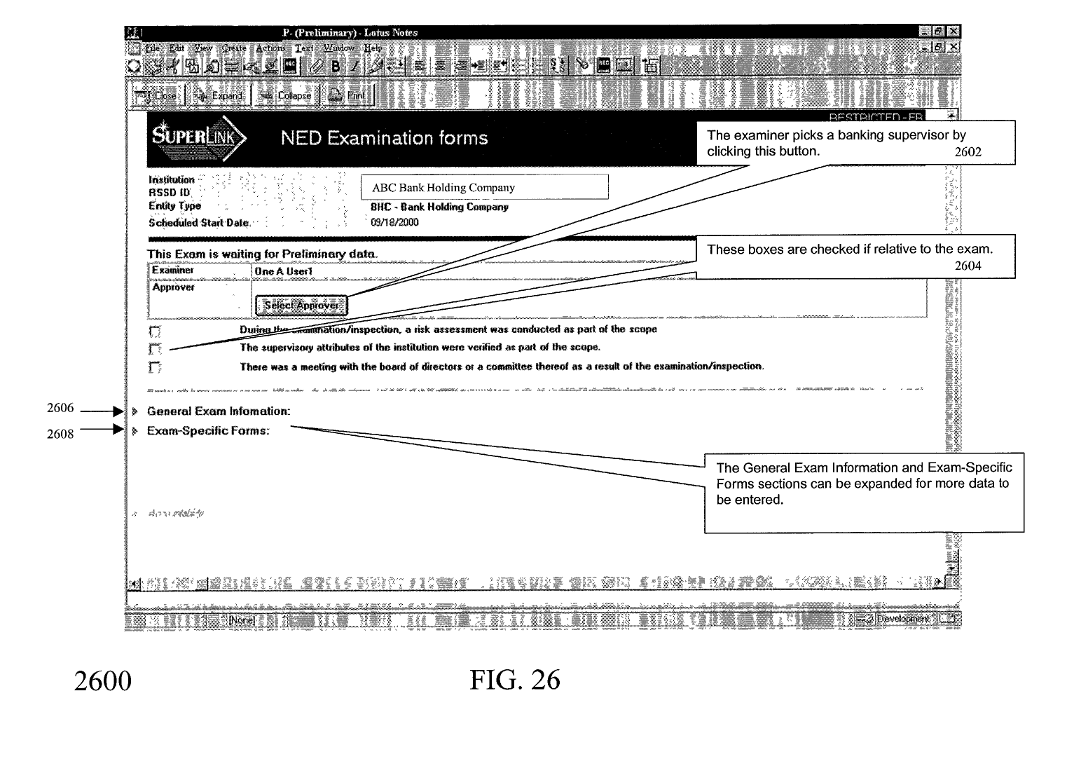

FIG. 24 shows an example of the NED Entry view 2400. FIG. 25 shows an example of the Examiner Entry view 2500. Exam documents may be found by selecting the twistie 2502 next to a name. FIG. 26 shows an example of a detailed Preliminary Stage screen 2600. An examiner may select a banking supervisor by clicking button 2602. A plurality of checkboxes 2604 are provided. These checkboxes 2604 are checked only if relative to the exam. General Exam 2606 and Exam Specific Forms 2608 may be expanded by selecting the appropriate twistie.

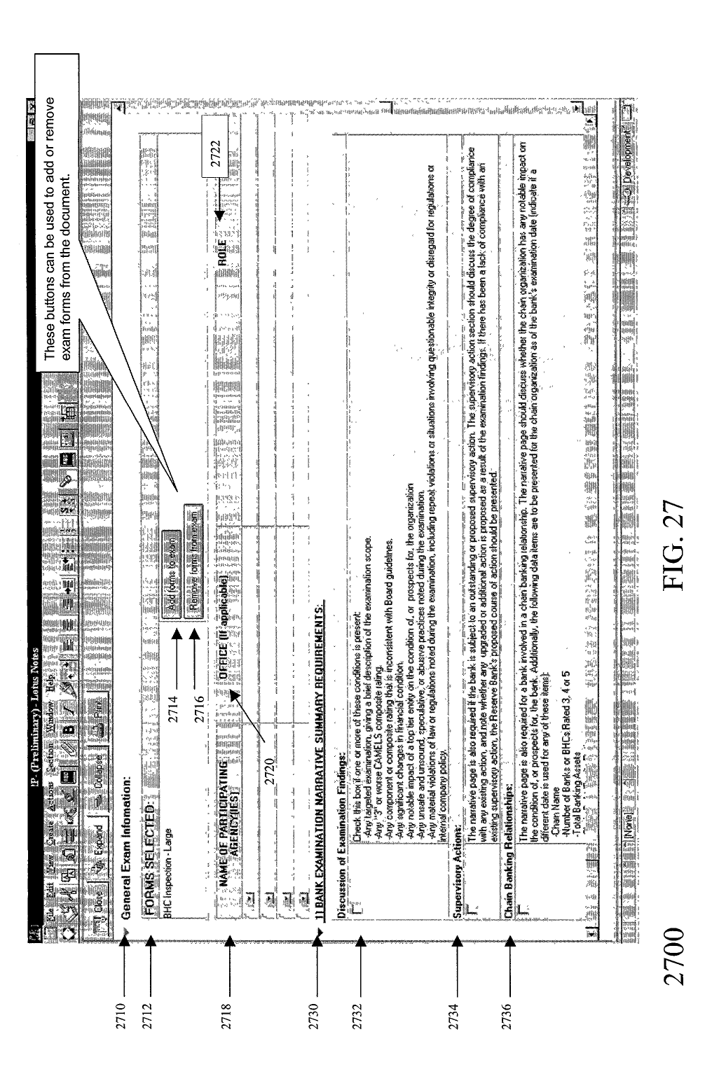

FIG. 27 is an example of additional details available from the Preliminary Stage screen 2600. This screen 2700 shows the General Exam Information section 2710 which includes the Forms selected 2712 along with a button 2714 to Add forms to an exam and a button 2716 to remove forms from an Exam. Also under General Exam Information 2712 are a plurality of columns describing agencies participating in an exam. The Name of Participating Agency(ies) 2718 column lists the agency's name, Office 2720 is the office location of the agency and Role 2722 described the role that agency plays in the exam. Under the bank Examination Narrative Summary Requirements section 2730, a discussion of Examination checkbox 2732 is provided for noting an occurrence of one of many circumstances, the Supervisor Actions checkbox 2734 to note when there is an outstanding or proposed supervisory action, and a Chain Banking Relationships checkbox 2736 when there is a chain banking relationship.

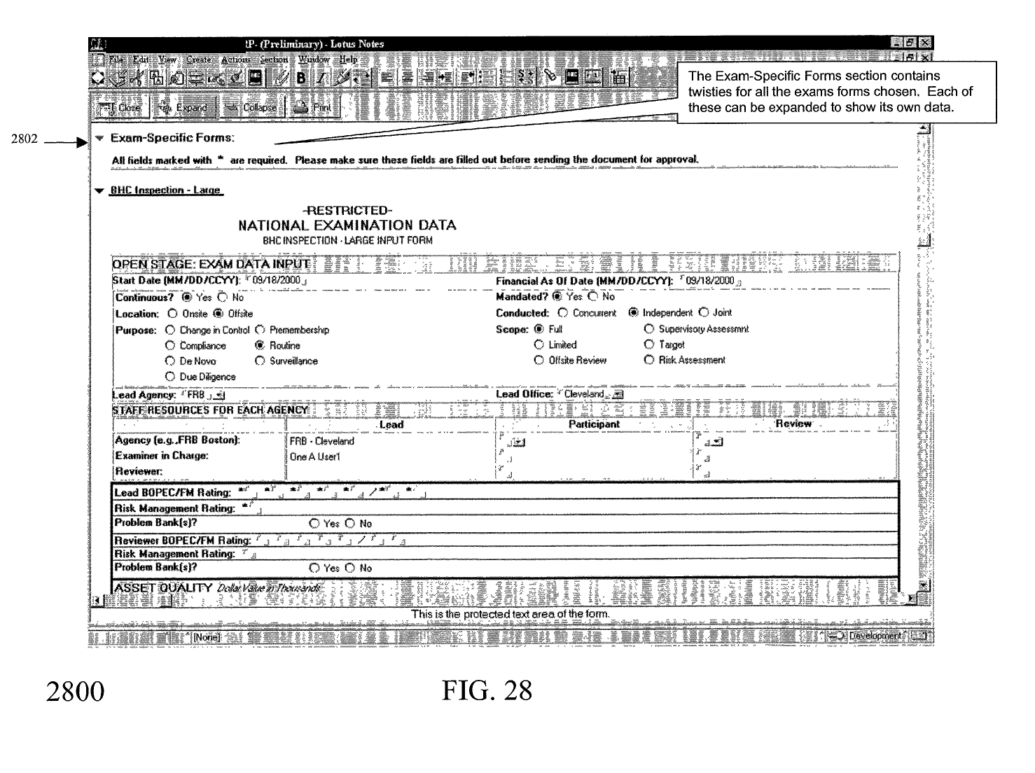

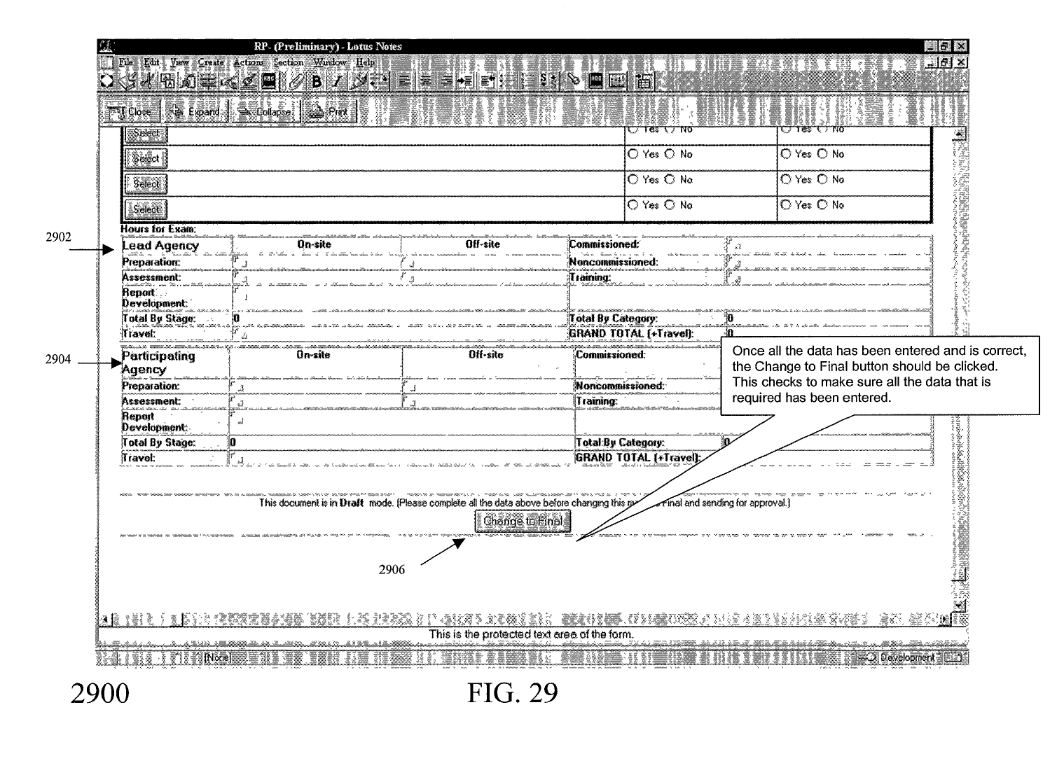

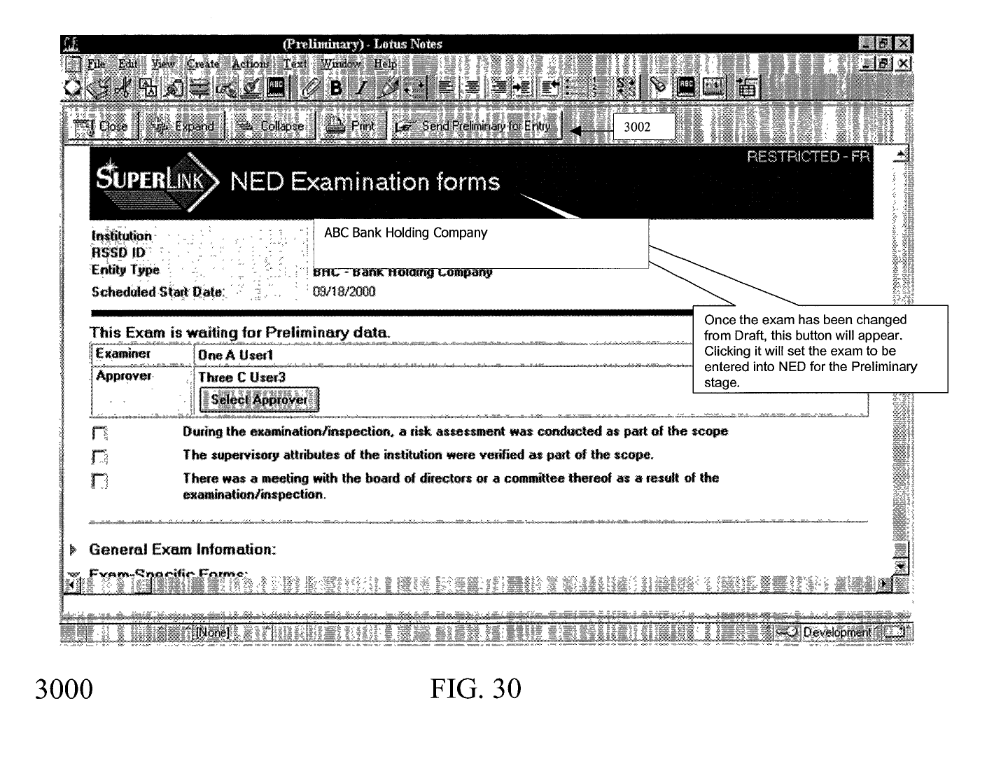

FIG. 28 shows another view from the Preliminary Stage screen 2600 which shows the detail 2800 of Exam-Specific Forms section 2802 link. The Exam specific Forms section 2802 contains twisties for all the exam forms chosen. Each form can be expanded to show its own data. FIG. 29 shows another view of the Preliminary Stage form generally referred to as 2900. This view shows Lead Agency 2902 and Participating Agency 2904 details Once all the data has been entered and is correct, the Change Final button 2906 is selected. This checks to make sure all the required data has been entered. Once the Change Final button 2906 is selected, the form shown in FIG. 30, the NED Examinations form 3000, is displayed. A push-button 3002 appears in the upper portion of the screen. Selecting push-button 3002, Send Preliminary for Entry, will set the exam to be entered into NED for the Preliminary Stage.

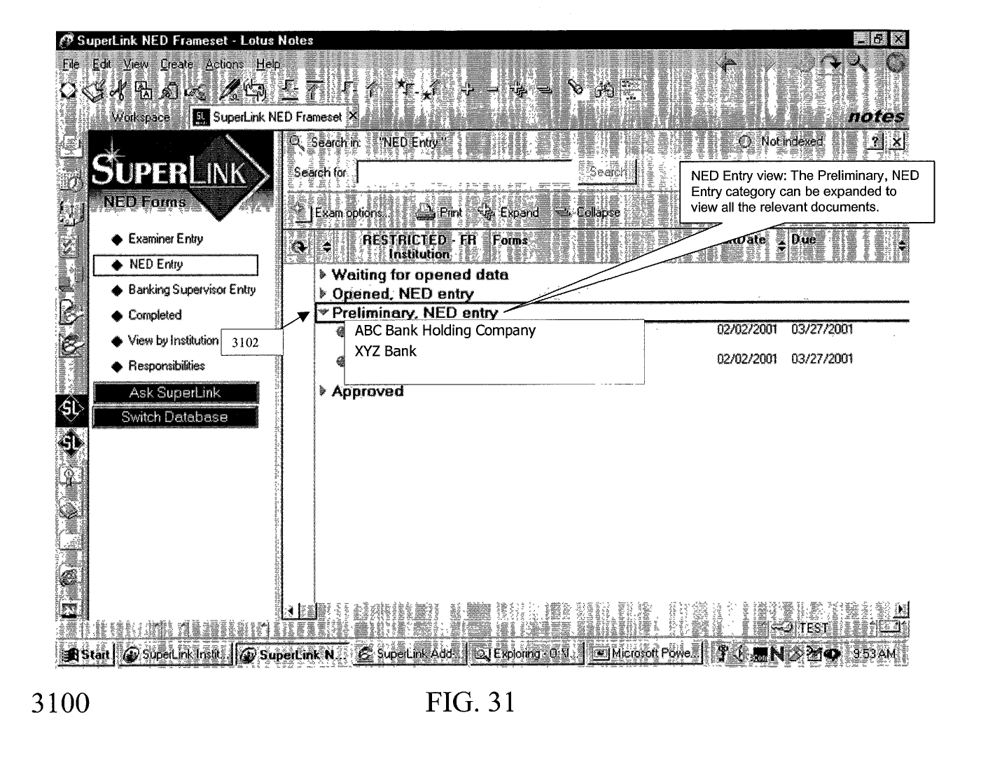

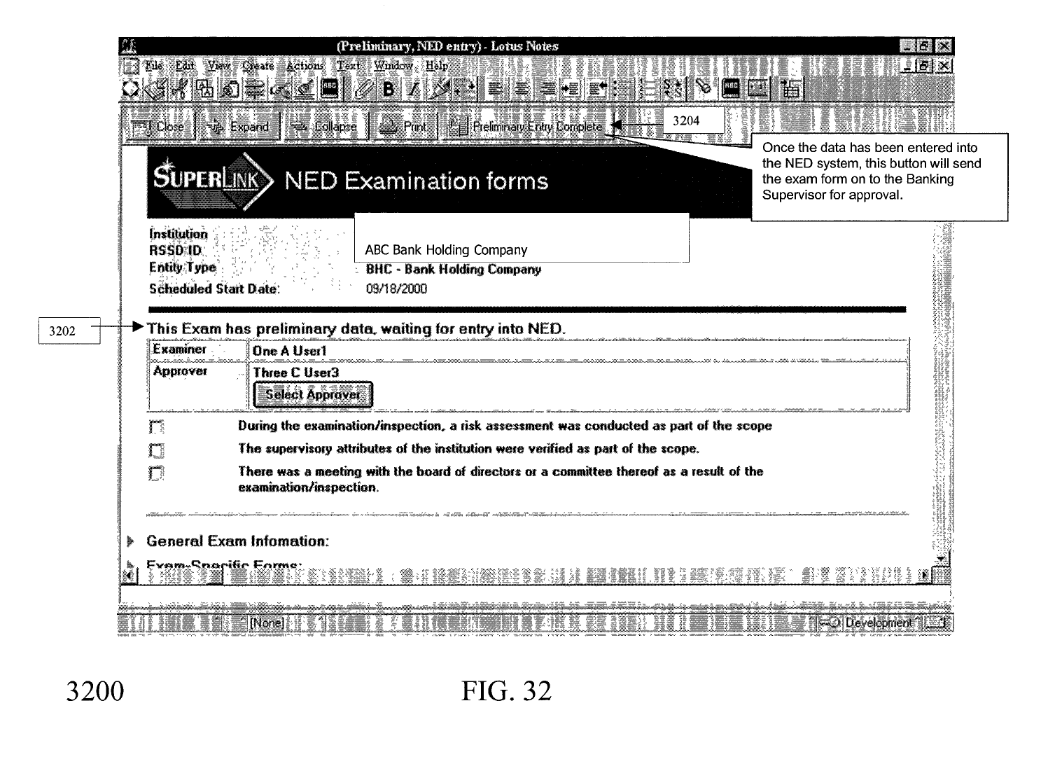

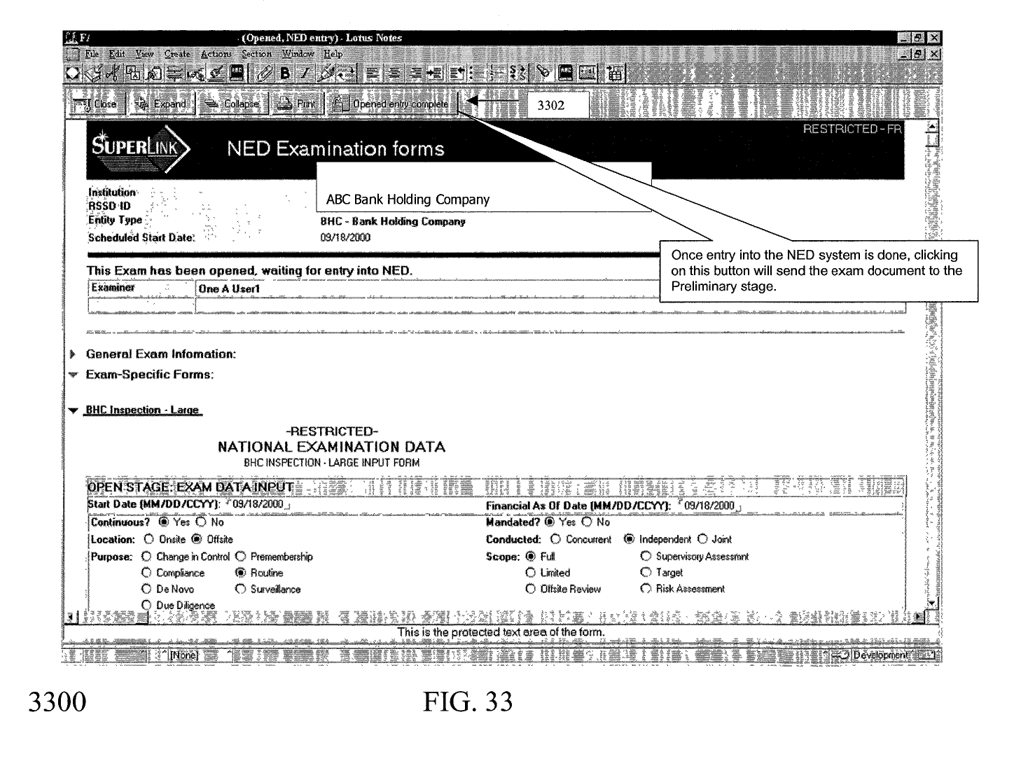

After selecting push-button 3002, a screen appears as shown in FIG. 31. The NED entry view 3100 will then show the selected form as Preliminary, NED entry on screen 3100. Selecting the twistie 3102 will expand the view to include all relevant documents. FIG. 32 shows a sample screen snapshot of a Preliminary stage NED entry view 3200. In this view 3200, the status 3202 has been changed to “The Exam has preliminary data, waiting for entry into NED.” and push-button 3204 appears. Selecting push-button 3204 will send the exam form on to the Banking Supervisor for approval. FIG. 33 is a sample screen show of the Opened NED entry screen 3300. Once entry into the NED system is done, a screen similar to FIG. 33 will be received. Selecting pushbutton 3302 will send the exam document to the Preliminary Stage.

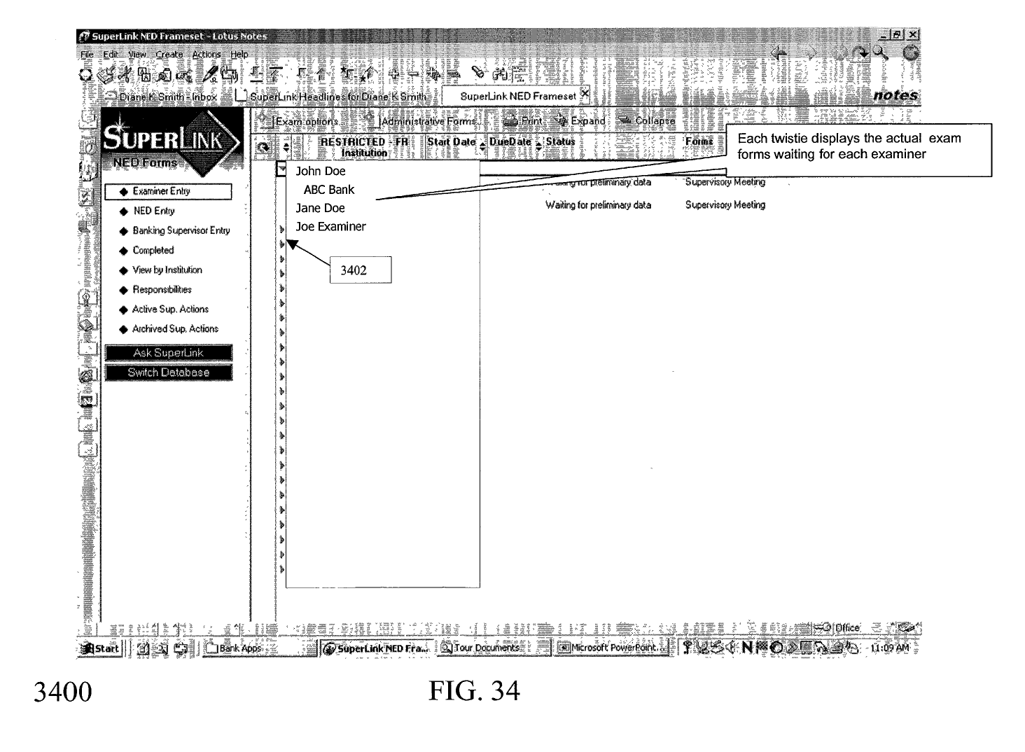

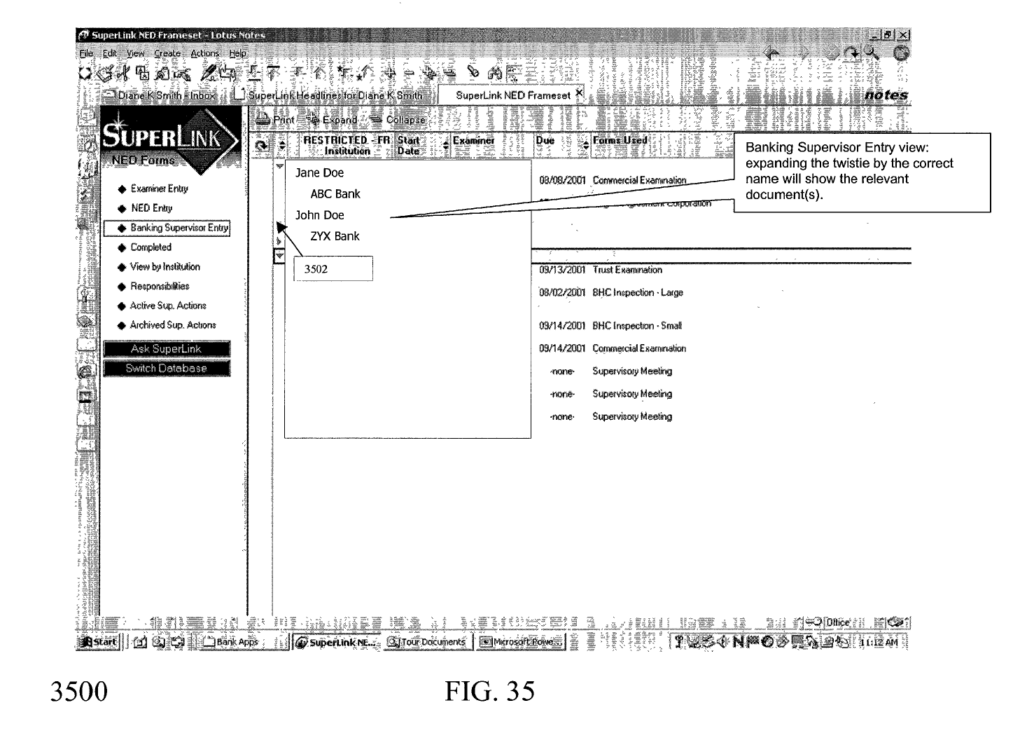

FIG. 34 is a sample screen snapshot of an NED Examiner View 3400. Selecting the twistie 3402 displays the actual forms waiting for each examiner. FIG. 35 is a sample screen snapshot of a Review stage screen 3500. Selecting a twistie 3502 next to a name will show the relevant documents.

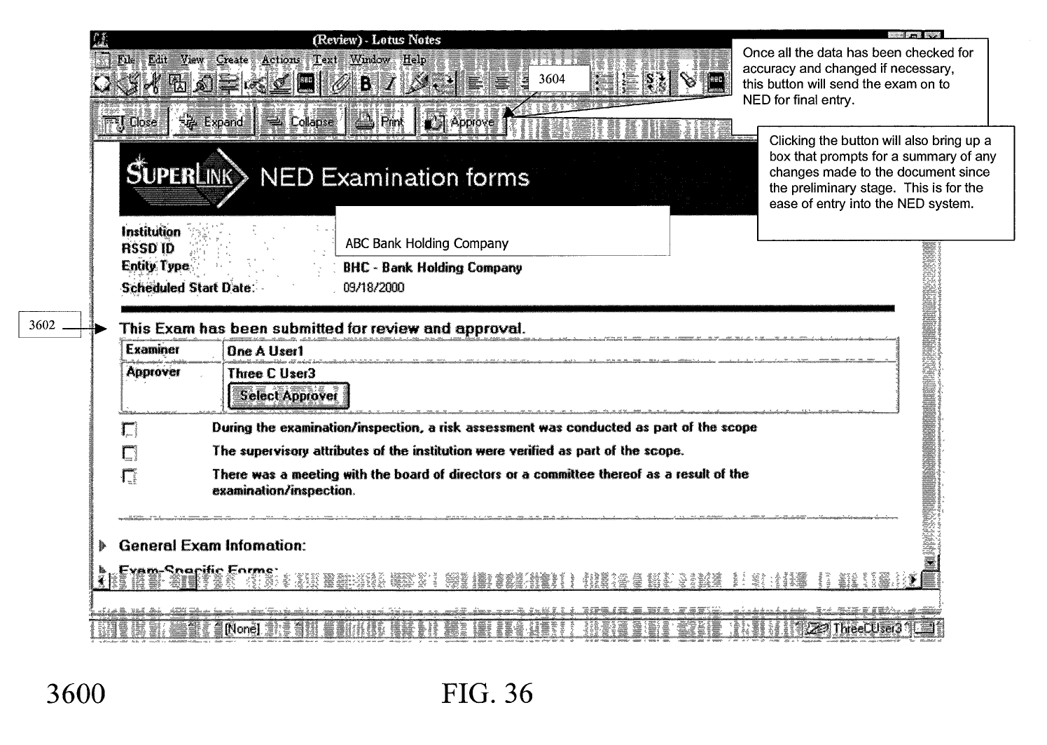

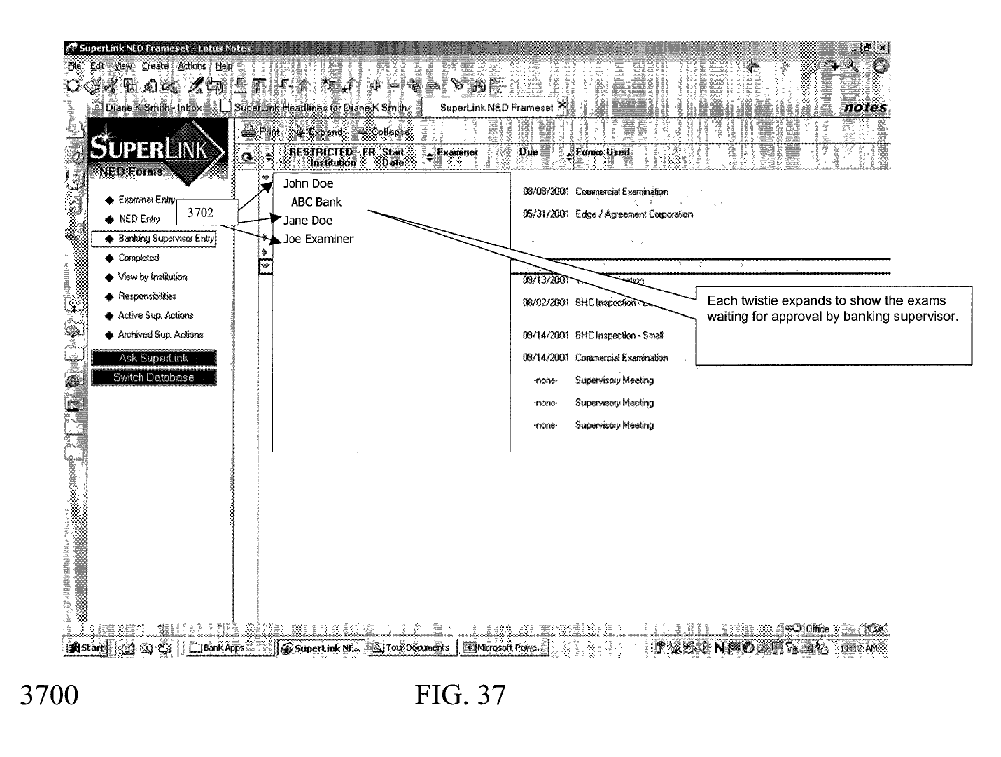

FIG. 36 is a sample screen snapshot of detailed Review stage screen 3600. This screen 3602 shows the status with a suitable indicator, such as “This Exam has been submitted for review and approval” and push button 3604 is used to approve the form. Once all the data has been checked for accuracy and changed if necessary, selecting push button 3604 will send the exam on to NED for final entry. FIG. 37 is a sample screen snapshot of a Banking Supervisor view 3700. Next to each name on this form is a twistie 3702. Each twistie expands to show the exams waiting for approval by a banking supervisor.

The Institutions database 120 stores data about each institution tracked in the system. This information can be accessed from the Headlines Page 102 by clicking on “Institutions”. Once the user has entered into the Institutions Database 120, the user will be able to see a listing of district-specific financial institutions being tracked in the system.

The view options listed in the Institutions navigator will give the user many ways to view the institution data being sorted and categorized in the database view. For example, the “By Entity Type” view categorizes an institution by its type, while the “By Name” view simply categorizes all institutions alphabetically.

Bearing in mind that each view displays summary information about an institution. To view an institution in detail, the user must double click on it from any view and the user will enter the institution's profile and see all information about that institution.

In this particular database, the actual document that contains the information about each institution contains information that will only be viewed by those with the necessary security rights.

For security reasons, some entity information is advantageously contained in separate documents. These documents are linked to the institution profile and can only be viewed by those with the proper access. The documents that are separated from the institution profile include Add-Ins (Other Links), Shared and Non-Shared Comments, Past Exams, Future Exams, Supervisory Actions, Exam Reports, Risk Assessments, Prompt Corrective Action Designations (PCAD), and Loan and Discount Information.

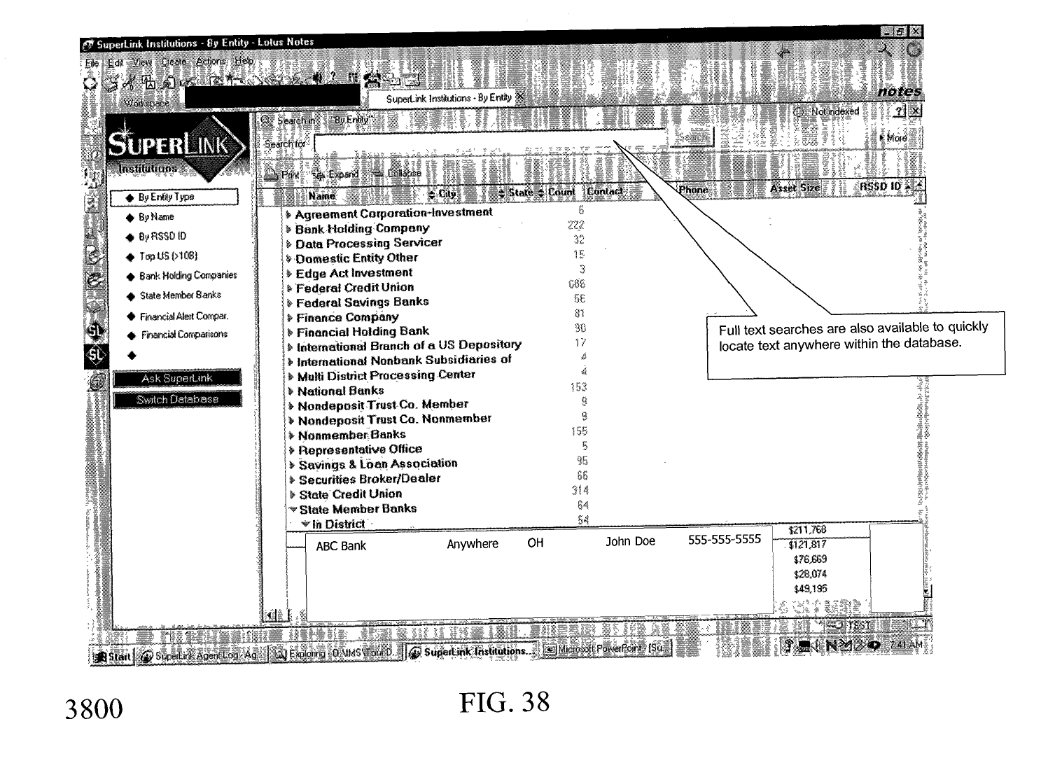

The database also contains general information that is available to all users. Examples of this type of information include: Attribute Information, Applications, Structure Notices, Accounts, and Assets. FIG. 38 shows an Institutions by Entity Type screen 3800.

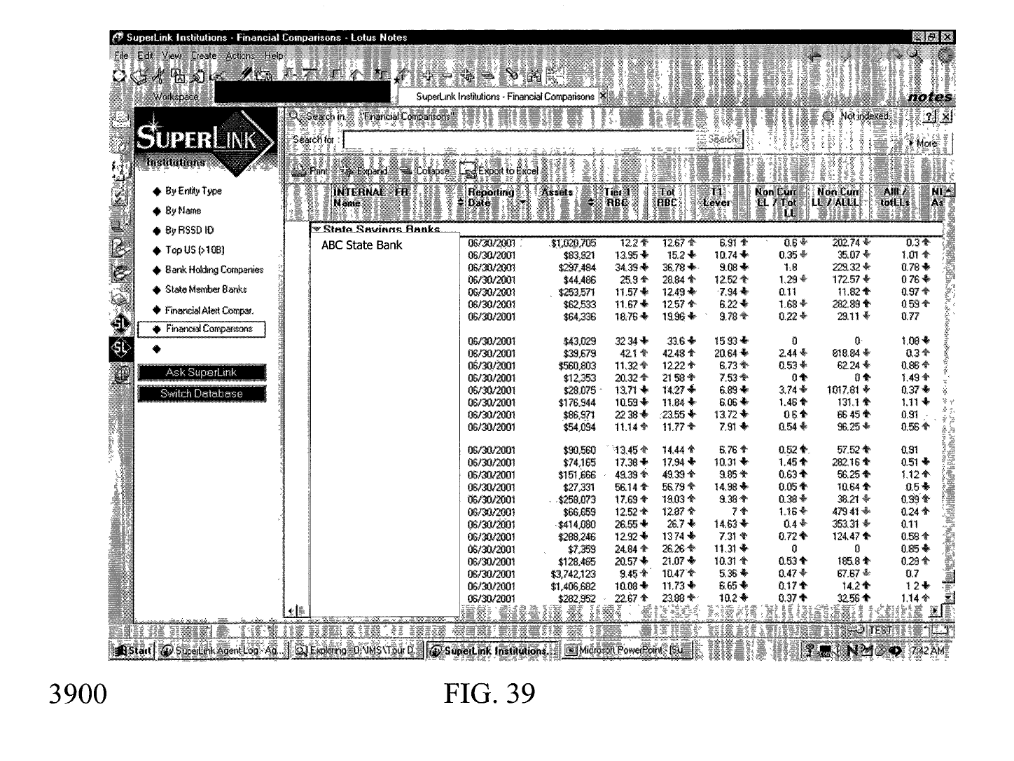

FIG. 39 shows that data available on the Institutions financial comparisons view 3900. This view 3900 uses colors and icons to signify different meanings for some of the data. In the preferred embodiment, if the ratio is Green and a green check appears next to the ratio, it means it meets the monitoring criteria set by each Federal Reserve Bank. If the ratio is Yellow, a yellow ball appears next to the ratio. This means the early warning threshold set for the financial ratio has been exceeded. If the ratio is Red and a red X appears next to the ratio, the normal threshold set by the Federal Reserve has been surpassed. When a red X or yellow ball appears, an Alert document will be created and posted into the Alerts database 104 (FIG. 1) for that institution. The last icons displayed in this section are arrows. A green up arrow signifies that the financial ratio has increased since last quarter, and the increase is good. If the increase is bad, a red up arrow is displayed. A red down arrow signifies that the financial ratio has decreased since last quarter and the decrease is bad. If the decrease is good, a green down arrow is displayed.

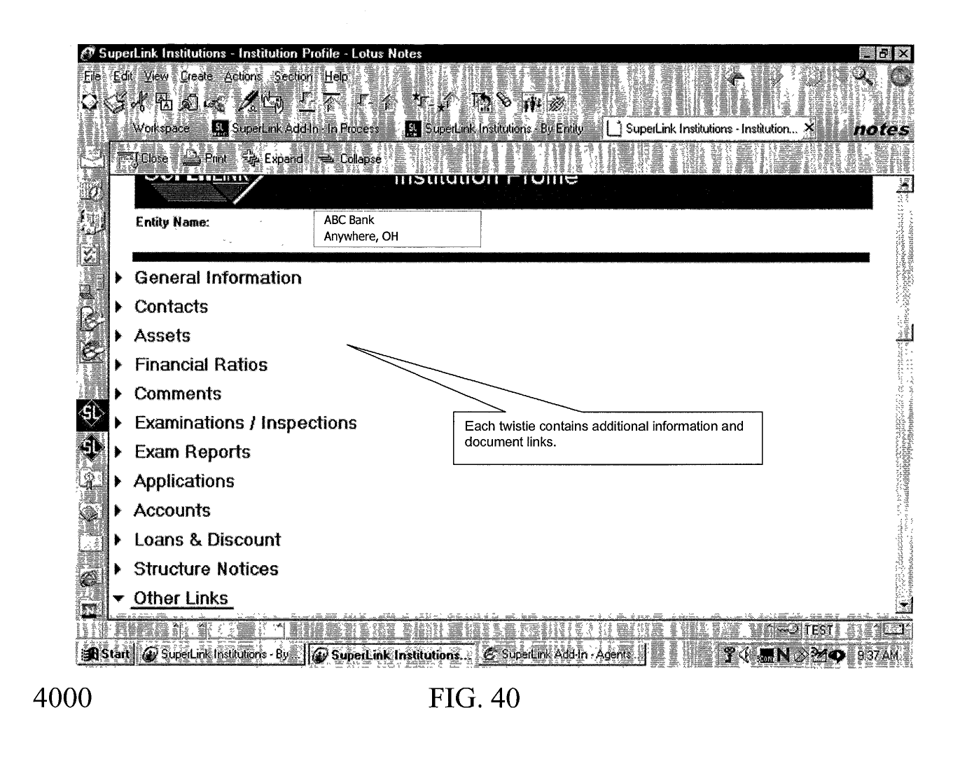

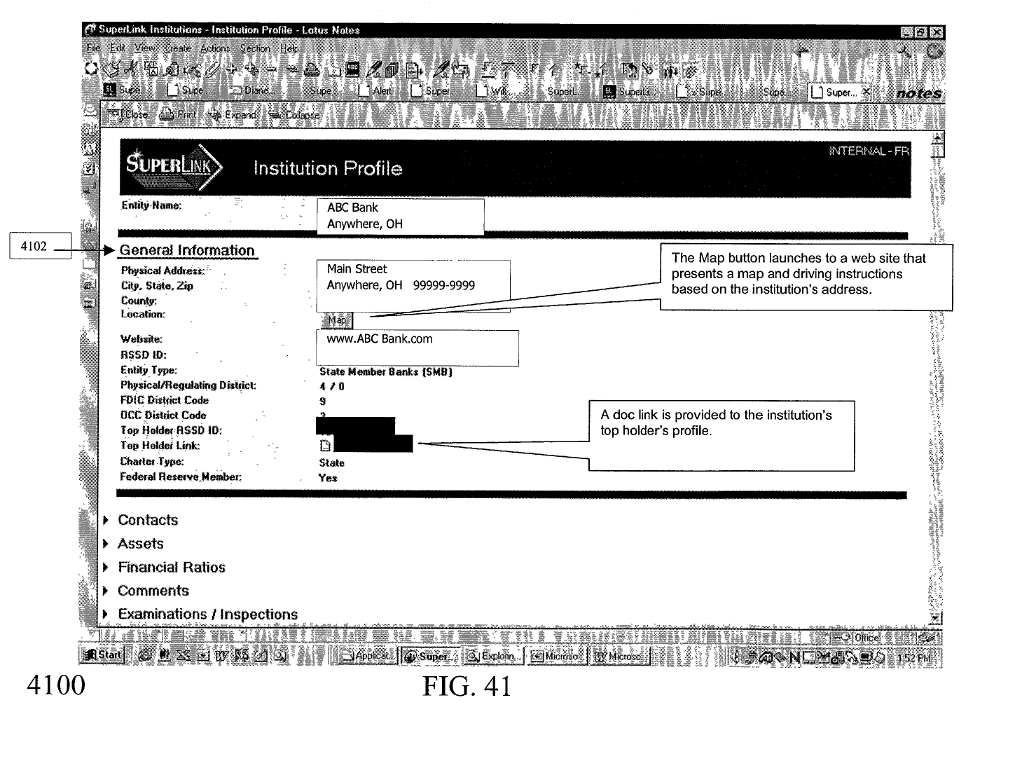

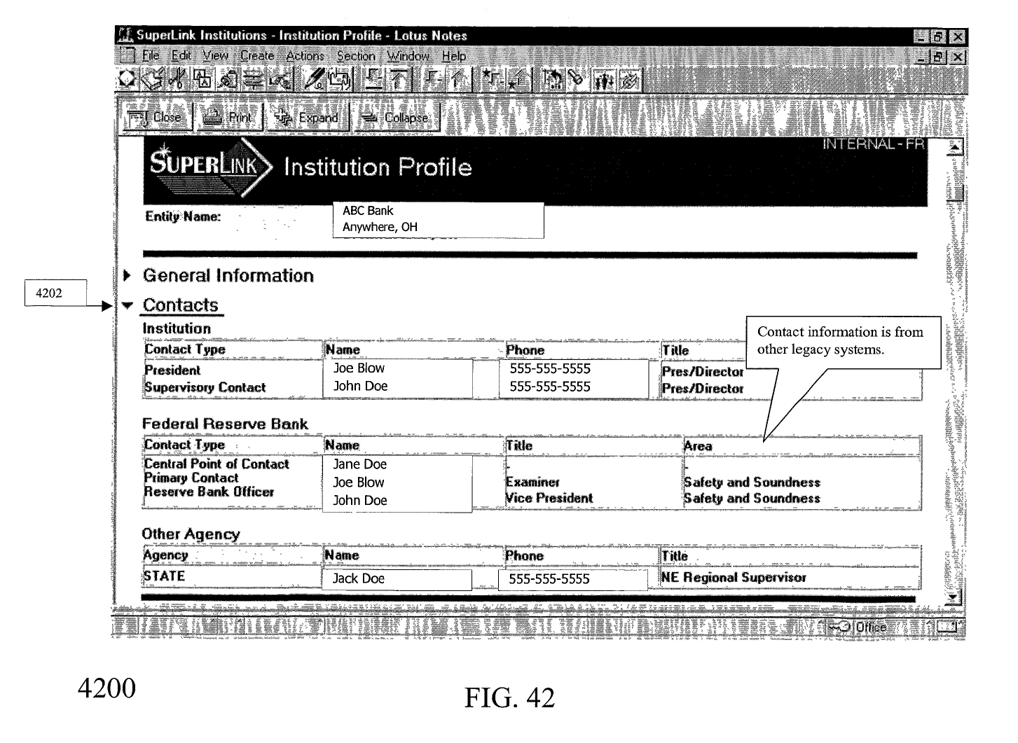

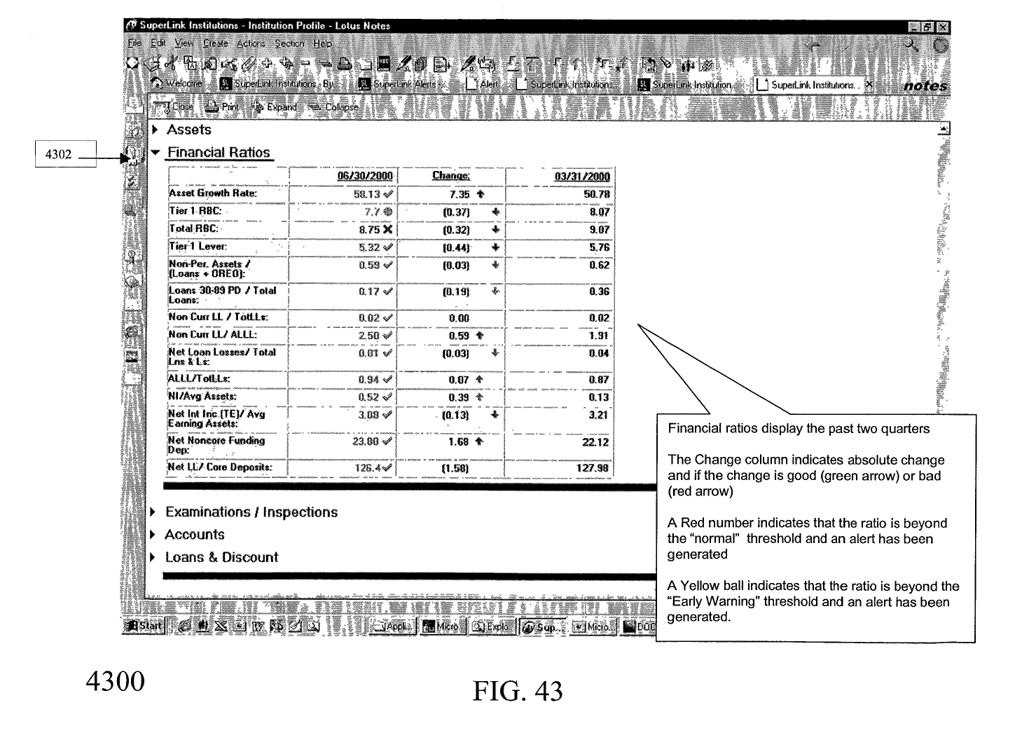

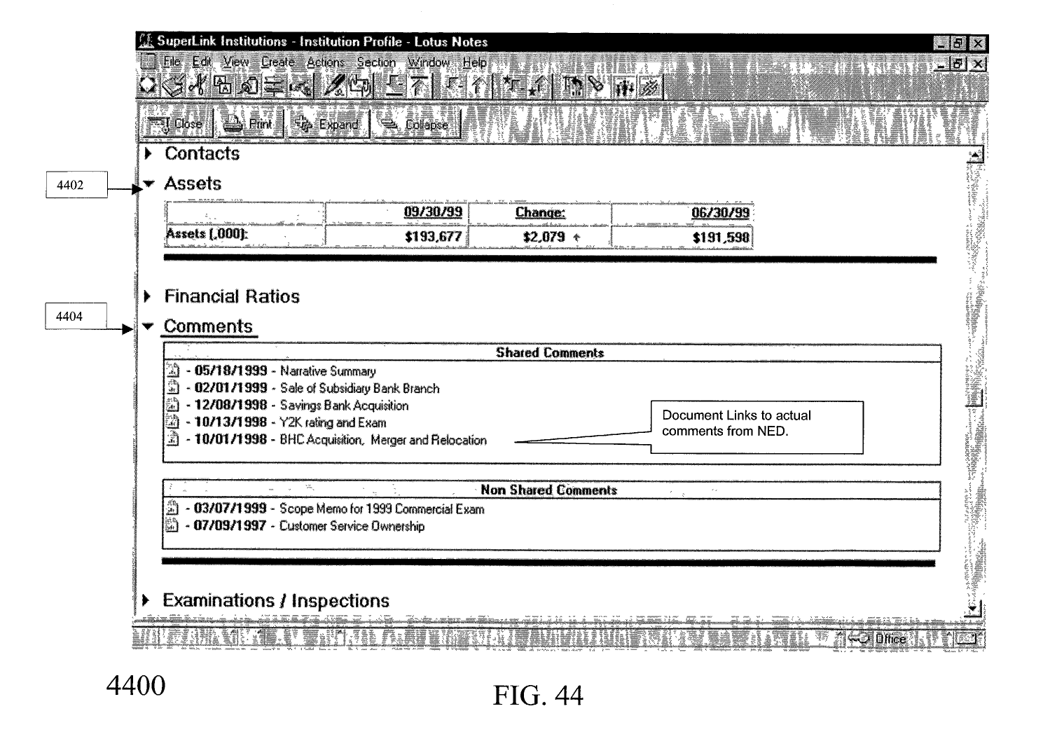

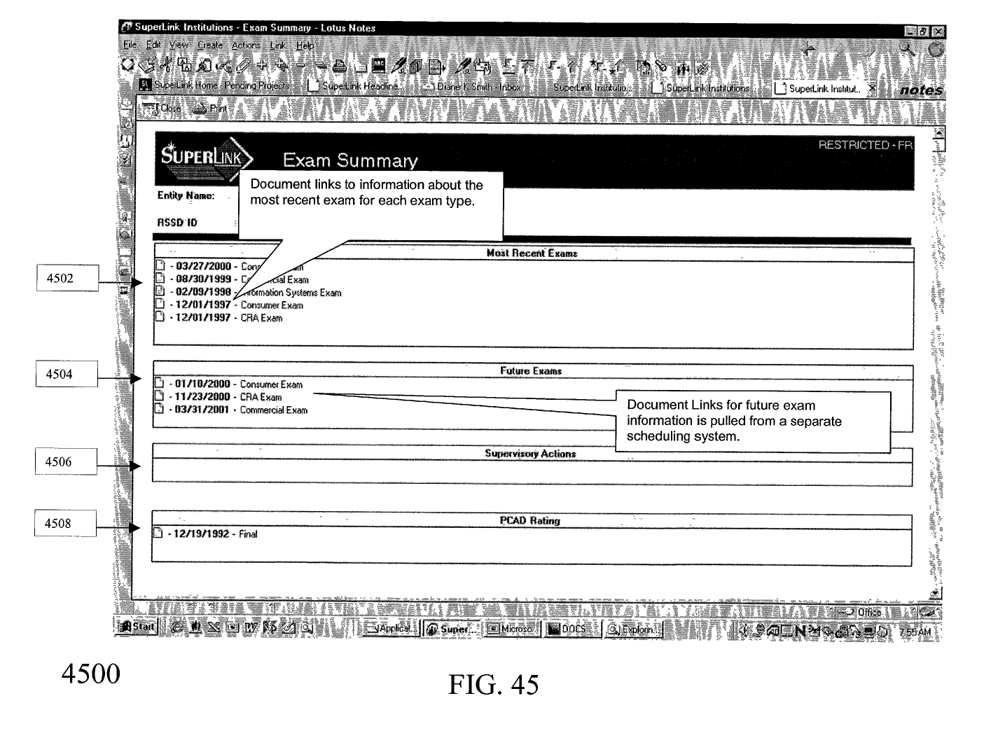

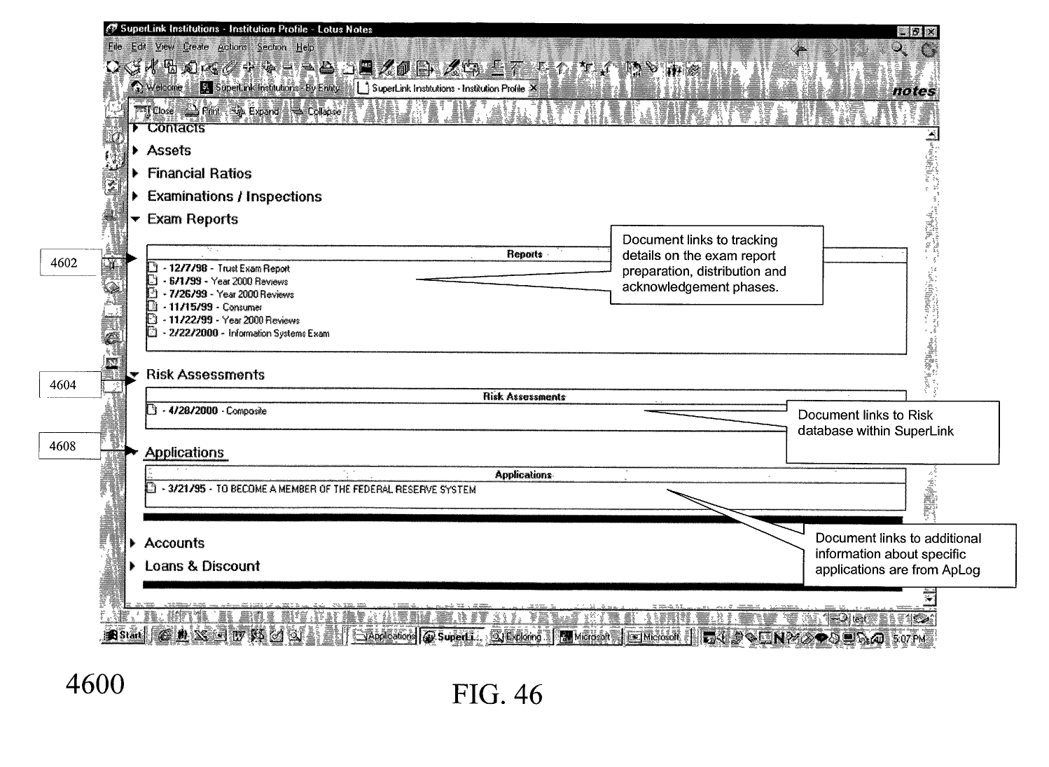

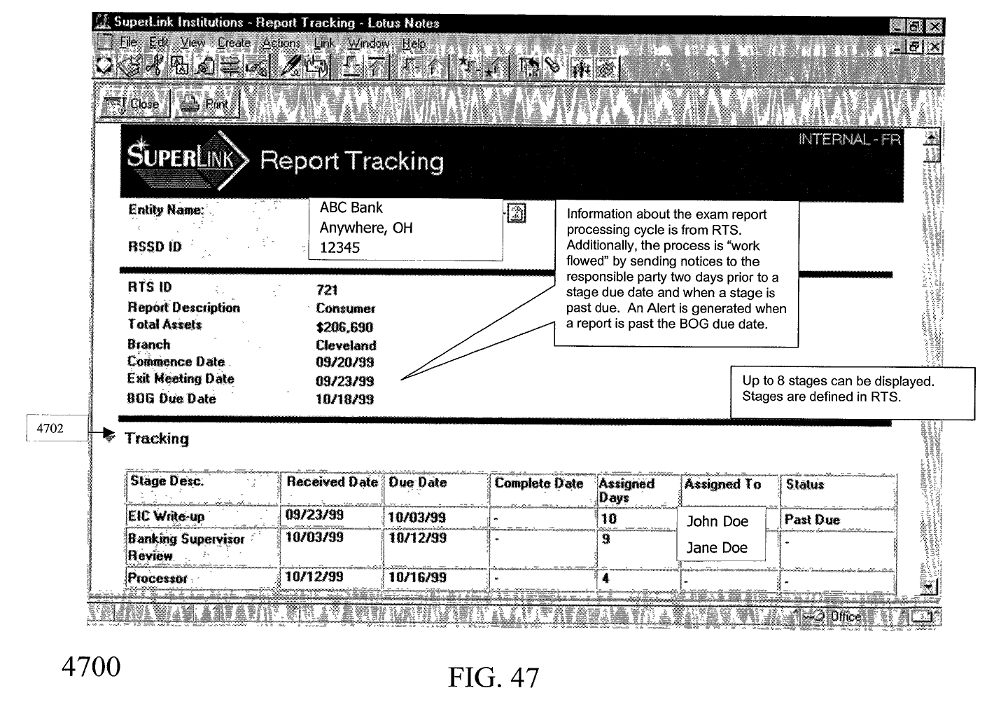

FIG. 40 shows the various data fields available on an Institution Profile view 4000. FIG. 41 is an expanded view 4100 of the General Information 4102 stored in the Institution Profile database. FIG. 42 is an expanded view 4200 of the Contacts information 4202 stored in the Institution Profile database. FIG. 43 is an expanded view 4300 of the Financial Ratios 4302 stored in the Institution Profile database. FIG. 44 is an expanded view 4400 of the Assets 4402 and Comments 4404 sections of an Institution Profile. FIG. 45 is an expanded view 4500 of the Exam Summary. Here information about past and future exams may be obtained. Most Recent Exams 4502, Future Exams 4504, Supervisor Actions 4506 and Prompt Corrective Action Designation (PCAD Rating) 4508 may all be accessed from this view 4500. FIG. 46 is an expanded view 4600 of the Exam Reports 4602, Risk Assessments 4604 and Applications 4608 sections of the Institution Profile. FIG. 47 is an expanded view 4700 of Reports Tracking Detail 4702 of the Institution Profile.

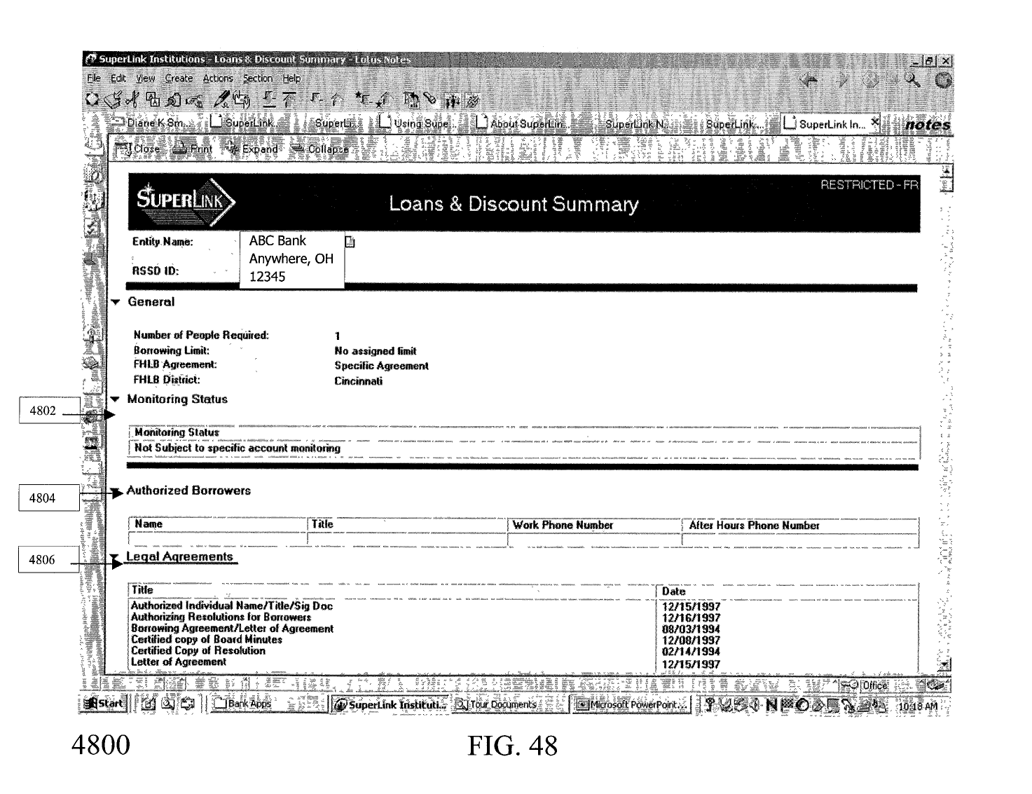

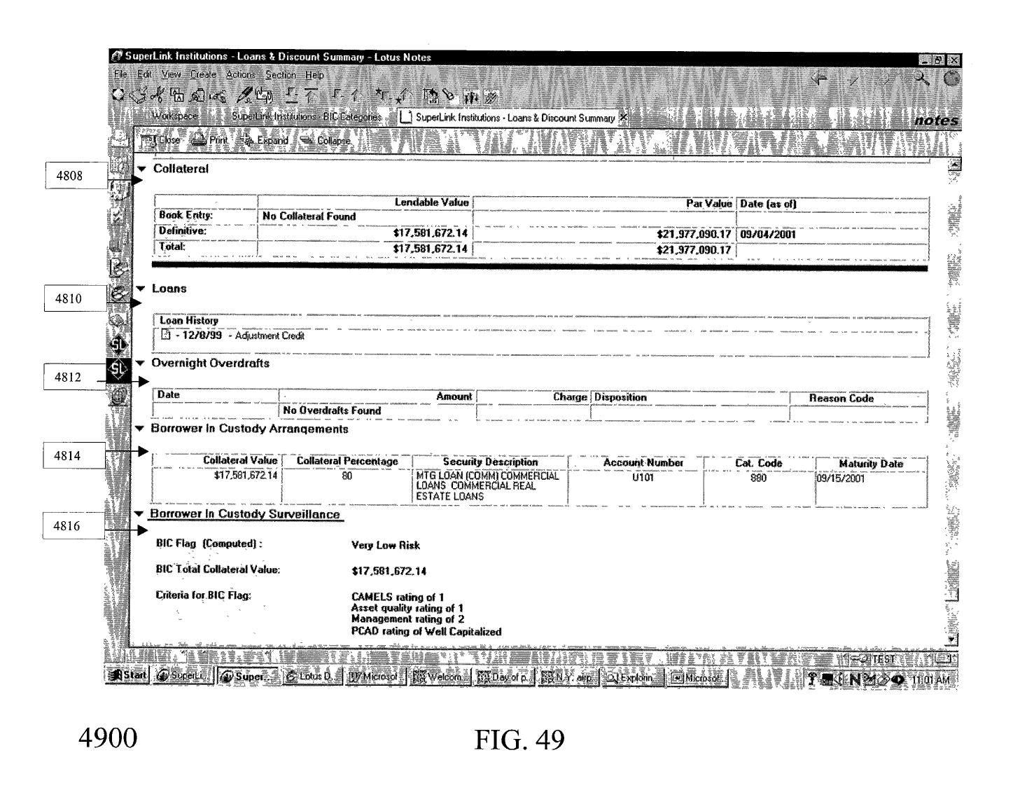

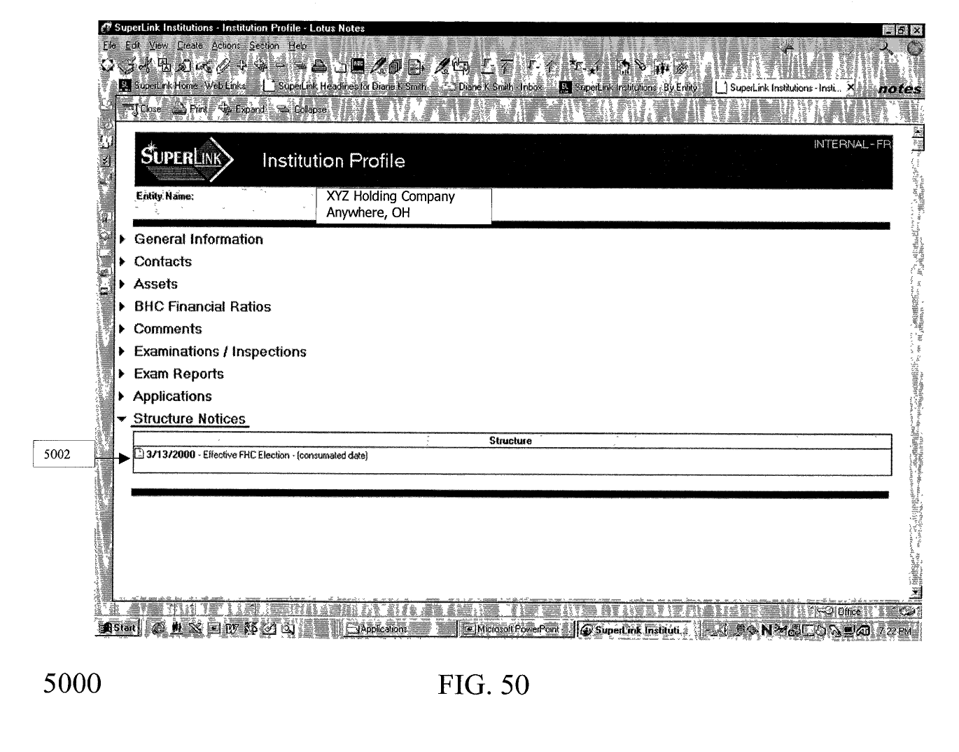

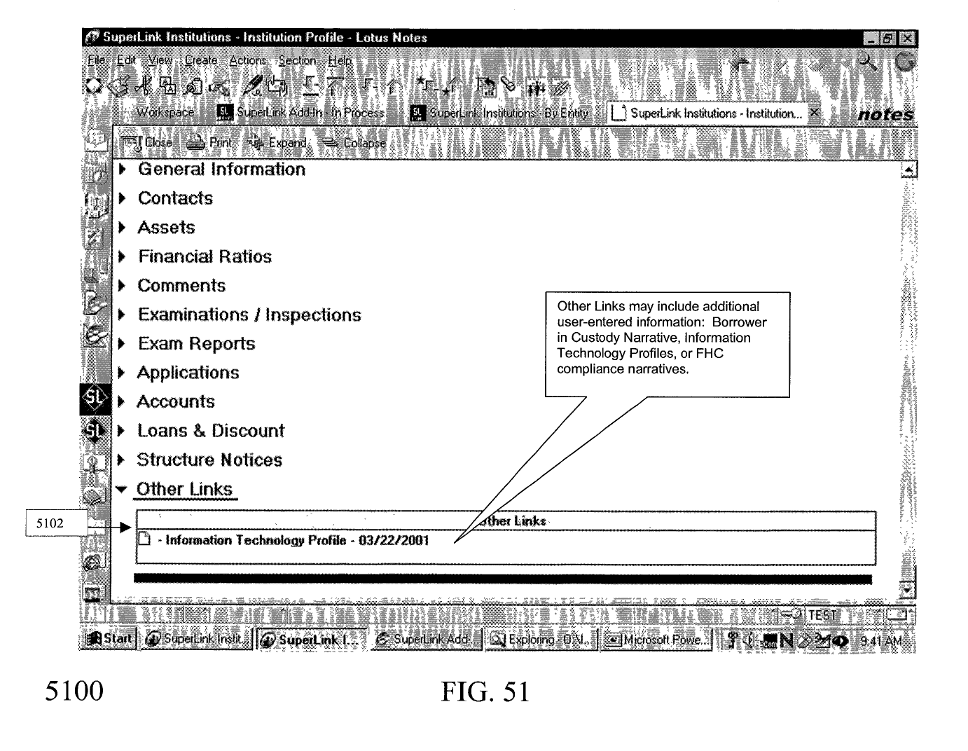

FIG. 48 is an expanded view 4800 of Loans and Discount Summary of an Institution Profile. This view shows the Monitoring Status 4802, Authorized Borrowers 4804, and Legal Agreements 4806 for Loans and Discounts. FIG. 49 shows additional detail of the Loans and Discount Summary view 4900. This view shows details of the Collateral 4808, Loans 4810, Overnight Overdrafts 4812, Borrower in Custody Arrangements 4814, and Borrower in Custody Surveillance 4816 sections. FIG. 50 shows an expanded view 5000 of Structure details 5002 of an Institution Profile. FIG. 51 shows an expanded view 5100 of Other Links section 5102 of an Institution Profile.

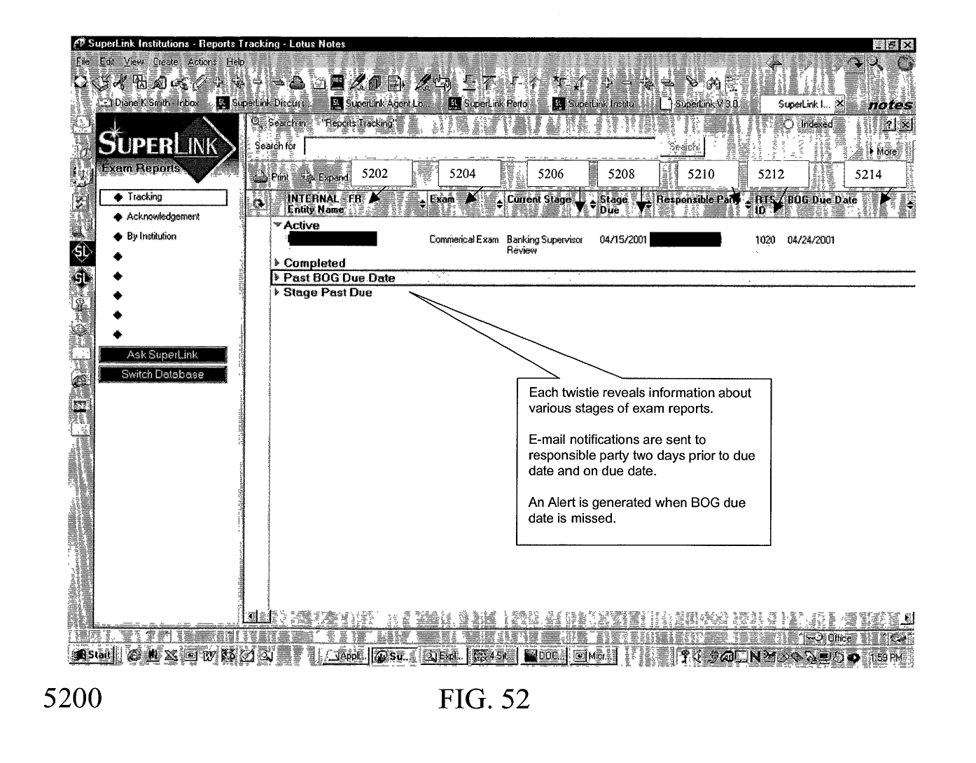

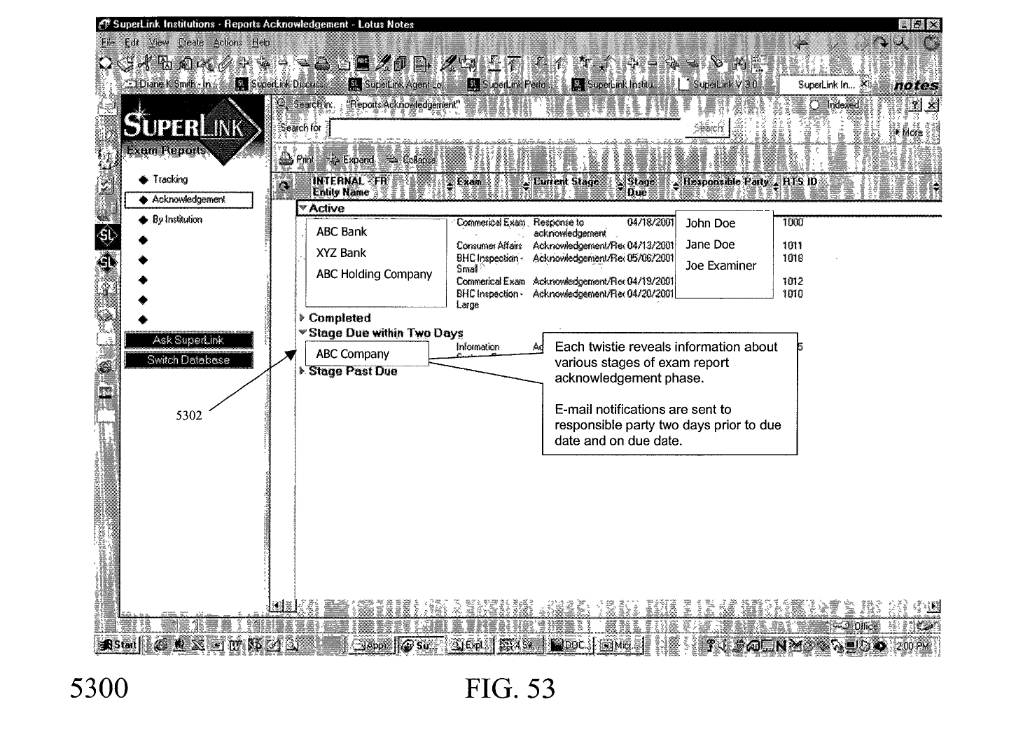

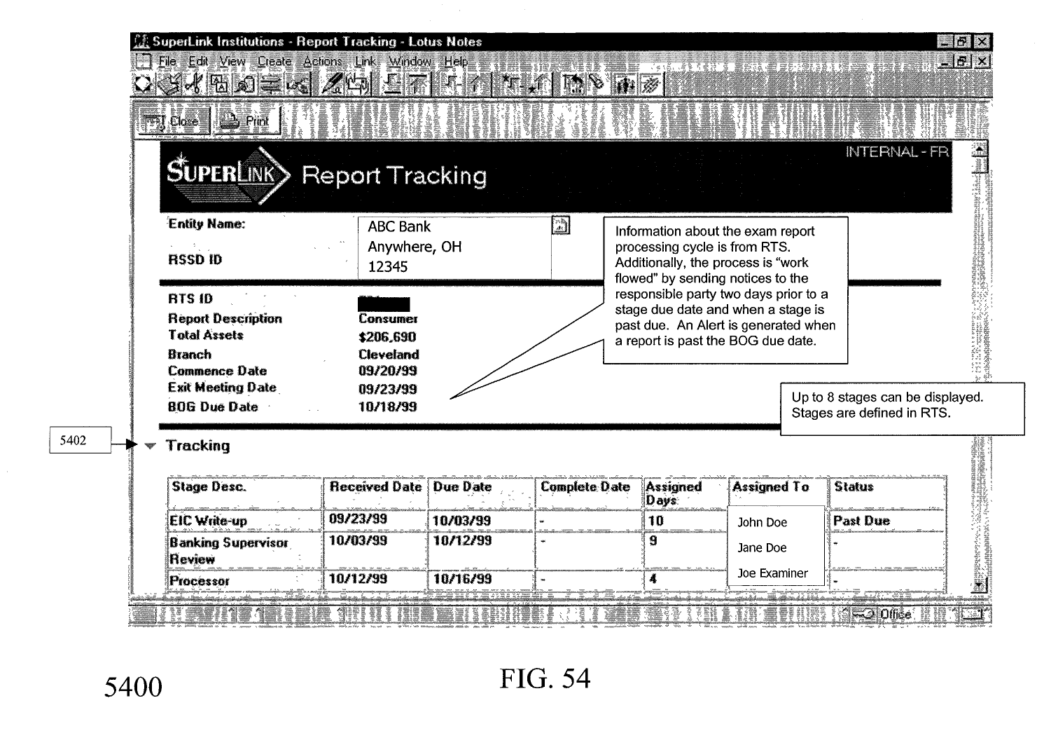

Exam Report 122 is used to track the status of Exam Reports, provides notifications, such as electronic mail notifications, to the responsible person when a stage is “due in two days” or “past due.” Exam Report 122 notifies all people listed in any stage when the report goes past the Board of Governors due date and generates an Alert. FIG. 52 shows an example of an Exam Reports tracking screen 5200. This screen displays the Entity Name 5202, Exam Type 5204, Current Stage 5206, Stage Due 5208 date, Responsible Party 5210, RTS ID 5212, and BOG Due 5214 date. FIG. 53 shows an example of an Exam Reports Acknowledgment view 5300. In this example, the Stage Due within Two Days 5302 twistie has been expanded. FIG. 54 shows an expanded view 5400 of the Tracking section 5402 of the Report Tracking view and the data contained therein.

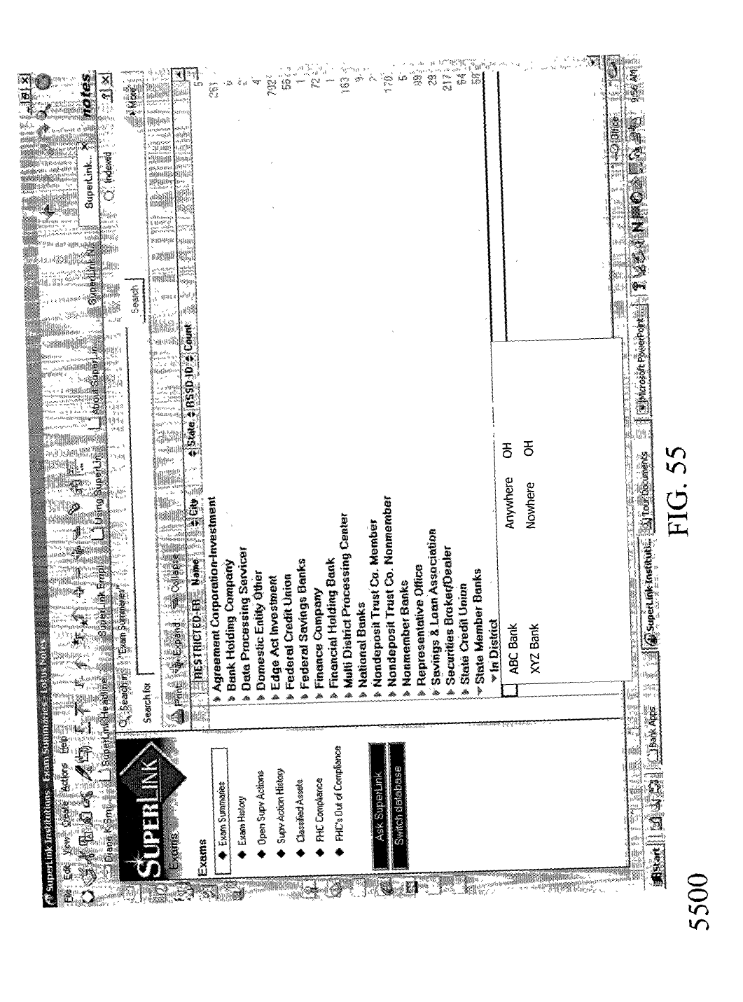

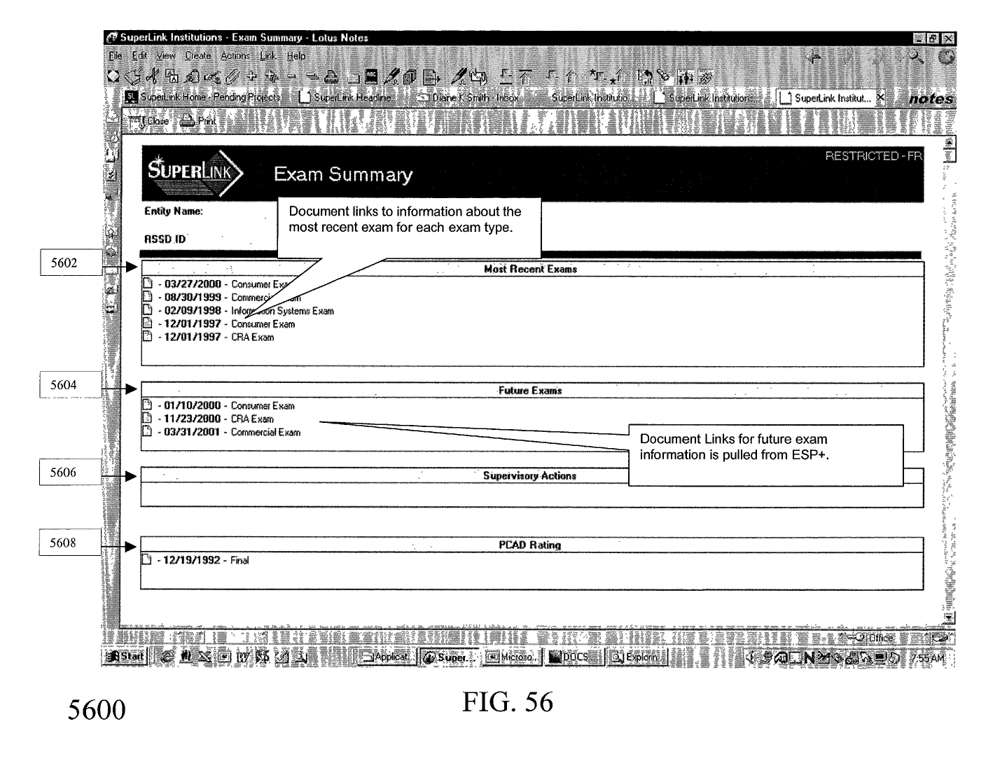

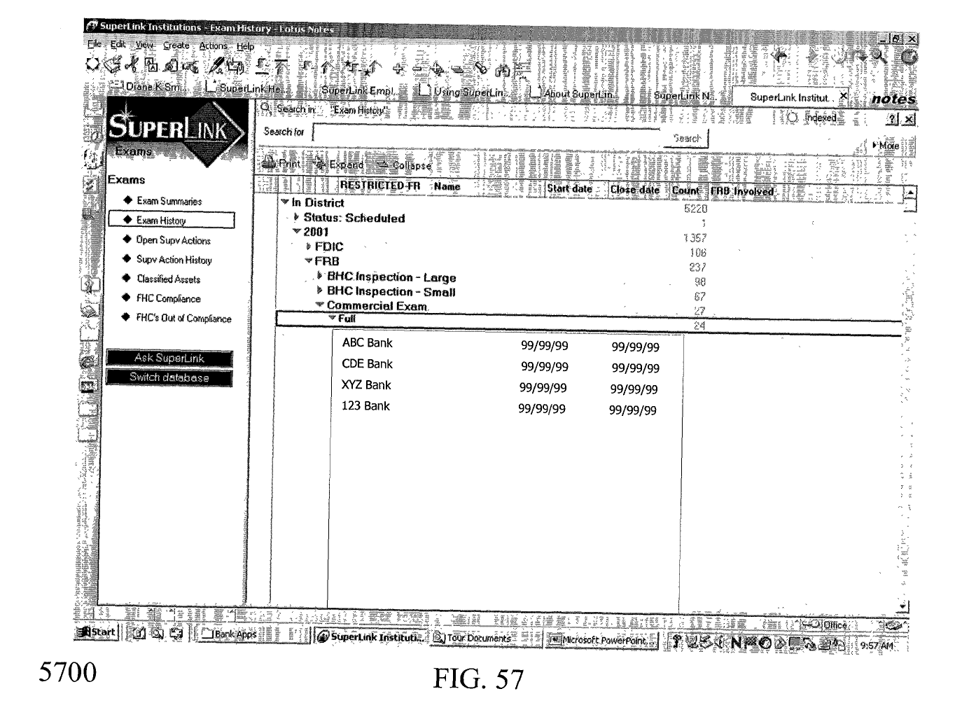

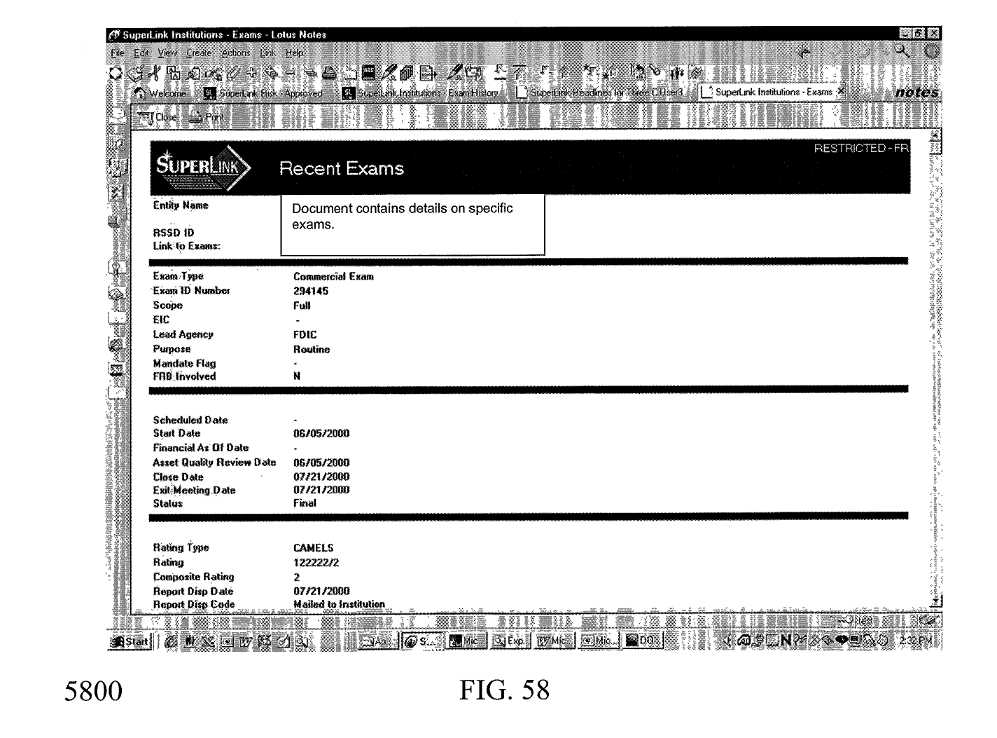

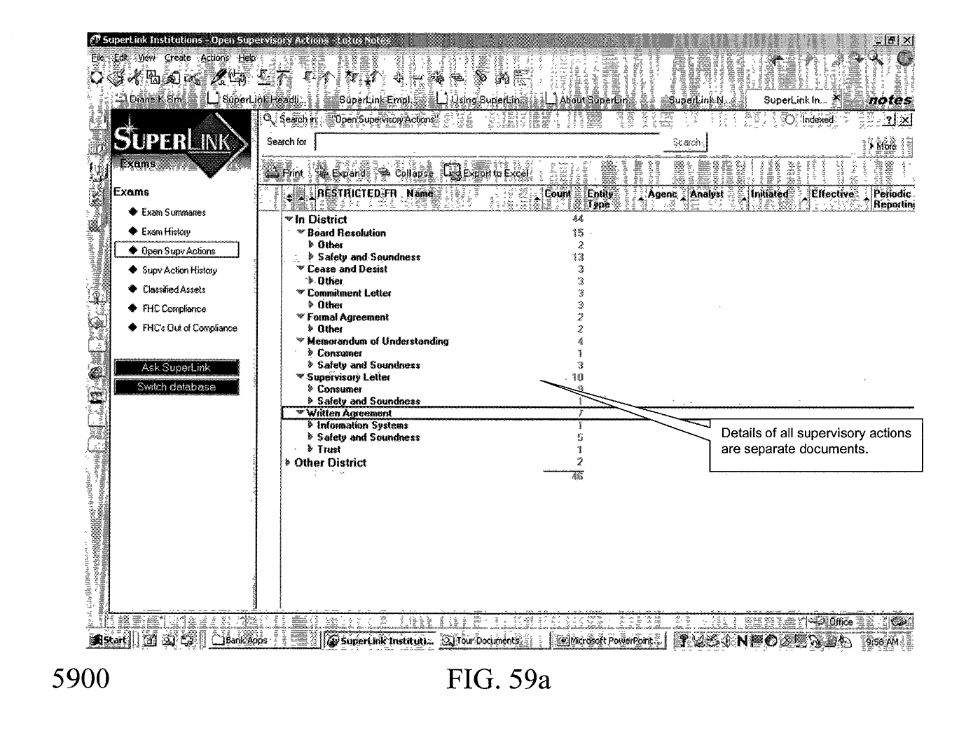

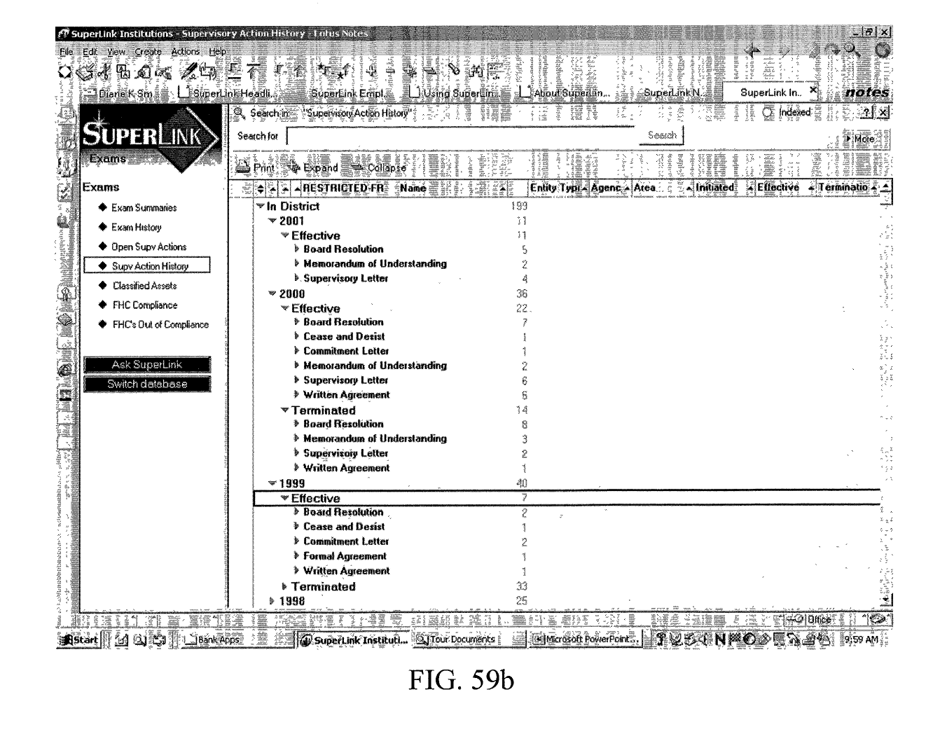

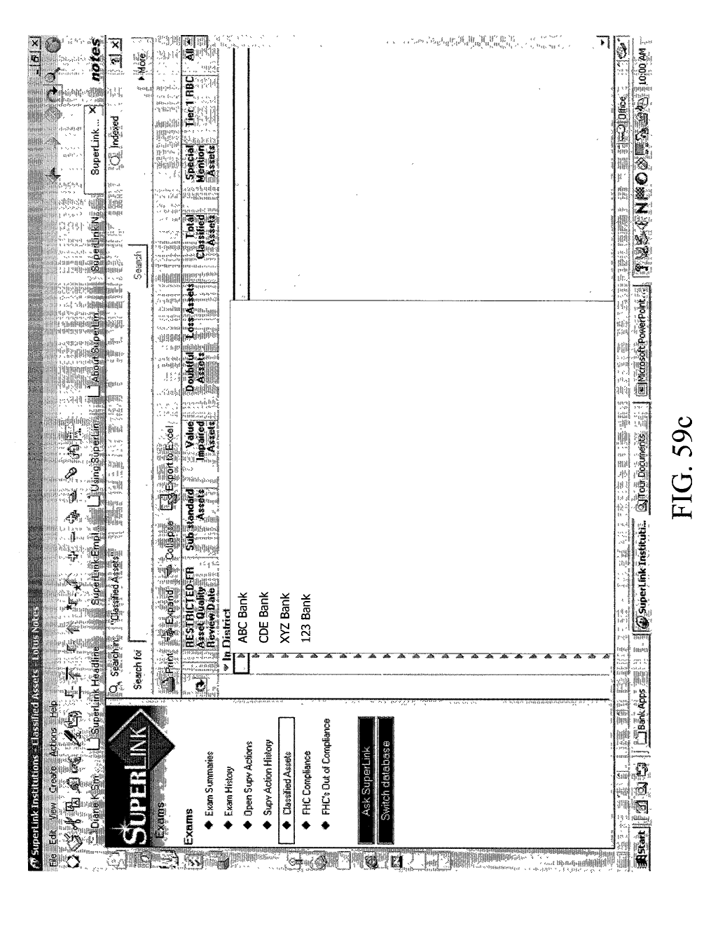

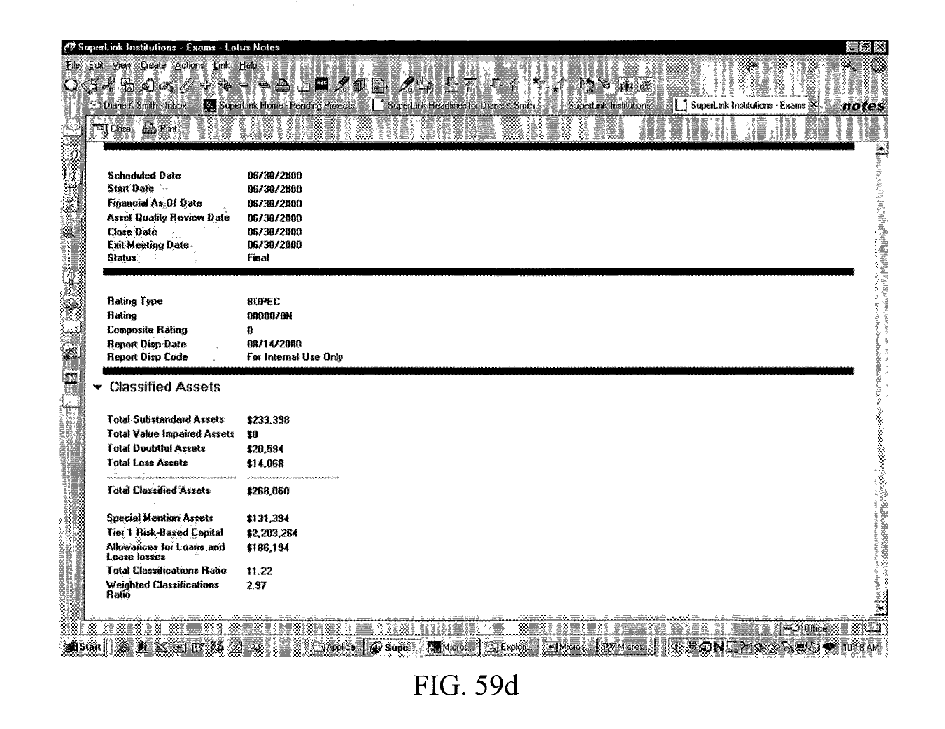

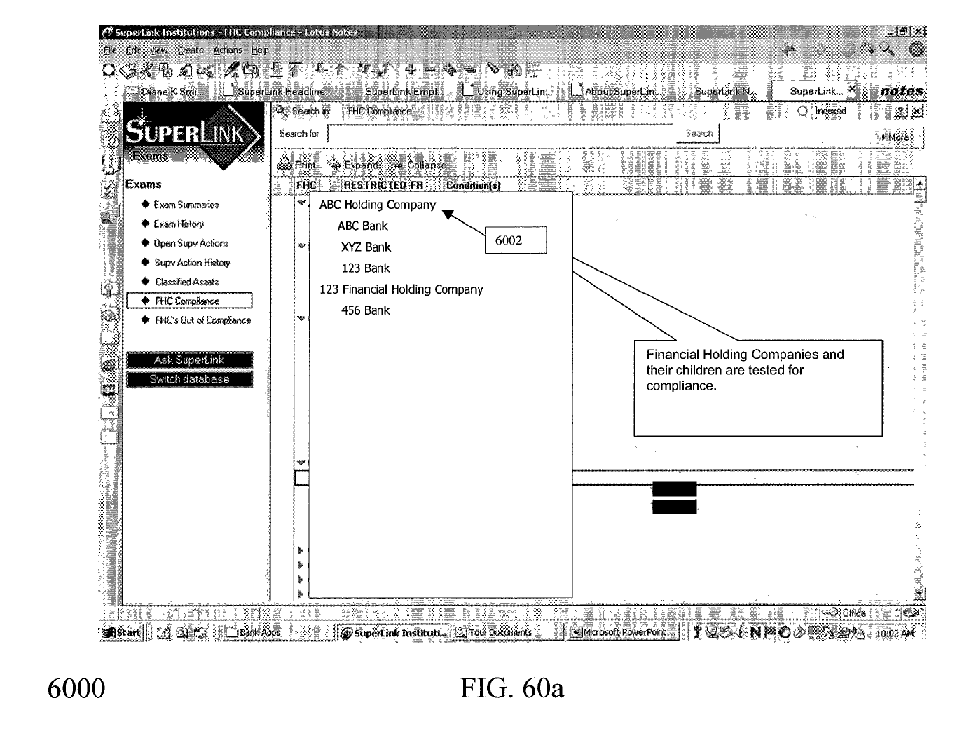

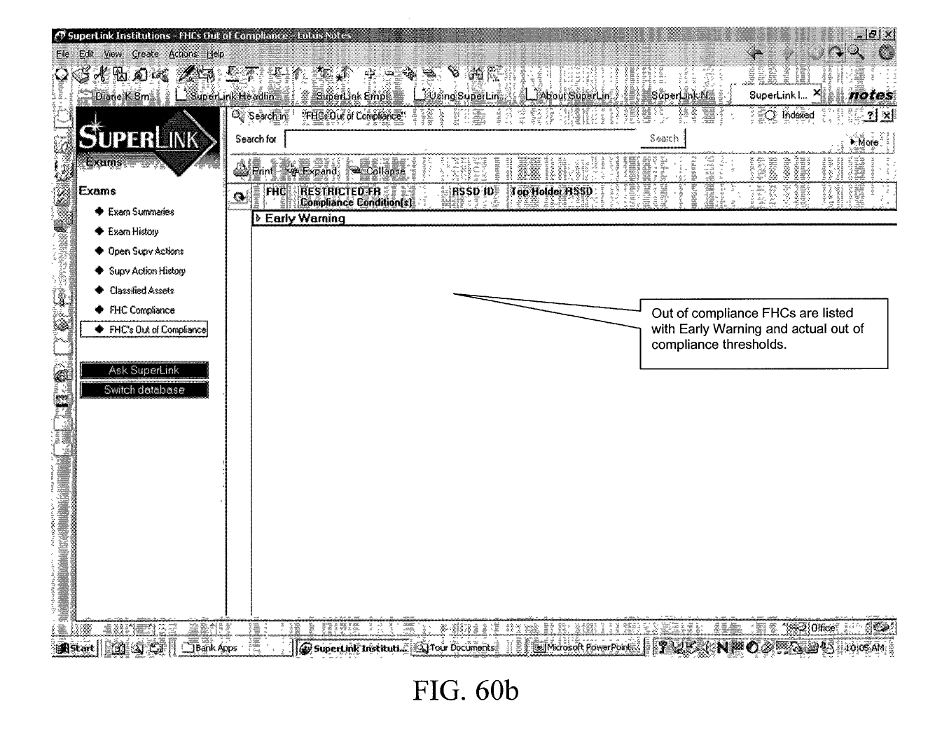

The Exams Database 124 provides detailed information on examinations that includes Exam Summaries, Exam History, Open supervisory Actions, Supervisory Action History, Classified Assets, FHC Compliance and FHCs out of compliance. The Exams navigator 124 located on the Headlines Page 102 is used to view a variety of information. This view is only available to those individuals with a “need to know” in the preferred embodiment. Users who do not have access to this data, will not see the navigator. FIG. 55 shows an example of an Exam Summaries view 5500 and is identical to that in FIG. 45. FIG. 56 shows an example of an expanded view 5600 of the Most Recent Exams 5602, Future Exams 5604, Supervisory Actions 5606, and Prompt Corrective Action (PCAD) Rating 5608 sections. FIG. 57 shows an example of an Exam History view 5700. FIG. 58 shows an example of details for exams displayed on the Exam History view 5800. FIG. 59a shows an example of an Open Supervisory Actions view 5900. FIG. 59b shows an example of a Supervisory Actions History view. FIG. 59c shows an example of a Classified Assets view. FIG. 59d is an example of a detailed Classified Assets view. FIG. 60a shows an example of a Financial Holding Company (FHC) Compliance view. The screen displays the financial holding company 6002 and its children and the conditions contributing to compliance with regulations. FIG. 60b shows an example of all FHCs that are actually out of compliance with regulations “Normal” (not shown) or nearing an out of compliance condition “Early Warning.”

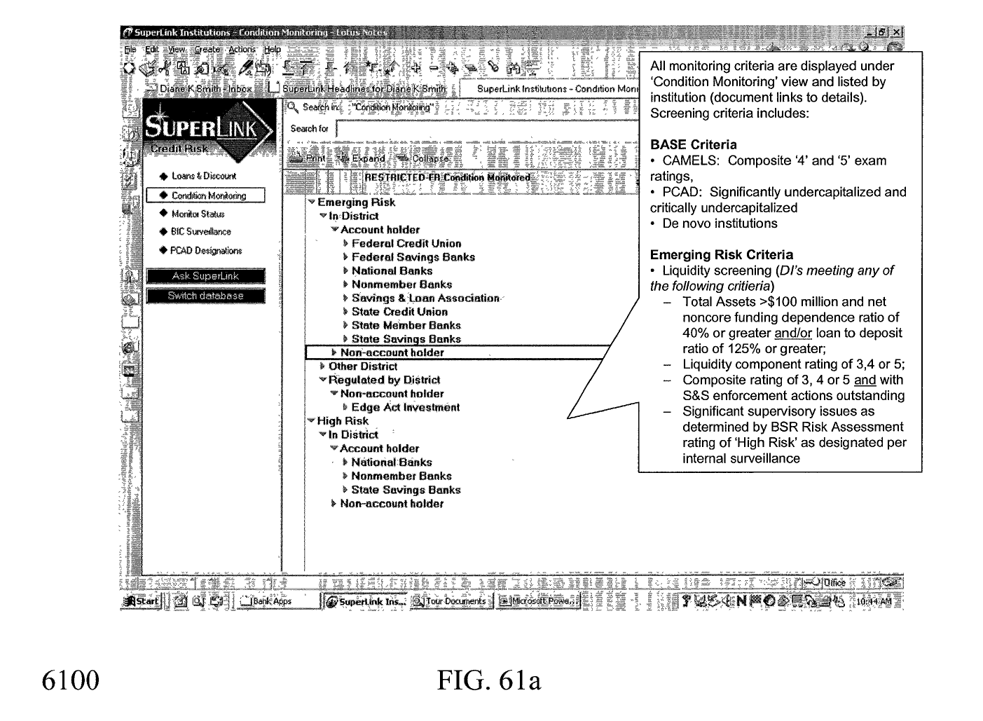

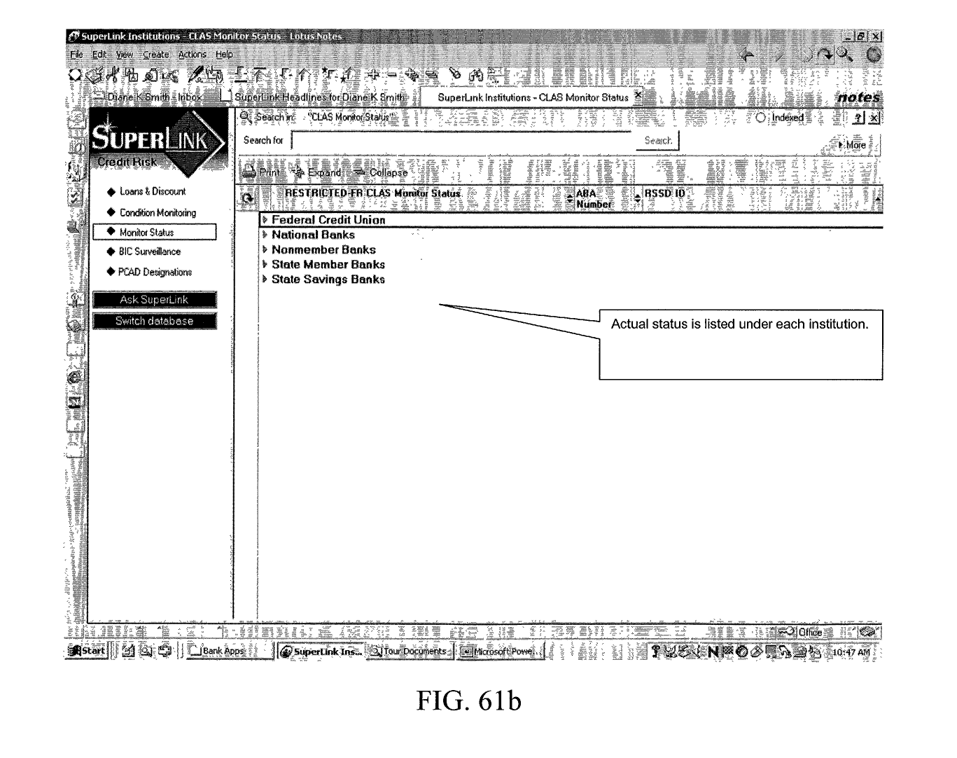

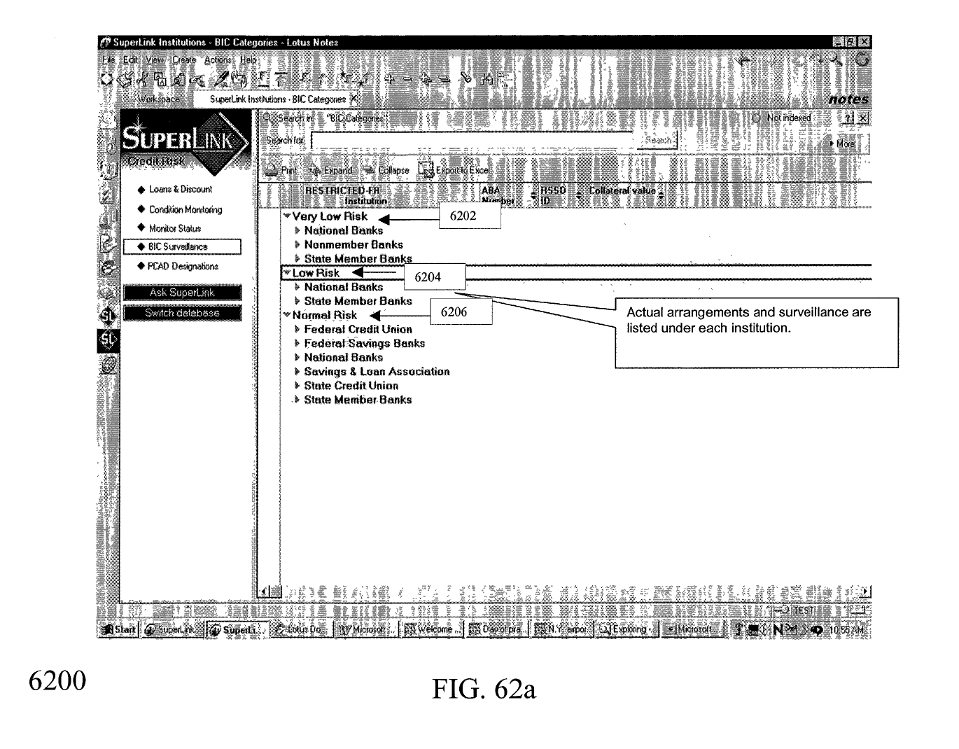

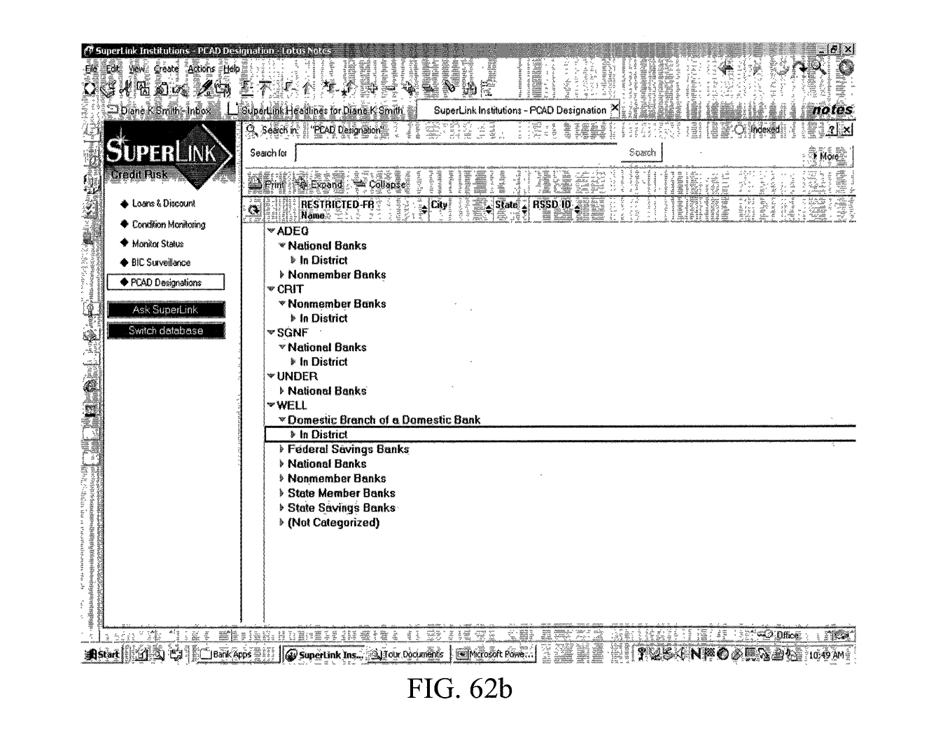

The Credit Risk Management Database 126 contains credit risk information which includes such data as Loan and Discount Summaries, Condition Monitoring, Monitor Status, Borrow in Custody (BIC) Surveillance, and PCAD Designations. The Credit Risk navigator 126 located on the Headlines Page 102 is used to view a variety of information. This view is only available to those individuals with a “need to know”. Users who do not have access to this data, will not see the navigator. FIG. 61 a shows an example of Condition Monitoring 6100 which lists all institutions monitored and their condition as defined by preset criteria. FIG. 61b provides a view by entity type of the actual monitoring status of each institution. FIG. 62a shows an example of Borrower in Custody surveillance which list arrangements made with the Federal Reserve for pledging collateral while retaining custody of the asset. Institutions are categorized as Very Low Risk 6202, Low Risk 6204 or Normal Risk 6206. FIG. 62b shows an example of Prompt Corrective Action Designations which categorizes institutions' capital adequacy.

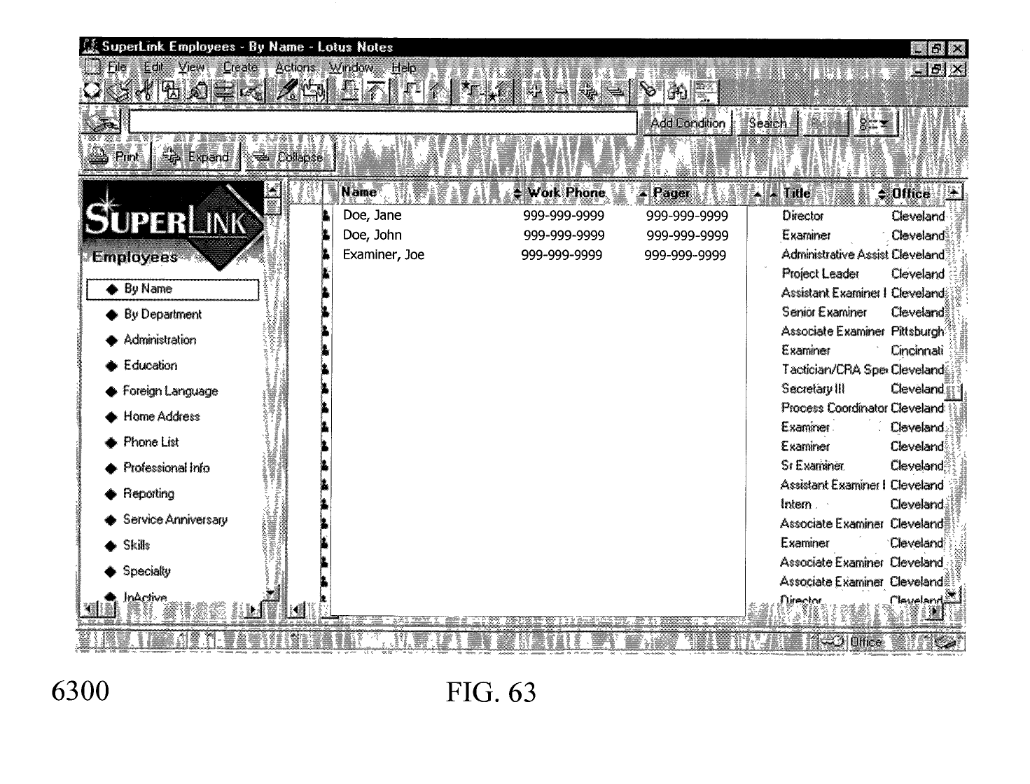

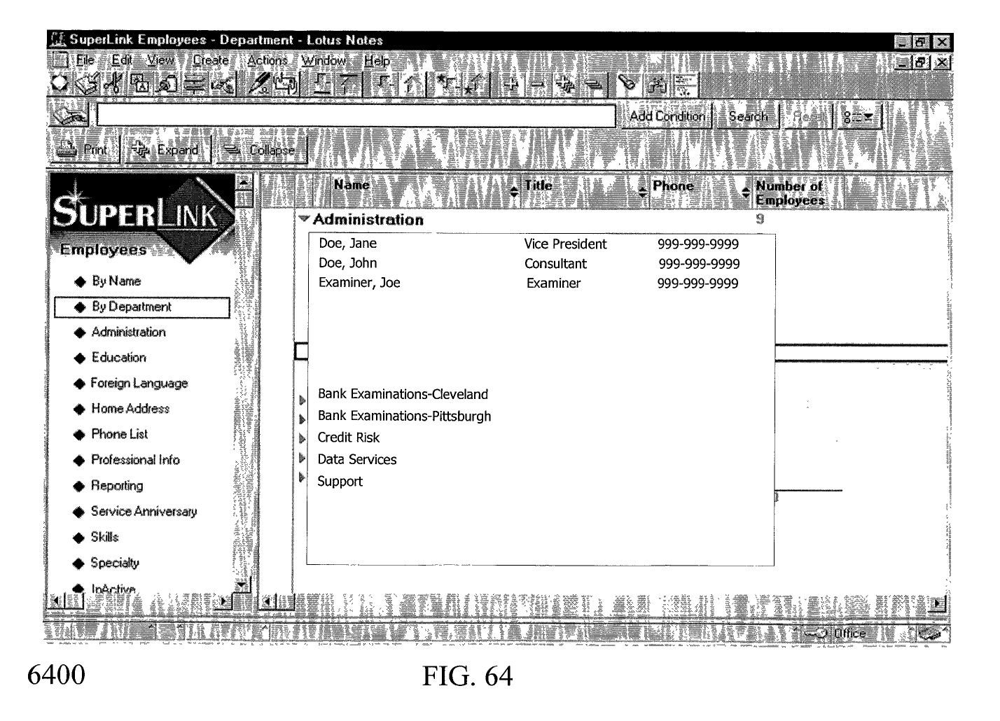

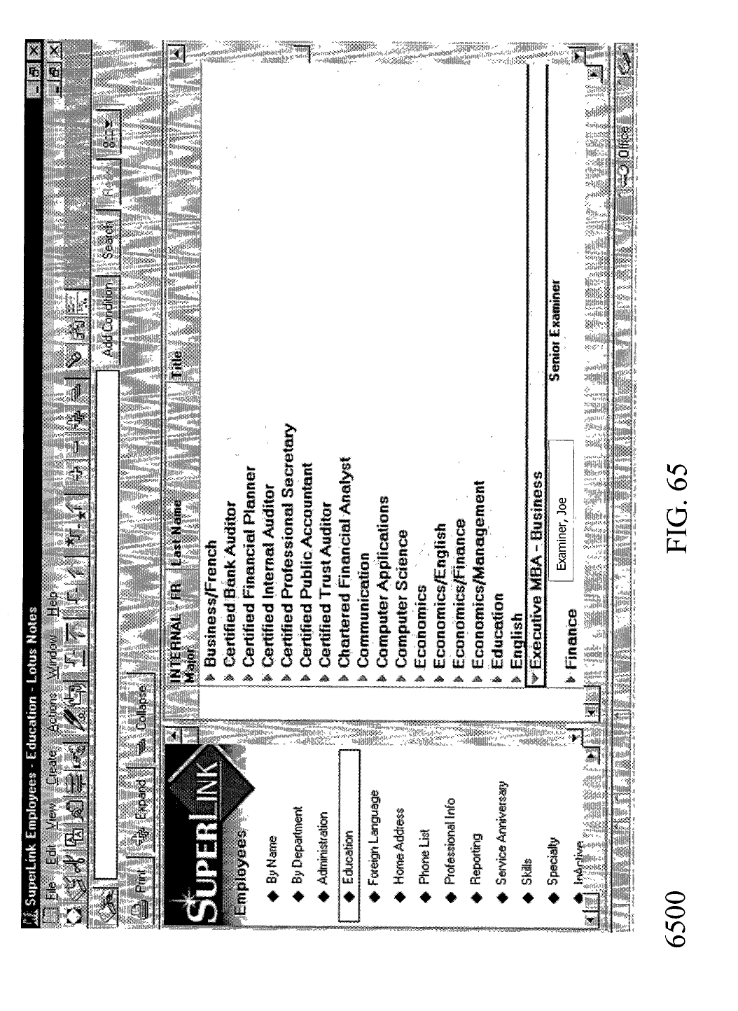

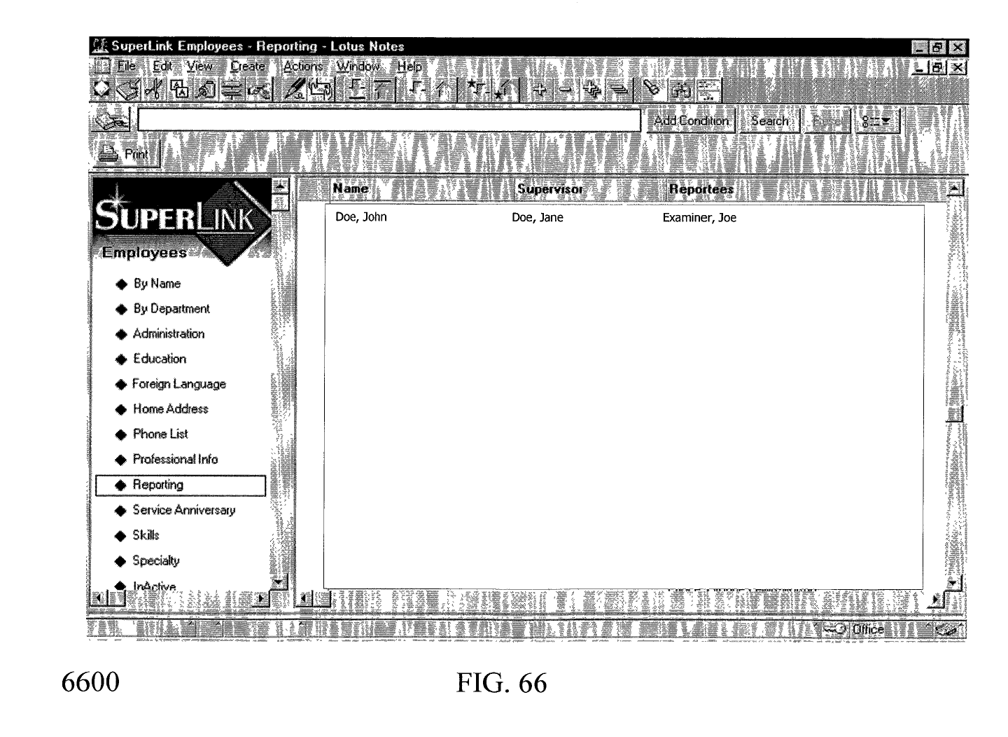

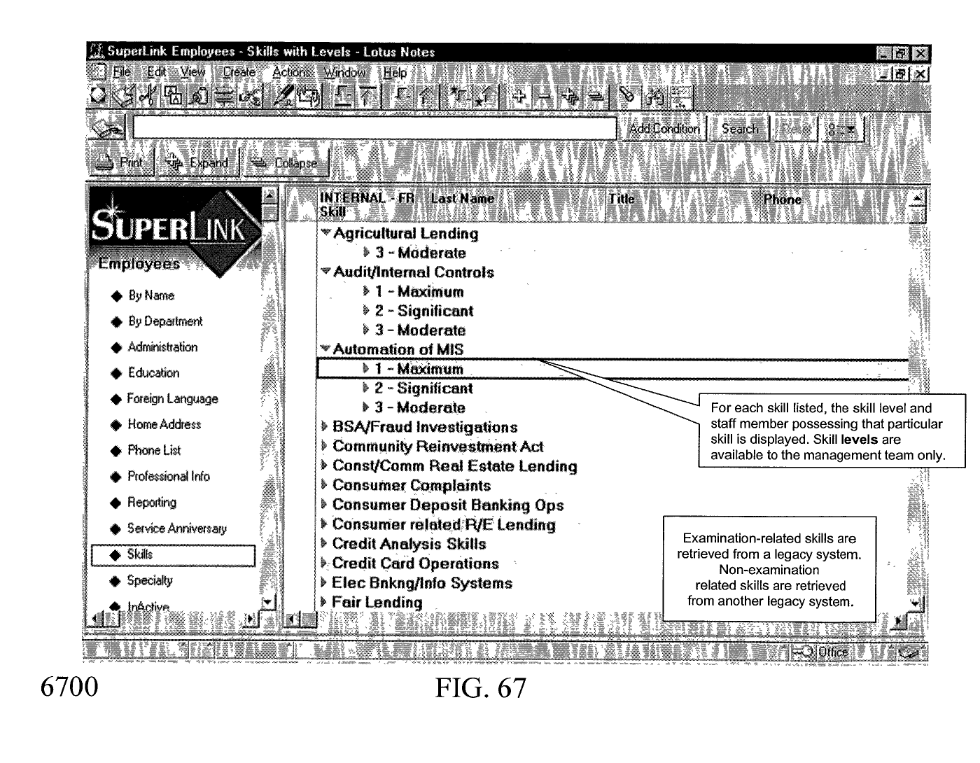

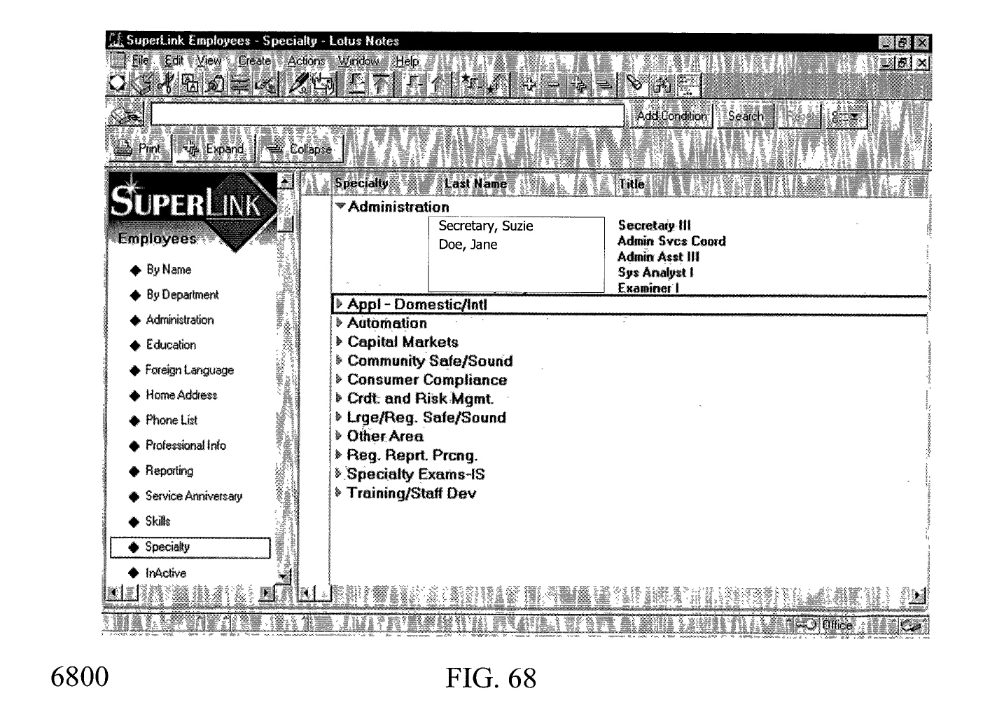

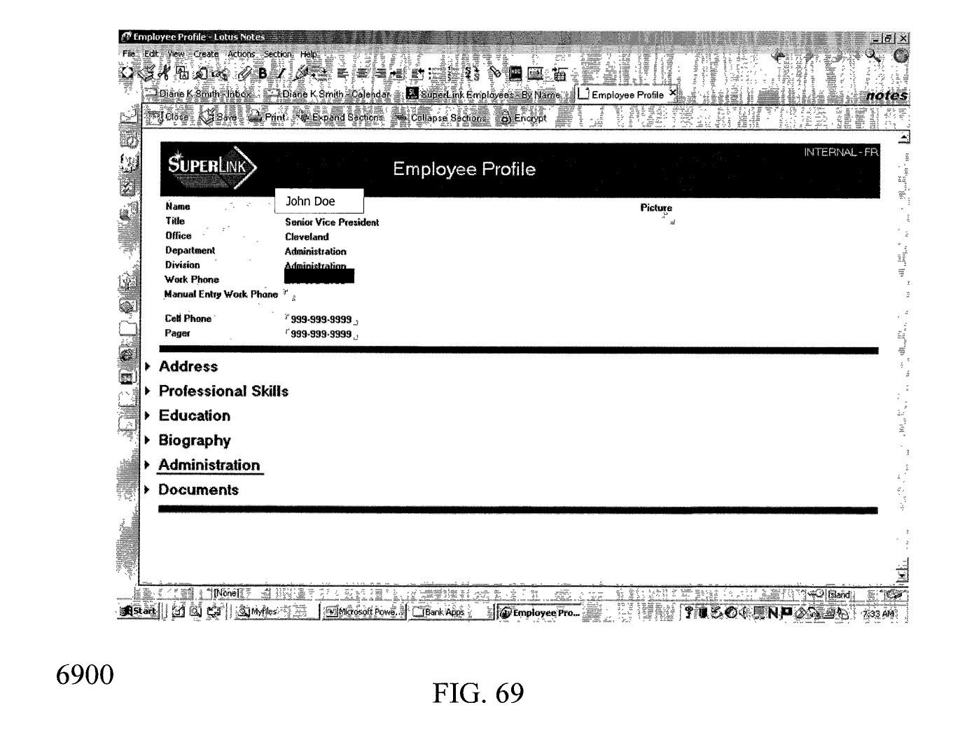

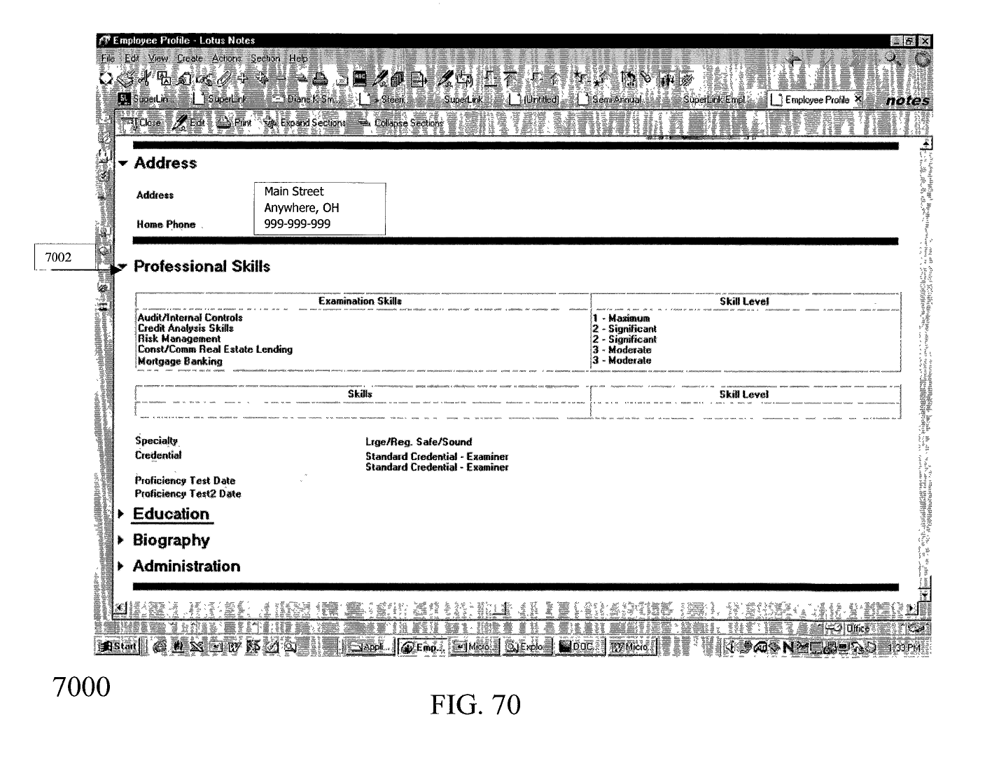

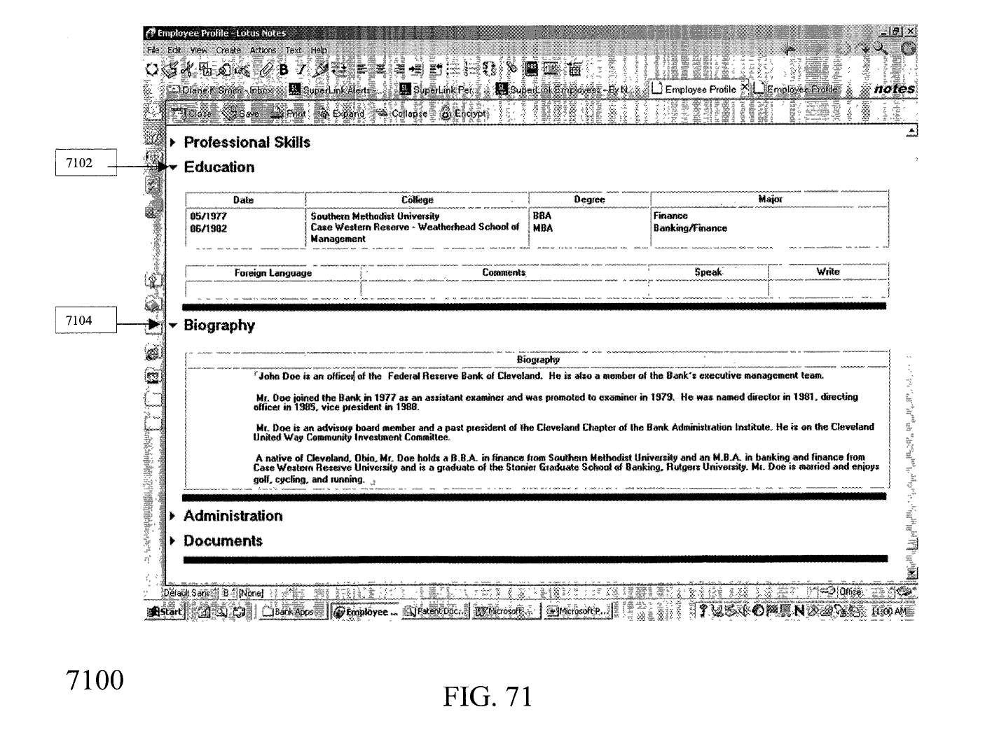

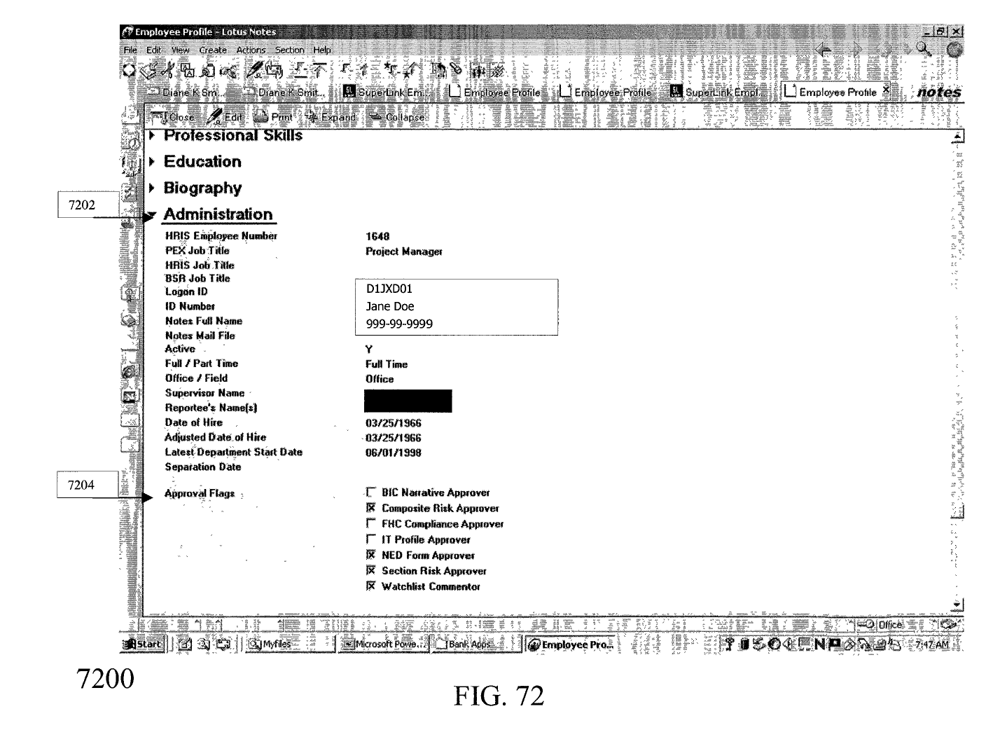

The Employee Database 128 includes a general profile for each employee which may include such data as professional skills, proficiency test results, credentials, education and foreign languages, employee biography, administration data such as ID numbers, supervisor, reportees, and hire dates. Additionally, the SuperLink Profile, which contains each user's preferences, is also contained in the Employee Database. The Employee Database 128 enables data to be retrieved with minimal manual entry. Views provide the ability to quickly find information. FIG. 63 is an example of an Employee By Name view 6300. FIG. 64 is an example of an Employee by Department view 6400. FIG. 65 is an example of Employee Education view 6500. FIG. 66 is an example of Employees Reporting relationships view 6600. FIG. 67 is an example of Employees Skills with level of skill view 6700. For each skill listed, the skill level and staff member possessing that particular skill is displayed. Skill levels are available only to the management team. FIG. 68 is an example of an Employee Specialty view 6800. FIG. 69 is a detailed example of an Employee Profile 6900. FIG. 70 is an example of an Employee Profile with expanded Professional Skills 7000. This skill detail is available under the heading Professional Skills 7002. FIG. 71 is an example of an Employee Profile 7100 with expanded Education 7102 and Biography 7104 sections. FIG. 72 is an example of an Employee Profile view 7200 with expanded Administration view 7202 and Approval Flags 7204. These flags are used to grant approval rights in the corresponding work flows.

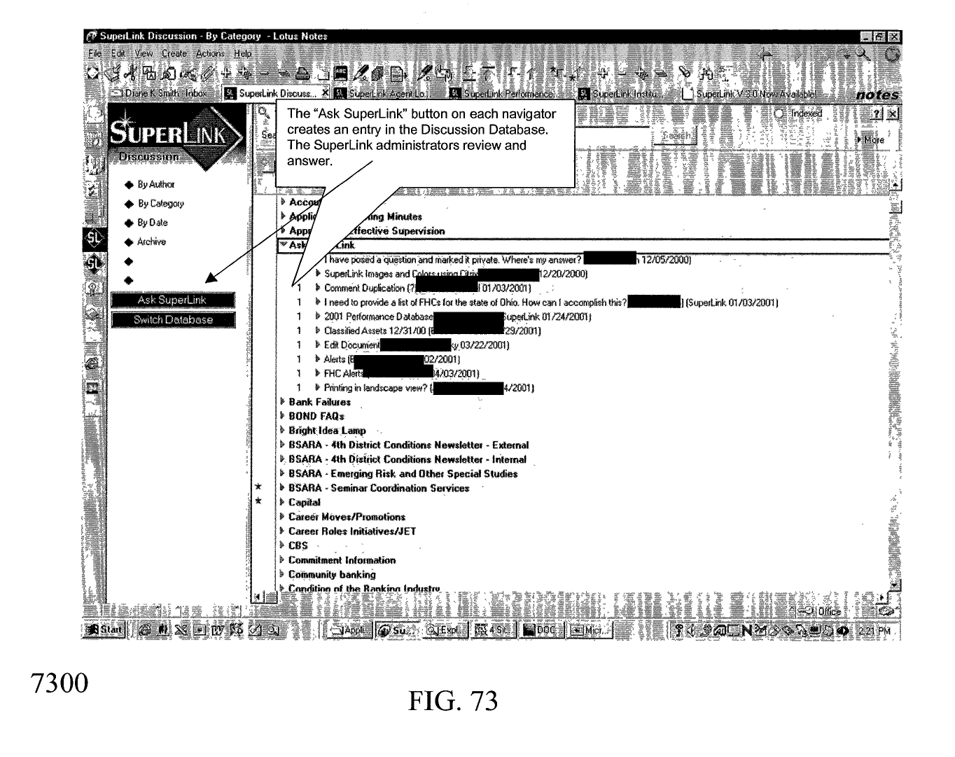

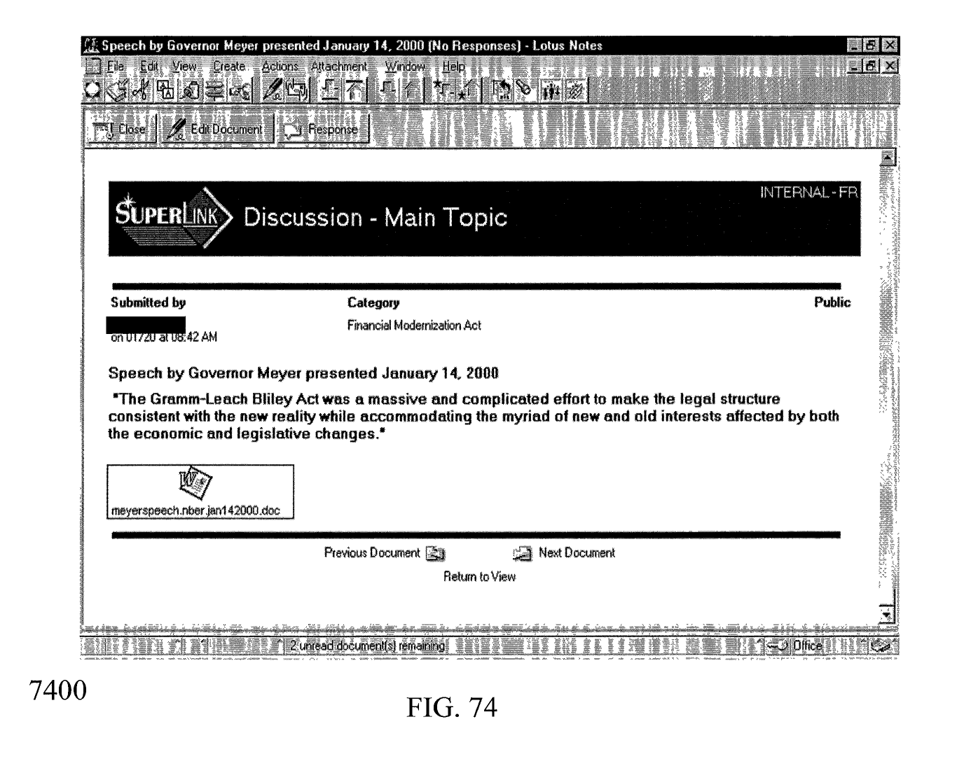

The Discussion Database 130 is discussion database, easily implemented as a standard Lotus Notes Discussion database by use of the platform of the preferred embodiment. This database is used to communicate questions, answers, tips, etc. The Discussion Database 130 may also be used to share knowledge. The database shows discussion thread, such as Main Topic, Response, and Response to Response. Document types stored in the database include Main, Response, and Response to Response. Categories are also used. A user may select an existing category or create a new one. Only the author of a document can update it, all other users only have read access. The Discussion Database 130 facilitates knowledge sharing by providing a common place for comments, collaboration and questions and answers. FIG. 73 is an example of a Discussion By Category view 7300. FIG. 74 is an example of a Discussion Main Topic document 7400.

The Applications Database 132 is used to see Open, Unconsummated, Consummated, and Closed applications. The Applications Database 132 has additional data representing comprehensive information about an institution. The views only list summary data, to view everything a document is tracking, a user only needs to double click on that document.

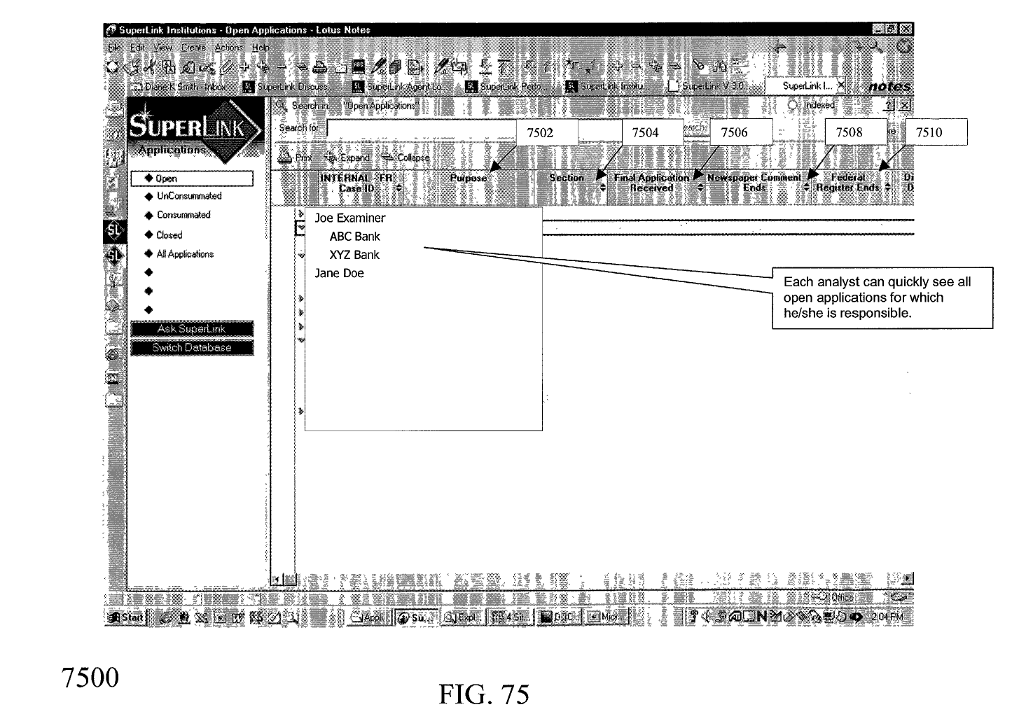

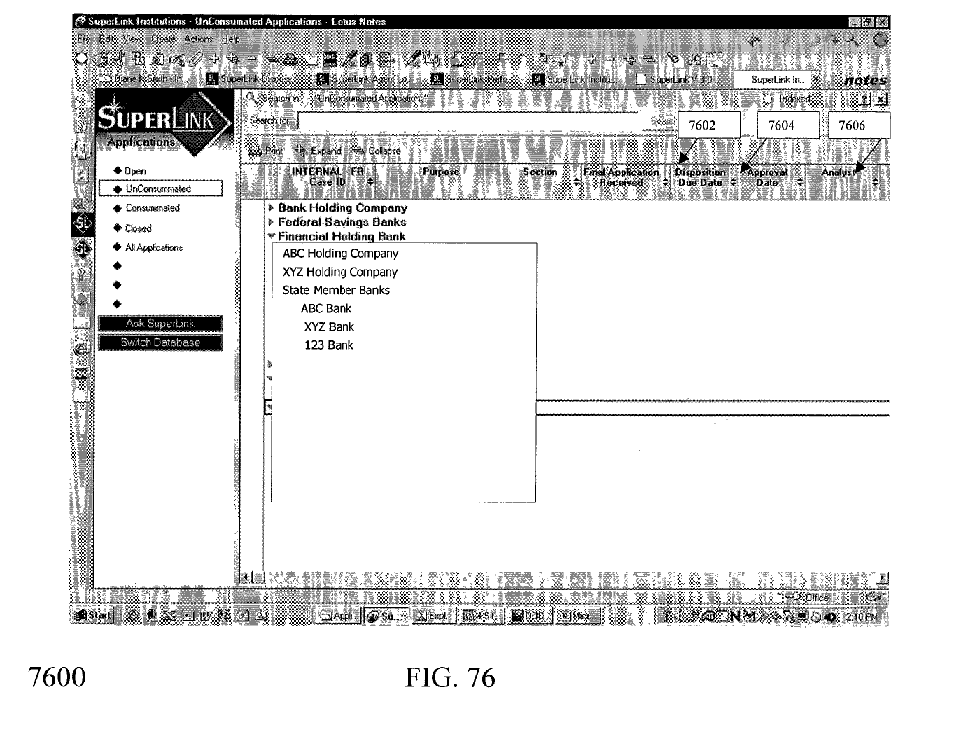

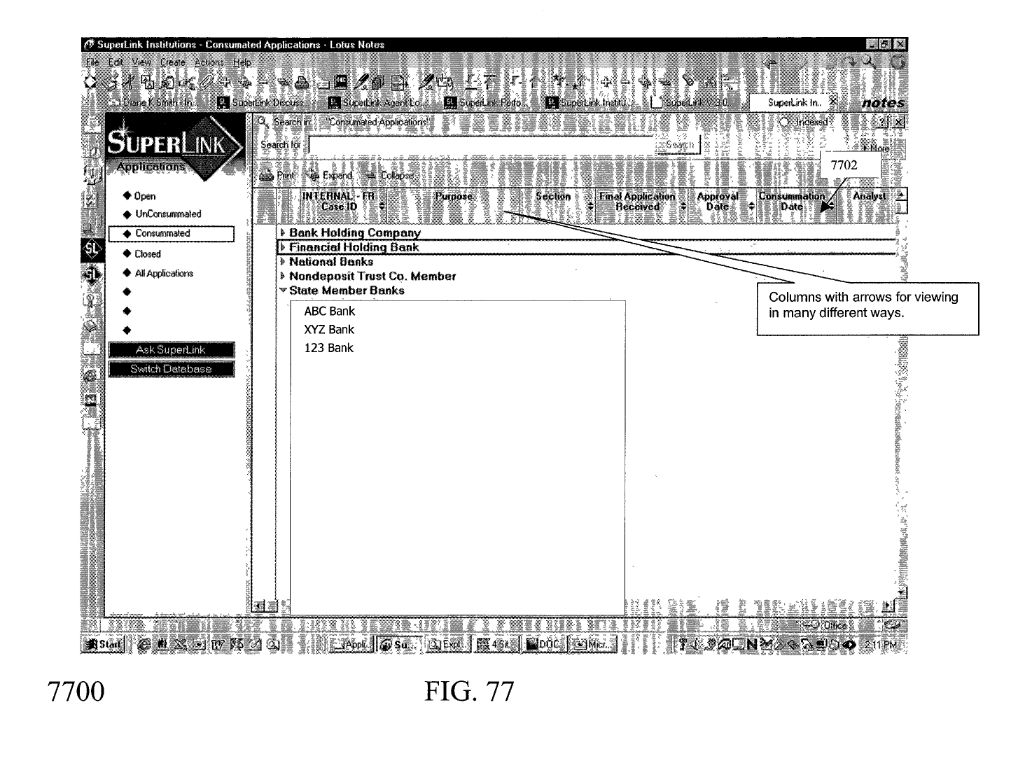

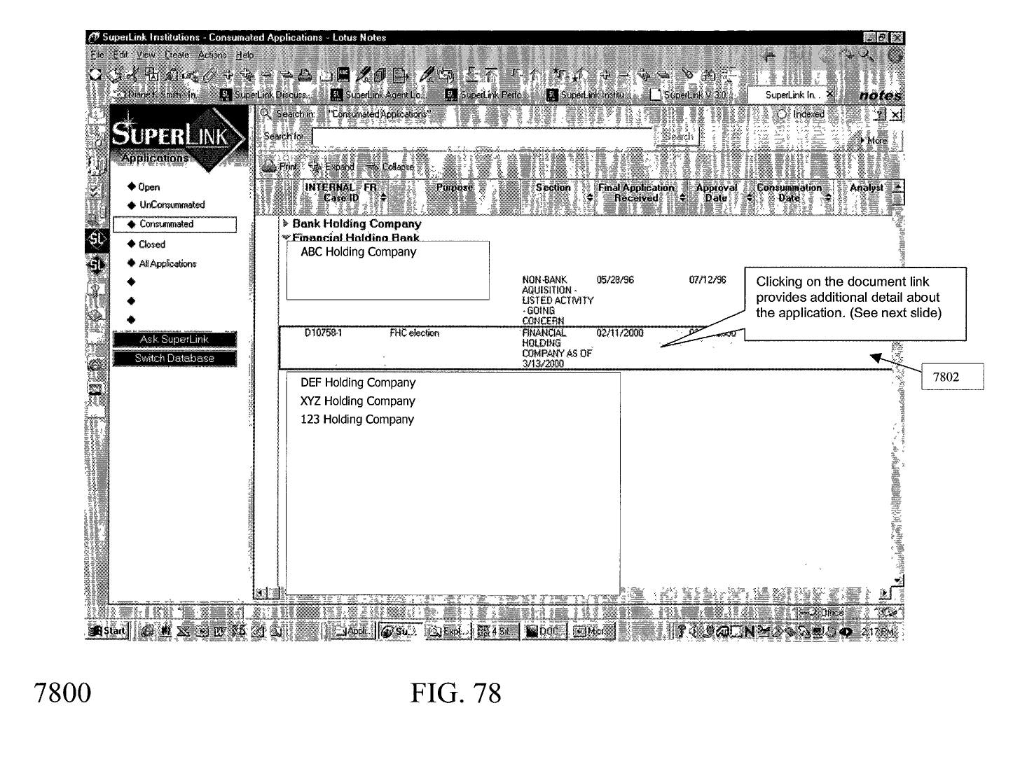

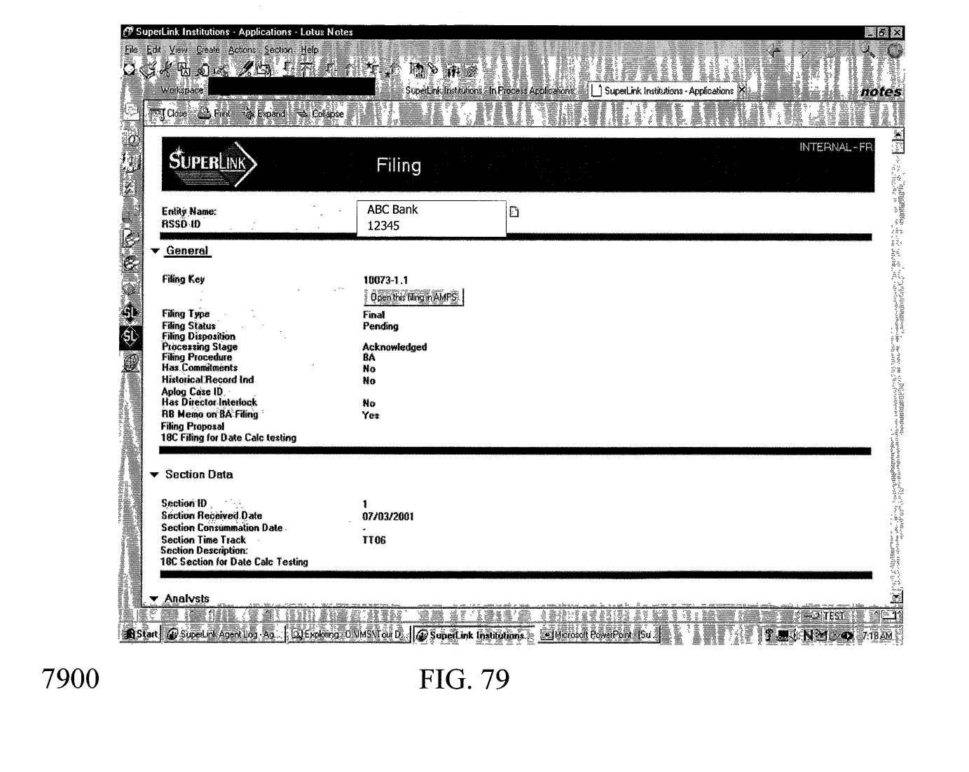

FIG. 75 is an example of an Open Application view 7500. This view shows a plurality of data fields relative to applications including Purpose 7502, Section 7504, Final Application Received Date 7506, Newspaper Comment Ends 7508, and Federal Register Ends 7510. FIG. 76 is an example of Unconsummated Applications view 7600. This view 7600 also shows the Disposition Due Date 7602, Approval Date 7604, and Analyst 7606. FIG. 77 is an example of a Consummated Applications view 7700. This view also shows a Consummation Date 7702. FIG. 78 is an example of the additional details 7802 available by selecting a document within a Consummated Applications view 7800. FIG. 79 is a detailed Application view 7900.

The Schedules Database 112 provides calendar views of schedule data from a separate scheduling application. The Schedules Database 112 utilizes standard Lotus Notes calendar views such as two day, week, two weeks, and month. The Schedules Database 112 indicates where staff personnel are and what they are doing. The Schedules Database 112 suitably tracks Exams, Projects, Training, Vacations, and provides on exams additional information such as type, staffing and phone number. The views available from the Schedules database 112 are as follows.

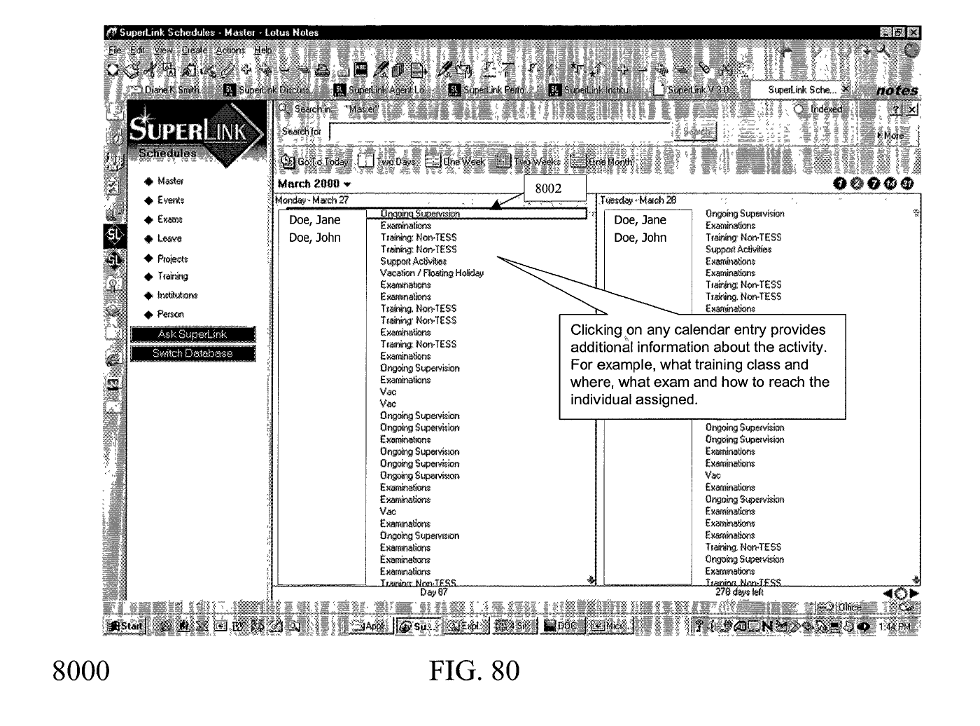

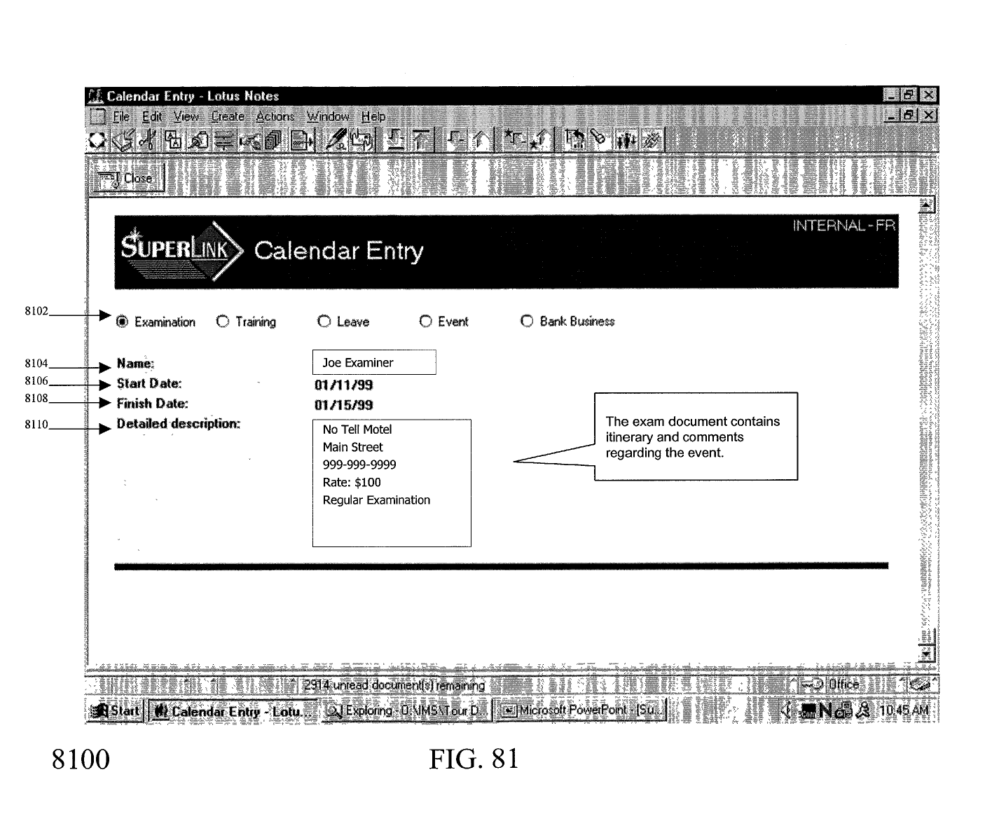

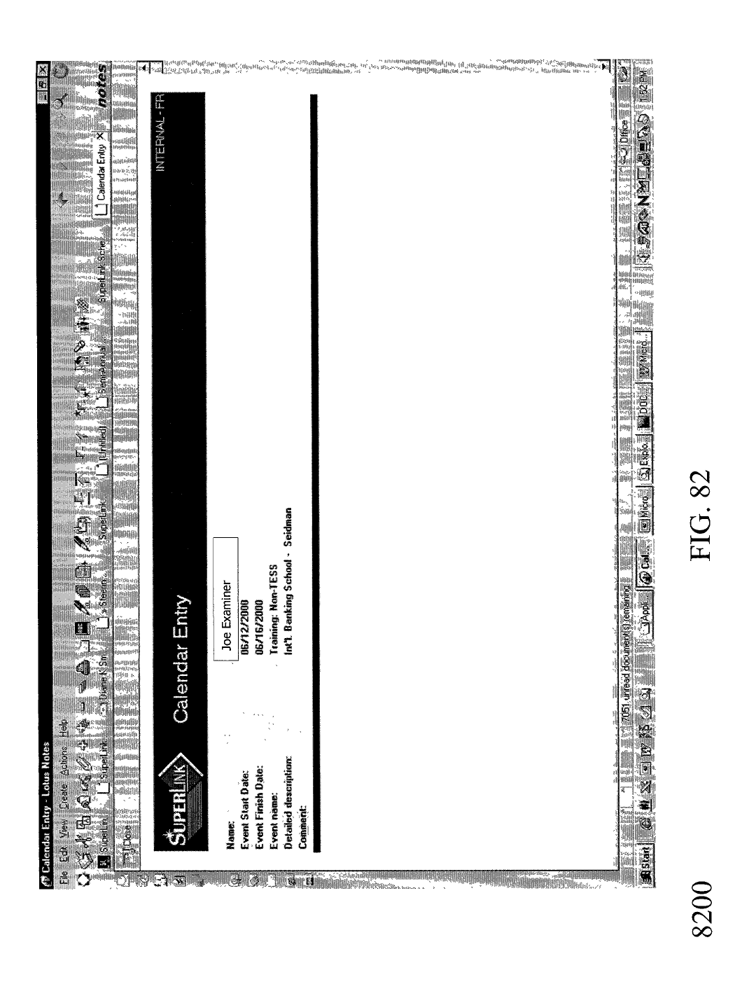

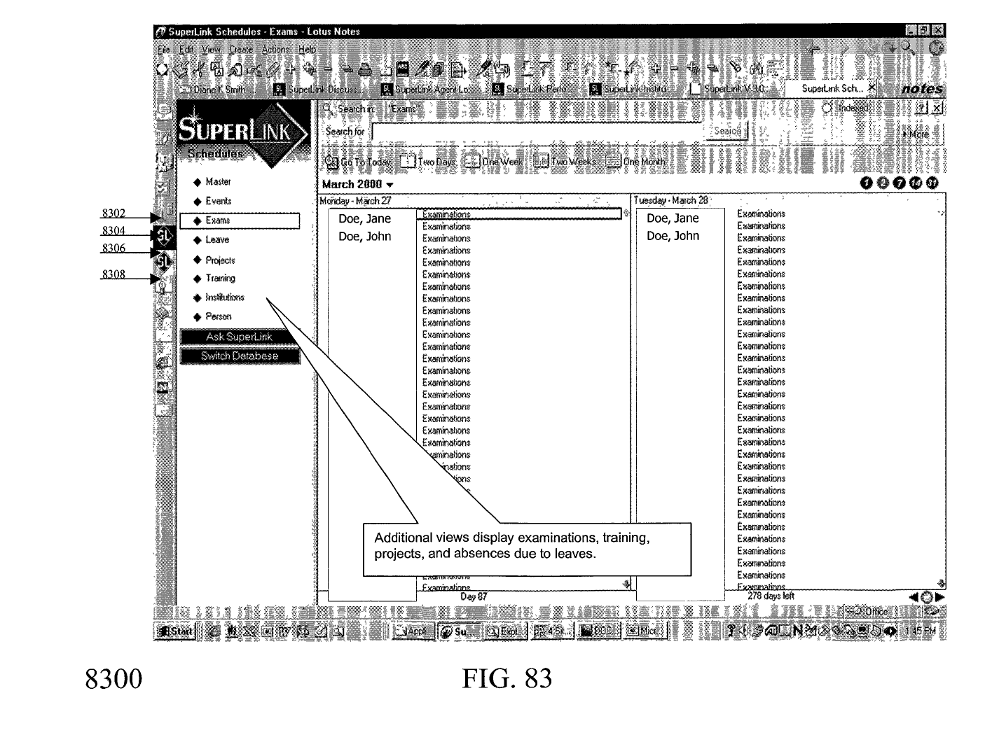

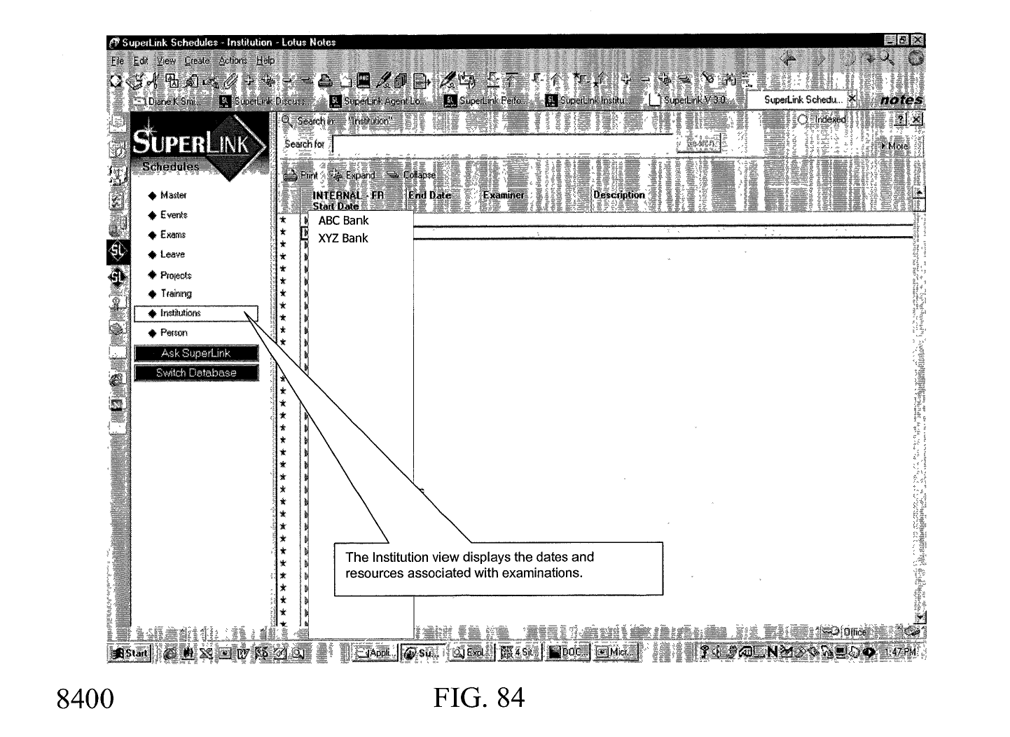

FIG. 80 shows the Master View lists 8000 that lists all employees, alphabetically, by date. Selecting any calendar entry 8002 will provide additional information about the activity, for example what training class, where, what exam, and how to reach the individual assigned. FIG. 81 is an example of a Calendar Entry screen 8100. From this screen detailed data is displayed, including type of entry 8102, name 8104 of person being scheduled, start date 8106, Finish date 8108, and a detailed description 8110. FIG. 82 shows an example of a Calendar Entry view 8200. FIG. 83 shows a Schedules—Exams view 8300. Selecting button 8302 displays the Exam view. Additional views are also available. Selecting Leave 8304 displays the Leave view. Selecting Projects 8306 displays the Projects view. Selecting Training 8308 displays a training view. FIG. 84 is an example of an Institutions view 8400.

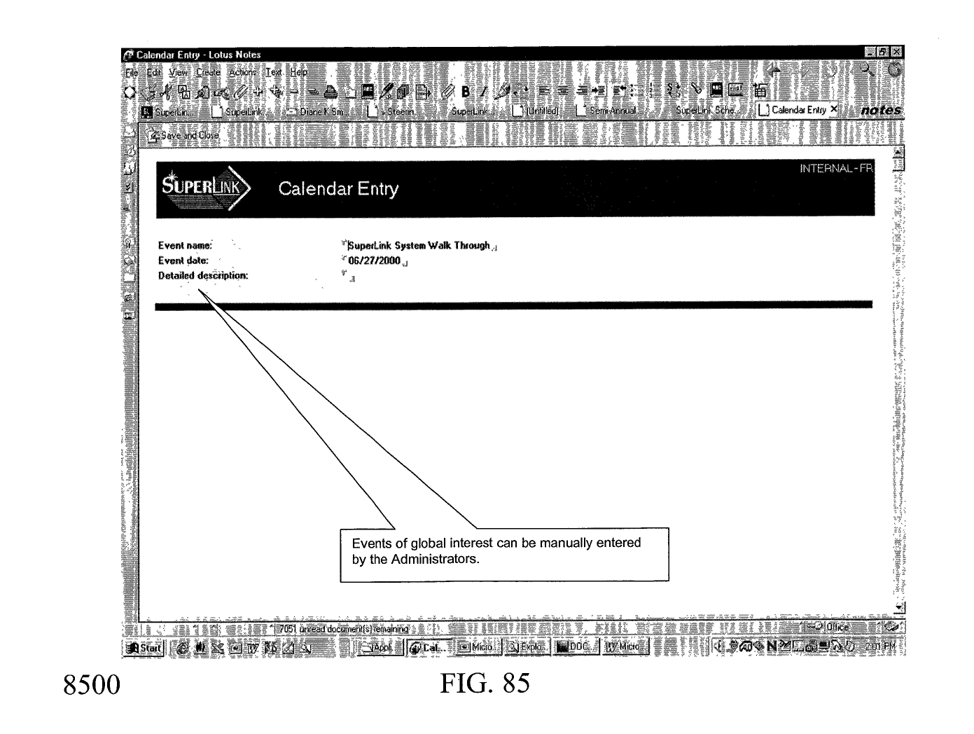

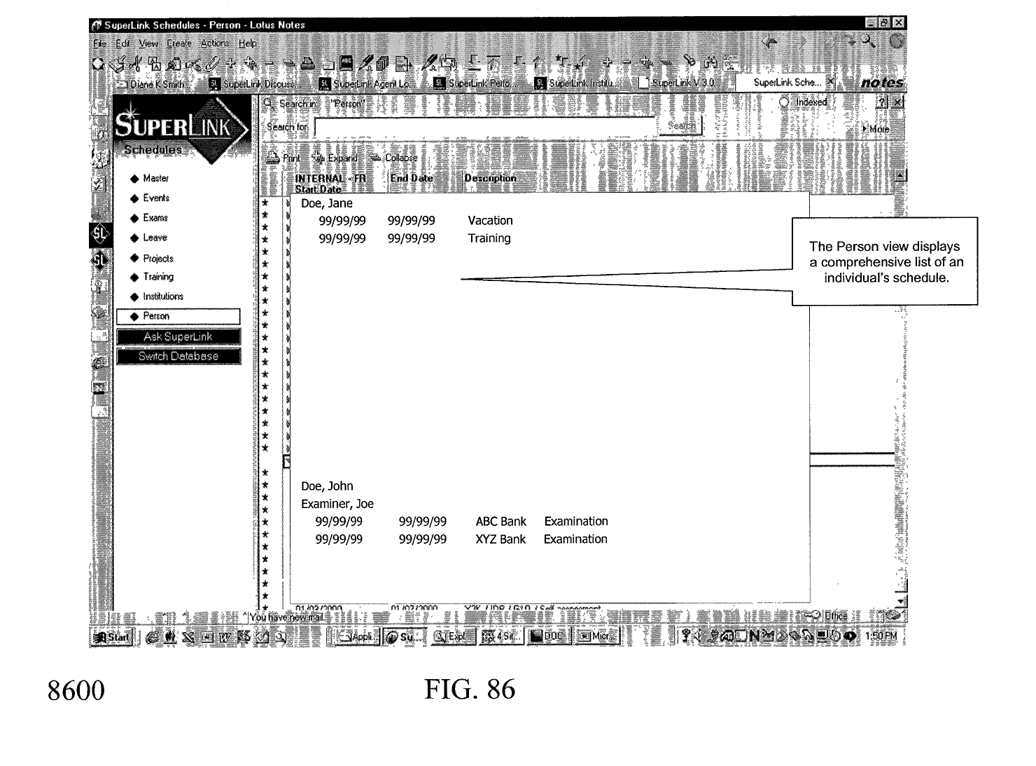

This view displays the dates and resources associated with examinations. FIG. 85 is an example of a Calendar Entry 8500 for a global interest event. Administrators may use the Calendar Entry 8500 to manually enter events of global interest. FIG. 86 is an example of a Person Schedule view 8600. This view 8600 displays a comprehensive list of an individual's schedule.

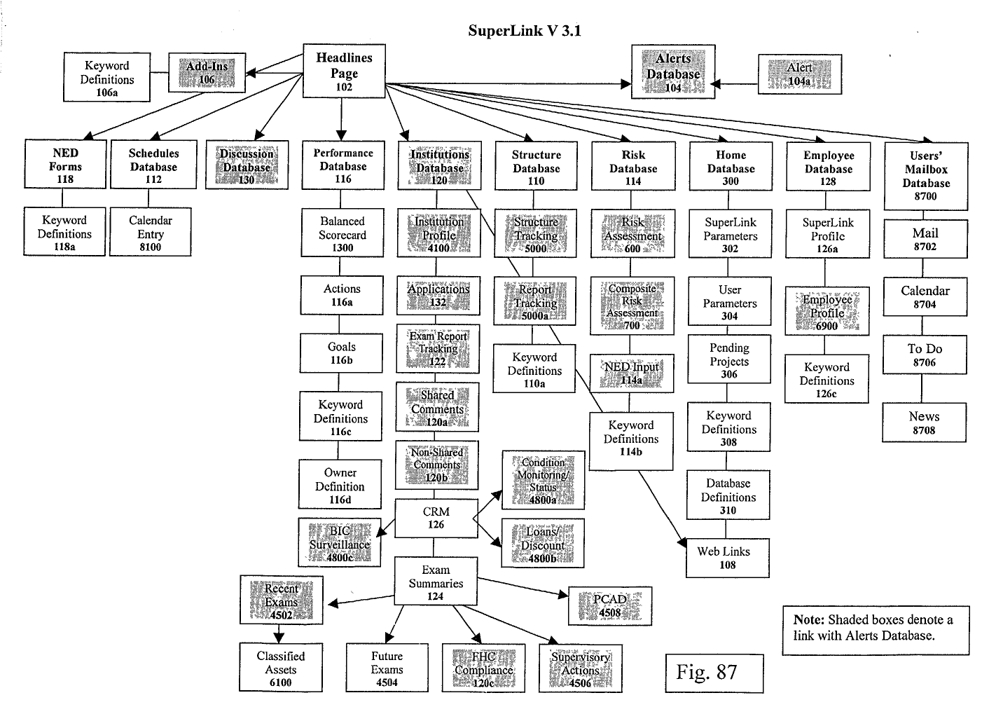

FIG. 87 shows a block diagram of the overall system configuration and the interrelationships between the various data files. The interrelationships are not necessarily the same as seen on the Headlines Page 102 because the Headlines Page 102 is used as a tool for navigating through the system, whereas FIG. 87 is the relationship between data files and views.

As noted above, the Headlines Page 102 is the main entry point into the system in the preferred embodiment. Data utilized by the Headlines Page 102 is stored throughout SuperLink for future use. The Home Database 300 is comprised of SuperLink Parameters 302, User Parameters 304, Pending Projects 306, Keyword Definitions 308, Database Definitions 310, and Web Links 108. By modifying the SuperLink parameters 302 and Database Definitions 310 the system may be ported to other locations and systems.

The Headlines Page 102 is connected to the Add-Ins database 106. The Add-Ins database 106 receives Keyword Definitions 106a customized to the particular application. The Add-Ins database has a link to the Alerts Database 104 and provides means for generating an alert.

The Headlines Page 102 is connected to the NED Forms database 118 which also receives Keyword Definitions 118a customized to the particular application.

The Headlines Page 102 also connects to the Schedules Database 112. The Calendar Entry screen 8100 utilizes data from this database.

The Headlines Page 102 also provides a direct link to the Discussion Database 130. The Discussion Database 130 is linked to the Alerts Database 104 enabling Alerts to be generated from the Discussion Database 130.

The Headlines Page 102 has a direct link to the Performance Database 116. Linked to the Performance Database 116 are the Balanced Scorecard view 1300, Actions 116a, Goals 116b, Keyword Definitions 116c and Owner Definition 116d.

The Headlines Page 102 is linked to the Institutions Database 120. The Institution Profile 4100 is generated from data obtained from the Institutions Database 120. The Applications database 132 and Exam Report Tracking Database 122 are also linked to the Institution Profile 120. Shared Comments 120a and Non-Shared Comments 120b are linked to the Institutions Database 120. The Institutions Database also stores Credit Risk Management 126 information. This portion of the Institution Database contains Condition Monitoring and Status 4800a, Loans & Discount 4800b, and Borrower In Custody 4800c. The expanded view 124 of the Exam Summary obtains data from Future Exams 4504, Recent Exams 4502, Classified Assets 6100, FHC Compliance 120c, Supervisory Actions 4506, and PCAD 4508 which are all linked to the Institution Profile 120. The Add-Ins Database 106 is used to receive BIC narratives, FHC Compliance 120c and IT Profiles.

The Headlines Page 102 is linked to the Structure Database 110 where access to the Structure Tracking 5000 and Report Tracking 5000a, and Keyword Definitions 110a are provided.

The Risk Database 114 is linked to the Headlines Page 102. The Risk Database 114, provides access to Risk Assessment 600, Composite Risk Assessment 700, NED Input 114a and Keyword Definitions 114b and are linked to the Institutions Database 120.

The Employee Database 128 is linked to the Headlines Page 102 and provides links to SuperLink Profile 126a, Employee Profile 6900 and Keyword Definitions 126c.

Finally, the SuperLink system provides a Users' Mailbox Database 8700 which provides a user with access to Mail 8702, Calendar 8704, ToDo 8706, and News functions 8708.

In addition to links from the Headlines Page 102, other cross links of data are available. The Add-Ins database 106 provides means for entering BIC narratives, FHC compliance data and IT Profiles which are accessible by the Institutions Database 120. Many of the databases have the capability to generate an Alert 104a. As mentioned previously, an Alert 104a may be generated automatically when data exceeds a certain threshold, when new documents are added to the database, or can be manually generated. Once an Alert 104a is generated, a record is placed in the Alerts Database 104. An Alert 104a may be generated from the Add-Ins Database 106, the Discussion Database 108, the Structure tracking view 5000 and Report Tracking view 5000a from the Structure Database 110. Data as seen in the Risk Assessment view 600, Composite Risk Assessment view 700, and NED Input 114a from the Risk Database 114 can also generate an Alert 104a. Alerts may also be generated from data in the Employee Profile view 6900 of the Employee Database 128. Furthermore, data from the Institutions Database 120, including data utilized by the Institution Profile view 4100, Applications Database 132, Exam Report Tracking 122, Shared Comments 120a, NonShared Comments 120b, BIC Surveillance 4800c, Loans 4800b, PCAD 4508, Supervisory Actions 4506, Condition Monitoring 4800a, FHC Compliance 120c, and Recent Exams 4502 may also be used to generate an Alert 104a.

Although the invention has been shown and described with respect to a certain preferred embodiment, it is obvious that equivalent alterations and modifications will occur to others skilled in the art upon the reading and understanding of this specification. The present invention includes all such equivalent alterations and modifications and is limited only by the scope of the following claims.

What is claimed is:

1. A method for assessing risk for a financial institution, the steps comprising:
a) receiving risk assessment data from a plurality of sources, each risk assessment includes data representative of a plurality of selected risk factors;
b) generating a composite risk assessment data in accordance with a calculation based on pre-selected parameters and a comparison thereto;
c) outputting the composite risk assessment on a computer readable medium.

2. The method for assessing risk for a financial institution as in claim 1, wherein the plurality of risk factors are selected from the group consisting of credit risk factor, market risk factor, liquidity risk factor, operational risk factor, legal risk factor, and reputational risk factor.

3. The method for assessing risk for a financial institution as in claim 2, the generating step further comprising computing an overall risk based on selected combined values of the plurality of risk factors.

4. The method for assessing risk for a financial institution as in claim 1, the method further comprising generating an alert when a risk factor has exceeded a predetermined threshold.

5. The method for assessing risk for a financial institution as in claim 4, the method further comprising defining a threshold parameter for generating the alert.

6. The method for assessing risk for a financial institution as in claim 5, wherein the threshold parameter step further comprises an early warning threshold parameter and a normal threshold parameter.

7. The method for assessing risk for a financial institution as in claim 6, the method further comprising storing the alert in a database.

8. The method for assessing risk for a financial institution as in claim 7, the method further comprising means communicatively coupled to a headlines page automatically displaying the alert on the headlines page.

9. Computer readable instructions stored on a computer readable medium, comprising:
computer readable instructions for receiving risk assessments for a financial institution from a plurality of sections, each risk assessment having a plurality of risk factors;
computer readable instructions for generating a composite risk assessment;
computer readable instructions for storing the composite risk assessment on a writeable computer readable medium

10. The computer readable instructions as in claim 9, wherein the plurality of risk factors are selected from the group consisting of credit risk factor, market risk factor, liquidity risk factor, operational risk factor, legal risk factor, and reputational risk factor.

11. The computer readable instructions as in claim 10, further comprising computer readable instructions for receiving risk assessment data from a national examination data examination database.

12. The computer readable instructions as in claim 10, the computer readable instructions for generating a composite risk assessment further comprising computer readable instructions for computing an overall risk based on the combined values of the plurality of risk factors.

13. The computer readable instructions as in claim 10, further comprising computer readable instructions for generating an alert when a new assessment is added to the database.

14. The computer readable instructions as in claim 10, the computer readable instructions further comprising computer readable instructions for defining a threshold parameter for generating the alert.

15. The computer readable instructions as in claim 14, wherein the threshold parameter further comprising an early warning threshold parameter and a normal threshold parameter.

16. The computer readable instructions as in claim 15, further comprising computer readable instructions for storing the alert in a database.

17. The computer readable instructions as in claim 16, further comprising computer readable instructions communicatively coupled to a headlines page for displaying the alert automatically on the headlines page.

18. A method for tracking at least one of an examination and inspection of a financial institution utilizing a computer based system, the steps comprising:
a) initiating a scheduled stage of the examination, the initiating stage including generating an examination form, the computer based system having means for receiving data to store on the form;
b) linking an additional form to the examination by the computer based system;
c) notifying an examiner when the examination is due to be completed;
d) receiving examination data into the examination form and additional forms associated with the computer based system;
e) verifying, by the computer based system, all necessary examination data has been entered into the system by performing a check thereof in accordance with pre-selected criteria;
f) communicating data representative of an examination form and additional forms to a supervisor for review;
g) receiving data representative of supervisory approval; and
h) storing and updating at least one database upon receipt of the data representative of supervisory approval.

19. The method of claim 18, wherein the generating stage further comprises automatically looking up and associating the financial institution data with the examination form and additional forms.

20. The method of claim 18, wherein the sending step is done by electronic mail, automatically after the verifying step has been completed.

21. The method of claim 18, wherein the notifying step is by electronic mail.

22. Computer readable instructions, stored on a computer readable medium comprising:
A) computer readable instructions for receiving instructions for initiating a scheduled stage of the examination;
B) computer readable instructions for generating an examination form, the computer readable instructions having means for receiving data to store on the form;
C) computer readable instructions for associating additional forms for the exam;
D) computer readable instructions for notifying an examiner when the exam is due to be completed;
E) computer readable instructions completing the examination form and additional forms by receiving examination data;
F) computer readable instructions for verifying all necessary examination data has been entered;
G) computer readable instructions for sending examination form and additional forms to a supervisor for review;
H) computer readable instructions for receiving supervisor approval;
I) computer readable instructions for storing examination data on a computer writeable storage medium and updating a plurality of databases.

23. The computer readable instructions of claim 22, the computer readable instructions for notifying an examiner when the examination is due to be completed further comprising computer readable instructions for automatically sending an electronic mail to an examiner.

24. The computer readable instructions of claim 22, the computer readable instructions for receiving supervisor approval further comprising computer readable instructions for automatically sending an electronic mail notification to a supervisor.

25. The computer readable instructions of claim 22, further comprising computer readable instructions to compare examination data to data of a past examination.

26. The computer readable instructions of claim 25, further comprising computer readable instructions for generating an alert when comparison of the examination detects a change of the data beyond a preset threshold.

27. The computer readable instructions of claim 26 further comprising storing the alert data in a database.

28. The computer readable instructions of claim 27 further comprising computer readable instructions for receiving the preset threshold.

29. The computer readable instructions of claim 28, wherein the preset threshold is comprised of an early warning threshold and a normal threshold.
